(19) United States
(12) Patent Application Publication
(10) Pub. No.: US 2019/0180219 A1
(43) Pub. Date: Jun. 13, 2019

(54) COMPUTER SYSTEM, MANAGEMENT METHOD, AND PROGRAM

(71) Applicant: BECUBE CO., LTD., Osaka (JP)

(72) Inventor: Makoto KURODA, Osaka (JP)

(73) Assignee: BECUBE CO., LTD., Osaka (JP)

(21) Appl. No.: 16/310,924

(22) PCT Filed: Aug. 3, 2017
(86) PCT No.: PCT/JP2017/028208

§ 371 Date: Dec. 18, 2018

(30) Foreign Application Priority Data
Dec. 27, 2016 (JP) 2016-253245

(51) Int. Cl. G06Q 10/06; G06Q 10/10

(52) U.S. Cl. CPC G06Q 10/063116; G06Q 10/1097

(57) ABSTRACT

A technique for reducing mismanagement of high- and low-order to-do related items, saving a user the trouble of the management of those items, and allowing him or her to more easily recognize the correlation between the high- and low-order to-do related items. A task item C serving as an exemplary high-order to-do related item and a grace period of the task item C, and a schedule item E serving as an exemplary low-order to-do related item associated with the task item C and occurring as a binding period during the grace period of the task item C and the binding period thereof are input to a management server. These to-do related items input are associated with each other via a path and stored in a database, thereby making a uniform interlinked management of the task and the schedule.

### TECHNICAL FIELD

The present invention generally relates to management of to-do related items, which are related to various things to be done by a user, including his or her schedules, tasks, and projects. More particularly, the present invention relates to a computer system, management method, and program for managing those to-do related items.

### BACKGROUND ART

Various types of schedule managers (or schedulers) have been known in the pertinent art. A method and device for displaying a calendar as disclosed in Patent Document 1 is one example of this.

### CITATION LIST

### Patent Documents

PATENT DOCUMENT 1: Japanese Unexamined Patent Publication No. H9-73434

### SUMMARY

### Technical Problem

The schedule manager disclosed in Patent Document 1 is designed to allow the user to manage his or her schedule by inputting the schedule into the schedule manager and displaying it on a calendar. Thus, such a schedule manager certainly allows the user to manage his or her schedule but does not allow him or her to manage his or her tasks to do. For this reason, to manage his or her tasks to do, the user need to provide another task manager for managing his or her tasks to do, separately from the calendar display device.

However, forcing the user to manage his or her schedule on the calendar display device and manage his or her tasks on the task manager separately would impose a heavy and troublesome management burden on him or her. This is because he or she has no choice but operating both of these two devices for the purpose of management of his or her schedule and tasks. This could lead to an unwanted situation where the user cannot manage both of his or her schedule and tasks equally perfectly. In other words, if the user spends too much time on schedule management, then he or she cannot afford to manage his or her tasks equally perfectly, and vice versa. This would cause a lot of inconvenience to him or her. On top of that, the known dual schedule/task management does not allow the user to recognize the correlation between his or her tasks and his or her schedule. These disadvantages outweigh its advantages.

These disadvantages result from the separate, non-interlinked management of a task (such as “Requesting Filing of Patent Application”) and a schedule related to that task (such as a “Schedule to Meet Patent Attorney from 2 PM Tomorrow”). Speaking more generically, these disadvantages result from the separate, non-interlinked management of a high-order to-do related item related to a thing to be done by the user (such as his or her task) and a low-order to-do related item related to the thing to be done by him or her in association with the implementation of the high-order to-do related item (such as the user's schedule involved with the implementation of his or her task).

In view of the foregoing background, it is therefore an object of the present invention to reduce such mismanagement of the high- and low-order to-do related items, save the user the trouble of the management of those items, and allow him or her to more easily recognize the correlation between the high- and low-order to-do related items.

### Solution to the Problem

In the following summary section, specific implementations corresponding to the respective means for solving the problems and described in detail later in the description of embodiments will be shown in parentheses.

A computer system according to the present invention includes: a storage device (such as a database 5) configured to store to-do related items (such as project items, tasks, and schedules) related to things to be done by a user and to-do periods when the things are scheduled to be done;

an input device (such as an input operating device 38) configured to accept input of a task item (such as “Specification Drafting” shown in FIG. 1) included in high-order to-do related items (such as project items and tasks) and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

a decision unit (such as the decision unit 72 shown in FIG. 2) configured to determine, in a state where the task item and the to-do period to perform the task item are stored in the storage device, whether or not the binding period of the schedule item input via the input device matches the to-do period of the task item; and

a processor (such as the processor 73 shown in FIG. 2, a CPU 30, S50) configured to control a storage operation by the storage device by performing storage processing of instructing the storage device to store the schedule item input and its associated binding period such that the schedule item input and a task item, which is a to-do related item higher in order than the schedule item, are stored and interlinked with each other in the storage device so as to be managed uniformly.

The processor disables the storage processing (e.g., in S43 if the answer is NO in S46) if a determination has been made by the decision unit that the binding period does not match the to-do period, and

also disables the storage processing (e.g., in S43 if the answer is YES in S42) if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

A computer system according to another aspect of the present invention includes: a storage device (such as a database 5) configured to store to-do related items (such as project items, tasks, and schedules) related to things to be done by a user and to-do periods when the things are scheduled to be done;

an input device (such as an input operating device 38) configured to accept input of a task item (such as “Specification Drafting” shown in FIG. 1) included in high-order to-do related items (such as project items and tasks) and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

a decision unit (such as the decision unit 72 shown in FIG. 2) configured to determine, in a state where the task item and the to-do period to perform the task item are stored in the storage device, whether or not the binding period of the schedule item input via the input device matches the to-do period of the task item; and

a processor (such as the processor 73 shown in FIG. 2 and a CPU 30) configured to instruct, provided that the decision unit has determined that the binding period matches the to-do period, the storage device to store the schedule item input and its associated binding period such that the schedule item input and a task item, which is a to-do related item higher in order than the schedule item, are stored and interlinked with each other in the storage device so as to be managed uniformly.

The storage device is able to store a plurality of users' to-do related items (e.g., can store Taro's, Hanako's, . . . and Jiro's to-do related items).

The processor includes a reference saving processor configured to instruct the storage device to perform a save operation, in order to allow, as a memo, reference to another user's schedule item that is any of the to-do related items stored in the storage device (e.g., in S104 shown in FIG. 8).

The input device includes a one's own schedule creator-input device (e.g., in S40-S42 and S46-S49 shown in FIG. 5) allowing the user to participate in that another user's schedule item stored in the storage device (e.g., in S52 shown in FIG. 5) and to create and input a one's own schedule item, which is a schedule item associated with the user's own to-do related item and corresponding to that another user's schedule item.

The processor performs one's own schedule storage processing of instructing the storage device to store, and interlink with each other, the one's own schedule item and the task item to be performed following the one's own schedule item so as to allow the one's own schedule item and the task item to be managed uniformly (e.g., in S50).

In an exemplary embodiment, that another user's schedule item may include timetable data on which times are allocated on the basis of a plurality of contents (e.g., an event such as a product planning briefing, a school schedule, and a train schedule), and

the one's own schedule creator-input device may allow the user to make reference to the timetable data, select any of the contents that the user wants to participate in, and input the selected content as the one's own schedule item.

In another exemplary embodiment, the computer system may further include an abnormality processor configured to perform abnormality processing (e.g., in S43 shown in FIG. 5) without performing the one's own schedule storage processing if the decision unit has determined that the binding period of the one's own schedule item does not match the to-do period to perform the task item (e.g., if the answer is NO in S51 shown in FIG. 5) at a point in time when the one's own schedule item is input via the one's own schedule creator-input device (e.g., at a point in time when the answer is YES in S47 shown in FIG. 5).

In still another exemplary embodiment, the computer system may further include an association display device configured to display (e.g., in S200-S206 shown in FIG. 14A, in S207-S209 shown in FIG. 14B, in “Task (To-Do List)/Schedule (Calendar) Simultaneous Display” shown in FIG. 26, and “Overview Display (Tree)” shown in FIG. 17A), in association with each other, the task items and the schedule items (e.g., “Problem Gathering” 19 and “Third Meeting Schedule of Problem Solving Conference” 20 shown in FIG. 1) that are stored and interlinked with each other in the storage device.

In yet another exemplary embodiment, the association display device may display a part of the to-do period to perform the task item as the binding period of the schedule item (e.g., 13:00-14:00, Feb. 15, 2016 in “Task (To-Do List)/Schedule (Calendar) Simultaneous Display” shown in FIG. 26).

In yet another exemplary embodiment, the high-order to-do related items may further include a project item established to accomplish a certain purpose (e.g., “Patent Obtaining Project” 12 shown in FIG. 1).

The processor may include a path association storage processor configured to instruct the storage device to store, in association with each other, the project item and task items to be done to put the project item into practice by using a path that is a character string indicating the storage location of data in a computer.

The path association storage processor may make the storage device store, as tree structure data (e.g., the tree data of Project A, Task C, and Schedules D and E in the database 5 shown in FIG. 2), the project item (e.g., Project A shown in FIG. 2) and the task items (e.g., Task C shown in FIG. 2) by defining a path following the project item as a path (e.g., /ROOT Project/Project A/Task C shown in FIG. 2) for the task items.

In yet another exemplary embodiment, the association display device may include a tree display device (such as the one shown in FIG. 17A) for displaying, in a tree form, the project item and the task items based on the tree structure data, and the input device may allow the user to select, as items to be interlinked with each other, any combination of to-do related items including the project item and the task items displayed by the tree display device, and to create and input new to-do related items associated with the selected to-do related items (e.g., a change of screens from the tree display shown in FIG. 16).

In yet another exemplary embodiment, if a first to-do related item (e.g., the experiment project 9 shown in FIG. 1) and a second to-do related item (e.g., the “Photo Shooting” 13 shown in FIG. 1), related to the first to-do related item, are stored in the storage device in association with each other (e.g., in S25 shown in FIG. 4A and in S35 shown in FIG. 4B), the input device may accept input (e.g., in S80 shown in FIG. 6) of a link to the second to-do related item as a link related to a third to-do related item (e.g., the problem solving project 11 shown in FIG. 1) that is different from the first to-do related item, and

the processor may instruct the storage device to store, in association with the third to-do related item, the link to the second to-do related item input via the input device (e.g., in the link creation processing shown in FIG. 6).

A computer system according to still another aspect of the present invention includes: a storage device (such as the database 5 shown in FIG. 1 and the EEPROM 33 shown in FIG. 3A) configured to store to-do related items related to things to be done by a user and to-do periods when the things are scheduled to be done; and a processor (such as the CPU 30 shown in FIG. 3A).

The processor performs:

processing of accepting input (e.g., in S30, S40 and other steps) of a task item (such as “Specification Drafting” shown in FIG. 1) included in high-order to-do related items (such as projects and tasks) and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

processing of determining (e.g., in S46 and other steps), in a state where the task item and the to-do period to perform the task item are stored in the storage device, whether or not the binding period of the schedule item accepted in the processing of accepting matches the to-do period of the task item;

processing of performing storage processing of instructing the storage device to store the schedule item accepted and its associated binding period such that the schedule item input and a task item, which is a to-do related item higher in order than the schedule item, are stored and interlinked with each other in the storage device so as to be managed uniformly (e.g., in S50); and

processing of disabling the storage processing if a determination has been made by the decision unit that the binding period does not match the to-do period (e.g., in S43 if the answer is NO in S46), and also disabling the storage processing (e.g., in S43 if the answer is YES in S42) if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

A management method according to yet another aspect of the present invention includes the steps of: accepting input (e.g., in S30, S40 and other steps) of a task item (such as “Specification Drafting” shown in FIG. 1) included in high-order to-do related items (such as project items and tasks) related to things to be done by a user and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

determining (e.g., in S46 and other steps), in a state where the task item and the to-do period to perform the task item are stored in a storage device, whether or not the binding period of the schedule item accepted in the step of accepting matches the to-do period of the task item; and

processing to control (e.g., in S50) a storage operation by the storage device by performing storage processing of instructing the storage device to store the schedule item accepted and its associated binding period such that the schedule item input and a task item, which is a to-do related item higher in order than the schedule item, are stored and interlinked with each other in the storage device so as to be managed uniformly.

The step of processing includes:

determining a storage disable condition to be satisfied and disabling the storage processing if a determination has been made in the step of determining that the binding period does not match the to-do period (e.g., in S43 if the answer is NO in S46), and

determining the storage disable condition to be satisfied and disabling the storage processing (e.g., in S43 if the answer is YES in S42) if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

A program according to yet another aspect of the present invention is designed to make a computer execute the steps of: accepting input (e.g., in S30, S40, and other steps) of a task item (such as “Specification Drafting” shown in FIG. 1) included in high-order to-do related items (such as project items and tasks) related to things to be done by a user and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

determining (e.g., in S46 and other steps), in a state where the task item and the to-do period to perform the task item are stored in a storage device, whether or not the binding period of the schedule item accepted in the step of accepting matches the to-do period of the task item; and

processing to control (e.g., in S50) a storage operation by the storage device by performing storage processing of instructing the storage device to store the schedule item accepted and its associated binding period such that the schedule item input and a task item, which is a to-do related item higher in order than the schedule item, are stored and interlinked with each other in the storage device so as to be managed uniformly.

The step of processing includes:

disabling the storage processing (e.g., in S43 if the answer is NO in S46) if a determination has been made in the step of determining that the binding period does not match the to-do period, and

also disabling the storage processing (e.g., in S43 if the answer is YES in S42) if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

A computer system according to still another aspect of the present invention includes: a storage device (such as the database 5 shown in FIG. 1 and the EEPROM 33 shown in FIG. 3A) configured to store to-do related items related to things to be done by a user and to-do periods when the things are scheduled to be done; and a processor (such as the CPU 30 shown in FIG. 3A).

The processor performs:

processing of accepting input (e.g., in S30, S40 and other steps) of a task item (such as “Specification Drafting” shown in FIG. 1) included in high-order to-do related items (such as projects and tasks) and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

processing of determining (e.g., in S46 and other steps), in a state where the task item and the to-do period to perform the task item are stored in the storage device, whether or not the binding period of the schedule item accepted in the processing of accepting matches the to-do period of the task item; and

processing of instructing (e.g., in S50 and other steps), provided that a determination has been made in the processing of determining that the binding period matches the to-do period, the storage device to store the schedule item accepted and its associated binding period such that the schedule item input and a task item, which is a to-do related item higher in order than the schedule item, are stored and interlinked with each other in the storage device so as to be managed uniformly.

The storage device is able to store a plurality of users' to-do related items (e.g., can store Taro's, Hanako's, . . . and Jiro's to-do related items).

The processing of instructing includes reference saving processing of instructing (e.g., in S104 shown in FIG. 8) the storage device to perform a save operation, in order to allow, as a memo, reference to another user's schedule item that is any of the to-do related items stored in the storage device.

The processing of accepting includes one's own schedule creating and accepting processing of allowing (e.g., in S40-S42 and S46-S49 shown in FIG. 5) the user to participate (e.g., in S52 shown in FIG. 5) in that another user's schedule item stored in the storage device and to create and input a one's own schedule item, which is a schedule item associated with the user's own to-do related item and corresponding to that another user's schedule item.

The processing of instructing includes performing (e.g., in S50) one's own schedule storage processing of instructing the storage device to store, and interlink with each other, the one's own schedule item and the task item to be performed following the one's own schedule item to allow the one's own schedule item and the task item to be managed uniformly.

A program according to yet another aspect of the present invention is designed to make a computer execute the steps of: accepting input (e.g., in S30, S40, and other steps) of a task item (such as “Specification Drafting” shown in FIG. 1) included in high-order to-do related items (such as projects and tasks) related to things to be done by a user and a schedule item (such as “Fifth Meeting Schedule to Meet Patent Attorney” 25 shown in FIG. 1) serving as a low-order to-do related item (such as a schedule) to be done to put the task item into practice, and input of a to-do period to perform the task item and a binding period when the user is bound to perform the schedule item;

determining (e.g., in S46 and other steps), in a state where the task item and the to-do period to perform the task item are stored in a storage device, whether or not the binding period of the schedule item accepted in the step of accepting matches the to-do period of the task item; and

instructing (e.g., in S50 and other steps), provided that a determination has been made in the step of determining that the binding period matches the to-do period, the storage device to store the schedule item accepted and its associated binding period such that the schedule item input and a task item, which is a to-do related item higher in order than the schedule item, are stored and interlinked with each other in the storage device so as to be managed uniformly.

The storage device is able to store a plurality of users' to-do related items (e.g., can store Taro's, Hanako's, . . . and Jiro's to-do related items).

The step of instructing includes a reference saving step of instructing (e.g., in S104 shown in FIG. 8) the storage device to perform a save operation, in order to allow, as a memo, reference to another user's schedule item that is any of the to-do related items stored in the storage device.

The step of accepting includes a one's own schedule creating and accepting step of allowing (e.g., in S40-S42 and S46-S49 shown in FIG. 5) the user to participate in that another user's schedule item stored in the storage device and to create and input a one's own schedule item, which is a schedule item associated with the user's own to-do related item and corresponding to that another user's schedule item.

The step of instructing includes a one's own schedule storage step of instructing (e.g., in S50) the storage device to store, and interlink with each other, the one's own schedule item and the task item to be performed following the one's own schedule item to allow the one's own schedule item and the task item to be managed uniformly.

### Advantages of the Invention

According to the present invention, a task item included in high-order to-do related items to be done by a user and a schedule item serving as a low-order to-do related item to be done to put the task item into practice are stored and interlinked with each other in a storage device so as to be managed uniformly. This reduces a mismanagement of the task and schedule items, saves the user trouble in management, and allows him or her to easily recognize correlation between the task and schedule items.

### BRIEF DESCRIPTION OF THE DRAWINGS

FIG. 1 Illustrates an overall system configuration.

FIG. 2 A functional block diagram.

FIG. 3A A block diagram illustrating a control circuit for a client terminal and a management server.

FIG. 3B A flow chart showing a main routine program to be executed by the client terminal and the management server.

FIG. 3C A flow chart showing a subroutine program for data editing processing and data editing response processing.

FIG. 4A A flow chart showing a subroutine program for project input processing.

FIG. 4B A flow chart showing a subroutine program for task input processing.

FIG. 5 A flow chart showing a subroutine program for schedule input processing.

FIG. 6 A flow chart showing a subroutine program for link creation processing.

FIG. 7A Illustrates a first exemplary mode of link verification.

FIG. 7B Illustrates a second exemplary mode of link verification.

FIG. 8 A flow chart showing a subroutine program for heteronomous schedule input processing.

FIG. 9 A flow chart showing a subroutine program for data loading processing (at the client end) and data loading response processing (at the server end).

FIG. 10 A flow chart showing a subroutine program for server data display processing (at the client end) and server data display response processing (at the server end).

FIG. 11 A flow chart showing a subroutine program for processing of designating a destination to which selected data needs to be loaded.

FIG. 12A A flow chart showing a subroutine program for data display processing.

FIG. 12B A flow chart showing a subroutine program for task display processing (task list).

FIG. 13A A flow chart showing a subroutine program for selected item display processing.

FIG. 13B A flow chart showing a subroutine program for schedule display processing (display of selected ranges of a calendar on a date, month, or year basis).

FIG. 14A A flow chart showing a subroutine program for task/schedule simultaneous display processing (display of a calendar and a range of a task list cooperating with its display range).

FIG. 14B A flow chart showing a subroutine program for overview display processing (tree).

FIG. 15 Illustrates changes of a normal screen.

FIG. 16 Illustrates changes of an overview display (tree) screen.

FIG. 17A Illustrates an exemplary overview display (tree) screen.

FIG. 17B Illustrates another exemplary overview display (icon) screen.

FIG. 18A Illustrates still another exemplary overview display (list) screen.

FIG. 18B Illustrates yet another exemplary overview display (column) screen.

FIG. 19A Illustrates a new project editing screen.

FIG. 19B Illustrates an existent project editing screen.

FIG. 20A Illustrates a new task editing screen.

FIG. 20B Illustrates an existent task editing screen.

FIG. 21A Illustrates a new schedule editing screen.

FIG. 21B Illustrates a new schedule editing screen (with automatic task creation).

FIG. 22A Illustrates an existent schedule editing screen.

FIG. 22B Illustrates a new heteronomous schedule editing screen.

FIG. 23A Illustrates a new heteronomous schedule editing screen (with automatic task creation).

FIG. 23B Illustrates an existent heteronomous schedule editing screen.

FIG. 24A Illustrates internal changes of a normal screen.

FIG. 24B Illustrates an exemplary to-dot list display screen.

FIG. 25 Illustrates changes of a to-do list display screen.

FIG. 26 Illustrates an exemplary task (to-do list)/schedule (calendar) simultaneous display screen.

FIG. 27A Illustrates changes from a calendar display screen to other screens.

FIG. 27B Illustrates internal changes of the calendar display screen.

FIG. 28 Illustrates an exemplary monthly schedule (calendar) display screen.

FIG. 29 Illustrates an exemplary biweekly schedule (calendar) display screen.

FIG. 30A Illustrates an exemplary weekly schedule (calendar) display screen.

FIG. 30B Illustrates an exemplary daily schedule (calendar) display screen.

FIG. 31A A flow chart showing a main routine program to be executed by a client terminal and a management server according to a variation.

FIG. 31B A flow chart showing a subroutine program for data editing processing and data editing response processing according to another variation.

FIG. 32 A flow chart showing a subroutine program for server synchronization processing (at the client end) and server synchronization response processing (at the cloud server end) according to still another variation.

FIG. 33 Illustrates how to install, into a computer, an application software program stored in a storage medium (such as a CD-ROM).

### DESCRIPTION OF EMBODIMENTS

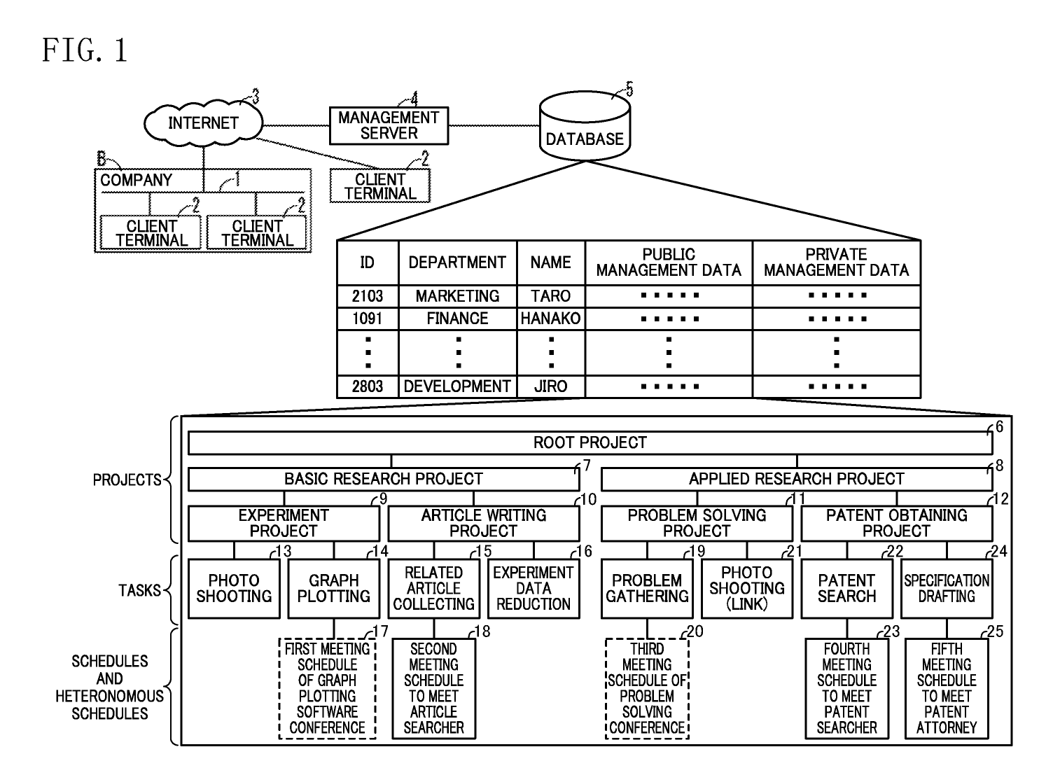

Embodiments of the present invention will now be described in detail with reference to the accompanying drawings. FIG. 1 illustrates an overall configuration for a computer system according to the present invention. This computer system is designed to perform interlinked management of schedules (such as appointments) and jobs (such as tasks). To an in-house local area network (LAN) 1 of Company B, connected are a plurality of client terminals 2, 2, . . . , which are connected to the Internet 3 via the in-house LAN 1. A management server 4 is connected as a cloud of servers to the Internet 3. Furthermore, a client terminal 2, which is a mobile terminal used outside of Company B by its employee, for example, is also connected to the management server 4 via the Internet 3. The plurality of client terminals 2, 2, . . . do not operate stand-alone but operate in accordance with a client-server model. Note that a situation where these client terminals 2, 2, . . . operate stand-alone will be described later as a variation. The client terminals 2 are operated by employees (hereinafter also referred to as “users”) belonging to marketing, finance, development, and other departments within the same company. In the database 5 of the management server 4, stored in association with each other are the identifications (IDs) of those employees, the names of the departments the employees belong to, the employees' names, and management data for performing management of projects, tasks, schedules, and heteronomous schedules (to be described later). The management data is comprised of public management data about the schedules, tasks, and other items subjected to shared management on the server by respective employees and private management data about the schedules, tasks, and other items managed personally by the individual employees. Optionally, the private management data may be stored by the individual employees on local client terminals 2, for example, without being stored in the database 5 of the management server 4.

For example, an employee with the ID 2803 belongs to the development department, is called Jiro, and has his management data (such as the one shown in FIG. 1) stored in the database 5. Specifically, as for the database 5, an application server for managing the database is provided for the database 5 and is configured to perform control of managing and extracting various types of data in the database.

The management data shown in FIG. 1 is classified, on a related item basis, into multiple hierarchical layers including a high-order to-do related item to be performed and one, two or more low-order to-do related items to be performed in association with the high-order to-do related item, and is input by Jiro, who is operating his own client terminal 2.

For example, supposing a situation where a particular technological development job needs to be done, the management data may be classified into the three stages, namely, a project stage related to various projects including a basic research project 7 and an applied research project 8, a task stage related to a single or a plurality of tasks to be done to put the project into practice, and a schedule stage related to a single or a plurality of schedules and heteronomous schedules (to be described later) to be observed to put the tasks into practice.

Thus, in the management data, everything about this technological development job is classified into multiple items on a stage-by-stage basis. Specifically, the management data is classified into: project items representing the contents and details of projects to be performed on the highest-order project stage; task items representing the contents and details of a single or a plurality of tasks to be done on the task stage in association with the projects; and schedule items representing the contents and details of a single or a plurality of schedules to be observed on the schedule stage in association with the tasks. The respective items are managed as related item units so as to be associated with their to-do periods. The management server 4 can further manage the heteronomous schedules to be described in detail later.

The project items represent the contents and details of a new technological development project. These project items are classified into the three hierarchical layers, namely, the highest-order ROOT project, intermediate-order project items immediately subordinate to the ROOT project, and a single or a plurality of low-order project items associated with the intermediate-order project items.

The intermediate-order project items include a basic research project item representing the contents and details of a basic research project 7, and an applied research project item representing the contents and details of an applied research project 8 related to the basic research project.

The low-order project items include an experiment project item and article writing project item respectively representing the contents and details of an experiment project 9 and an article writing project 10 to be done in, or involved with, putting the basic research project 7 into practice. The low-order project items further include a problem solving project item and a patent obtaining project item respectively representing the contents and details of a problem solving project 11 and a patent obtaining project 12 to be done in, or involved with, putting the applied research project 8 into practice.

The task items represent the contents and details of specific tasks to be done in, or involved with, putting into practice the respective projects, namely, the experiment project 9, the article writing project 10, the problem solving project 11, and the patent obtaining project 12. Examples of these task items include: photo shooting and graph plotting items associated with the experiment project 9; related article collecting and experiment data reduction items associated with the article writing project 10; problem gathering and photo shooting items associated with the problem solving project 11; and patent search and specification drafting items associated with the patent obtaining project 12.

The photo shooting item and graph plotting item respectively represent the contents and details of the tasks called “Photo Shooting” 13 and “Graph Plotting” 14 to be done in, or involved with, putting the experiment project 9 into practice. The related article collecting item and experiment data reduction item respectively represent the contents and details of the tasks called “Related Article Collecting” 15 and “Experiment Data Reduction” 16 to be done in, or involved with, putting the article writing project 10 into practice.

The problem gathering item and the photo shooting item respectively represent the contents and details of the tasks called “Problem Gathering” 19 and “Photo Shooting” 21 to be done in, or involved with, putting the problem solving project 11 into practice. The patent search item and specification drafting item respectively represent the contents and details of the tasks called “Patent Search” 22 and “Specification Drafting” 24 to be done in, or involved with, putting the patent obtaining project 12 into practice.

The schedule items represent the contents and details of schedules to be observed in, or involved with, putting the respective tasks of “Related Article Collecting” 15, “Patent Search” 22, and “Specification Drafting” 24 into practice. Examples of the schedule items include a second meeting schedule item to meet an article searcher, a fourth meeting schedule item to meet a patent searcher, and a fifth meeting schedule item to meet a patent attorney.

In FIG. 1, a first meeting schedule item related to a graph plotting software conference is a heteronomous schedule saved as a memo by the user in order to make reference to another user's schedule in association with the “Graph Plotting” 14. Likewise, a third meeting schedule item related to a problem solving conference is a heteronomous schedule saved as a memo by the user in order to make reference to another user's schedule in association with the “Problem Gathering” 19. These heteronomous schedules will be described later.

The first meeting schedule item represents the contents and details of the “First Meeting Schedule of Graph Plotting Software Conference” 17 to be observed in, or involved with, putting the task called “Graph Plotting” 14 into practice. The second meeting schedule item represents the contents and details of the “Second Meeting Schedule to Meet Article Searcher” 18 to be observed in, or involved with, putting the task called “Related Article Collecting” 15 into practice. The third meeting schedule item represents the contents and details of the “Third Meeting Schedule” 20 to be observed for, or involved with, overcoming the problem of a researcher in putting the task called “Problem Gathering” 19 into practice. The fourth meeting schedule item represents the contents and details of the “Fourth Meeting Schedule to Meet Patent Searcher” 23 to be observed in, or involved with, putting the task called “Patent Search” into practice. The fifth meeting schedule item represents the contents and details of the “Fifth Meeting Schedule to Meet Patent Attorney” 25 to be observed in, or involved with, putting the task called “Specification Drafting” into practice.

The project described above herein refers to a project established to achieve a certain goal. The highest-order project is the ROOT project 6, which is statically (i.e., automatically) stored in the client terminal 2 when the software of this system is installed. Thus, there is no need for any employee (user) to manually input this ROOT project 6.

For each of these projects, a to-do timing (specifically, a to-do period), indicating the exact period of time in which the project is supposed to be performed, is set. As can be seen, the “to-do period” of a project herein refers to a period afforded to an employee (user) to realize the project, and will be hereinafter referred to as a “grace period” in the following description of embodiments. The ROOT project 6 has an infinite grace period. Meanwhile, a finite grace period is set for each of the basic research project 7 and applied research project 8. The experiment project 9 and the article writing project 10 are specific projects to be done to realize the basic research project 7 higher in order than these projects 9 and 10. Therefore, the grace periods of these specific projects are set within the range of the grace period of the basic research project 7 that is immediately higher in order than those projects. Likewise, the grace periods of the problem solving project 11 and the patent obtaining project 12 are also set within the range of the grace period of the applied research project 8 that is immediately higher in order than those projects.

Next, a task herein refers to a specific job to be done to put its associated project into practice. The tasks to be done to realize the experiment project 9 include “Photo Shooting” 13 and “Graph Plotting” 14. The to-do timings (specifically, the to-do periods) of these tasks fall within the range of the grace period of the experiment project 9 that is immediately higher in order than those projects. The to-do period of a task indicates the exact period of time in which the task is supposed to be done. As can be seen, the “to-do period” of a task herein refers to a period afforded to an employee (user) to achieve the task, and will be hereinafter referred to as a “grace period” in the following description of embodiments. The tasks to be done to realize the article writing project 10 include “Related Article Collecting” 15 and “Experiment Data Reduction” 16. The grace periods of these tasks should also fall within the range of the grace period of the article writing project 10 that is immediately higher in order than those projects. The tasks to be done to realize the problem solving project 11 include “Problem Gathering” 19 and “Photo Shooting (Link)” 21. The grace periods of these tasks should also fall within the range of the grace period of the problem solving project 11 that is immediately higher in order than those projects. Likewise, the grace periods of the tasks called “Patent Search” 22 and “Specification Drafting” 24 should also fall within the range of the grace period of the patent obtaining project 12 that is immediately higher in order than those projects. As used herein, a “link” is a piece of information indicating the location of an already created task (hereinafter referred to as “entity” or “real data”) and generated at a different location from the entity's immediately superordinate project.

The “Photo Shooting” 21 subordinate to the problem solving project 11 is a link to the “Photo Shooting” 13 subordinate to the experiment project 9. Although not shown in FIG. 1, not only a task link but also a project link may be introduced as well. Introducing such links allows a particular project or task to be subordinate to a plurality of projects at the same time.

Next, a schedule herein refers to a to-do related item such as an appointment to be observed for an immediately superordinate task, for which a binding period is set. This binding period is defined to fall within the range of the grace period of the immediately superordinate task. In the case of the management data shown in FIG. 1, there is a schedule entitled “Second Meeting Schedule to Meet Article Searcher” 18 as a schedule subordinate to the task called “Article Collecting” 15. There is a schedule entitled “Fourth Meeting Schedule to Meet Patent Searcher” 23 as a schedule subordinate to the task called “Patent Search” 22. There is a schedule entitled “Fifth Meeting Schedule to Meet Patent Attorney” 25 as a schedule subordinate to the task called “Specification Drafting” 24. In FIG. 1, the “First Meeting Schedule” item related to a “Graph Plotting Software Conference” is a heteronomous schedule saved as a memo by the user in order to make reference to another user's schedule in association with “Graph Plotting” 14. Likewise, the “Third Meeting Schedule” item related to a “Problem Solving Conference” is a heteronomous schedule saved as a memo by the user in order to make reference to another user's schedule in association with “Problem Gathering 19.” These heteronomous schedules will be described later.

In FIG. 1, “Third Meeting Schedule of Problem Solving Conference” 20 is indicated by the dashed rectangle. This “Third Meeting Schedule of Problem Solving Conference” 20 is a piece of information about another employee's schedule saved as reference information. In arranging this schedule, the user may make reference to another employee's normally created schedule and take notes of it and save it as heteronomous data in his or her own management data.

For example, suppose a situation where Taro, who belongs to the marketing department, has gathered clients' feedback and information about the problems with a new product and has recorded a schedule for solving the problems. In that case, the “Third Meeting Schedule of Problem Solving Conference” 20 is a useful task and schedule for Jiro as well in solving problems in applied research. Suppose another exemplary situation where Taro working for the marketing department has arranged a schedule to attend a product planning briefing event in a certain field. Data is stored in the form of a timetable that says, in the product planning briefing, a planning presentation is scheduled from 10 to 12, and a specific product briefing is scheduled from 13 to 14. In this timetable, Jiro may be interested in the “Planning Presentation,” among other things. This computer system is configured to allow Jiro to browse through another employee's (e.g., Taro' s) management data, and take notes of the schedule and save it for future reference.

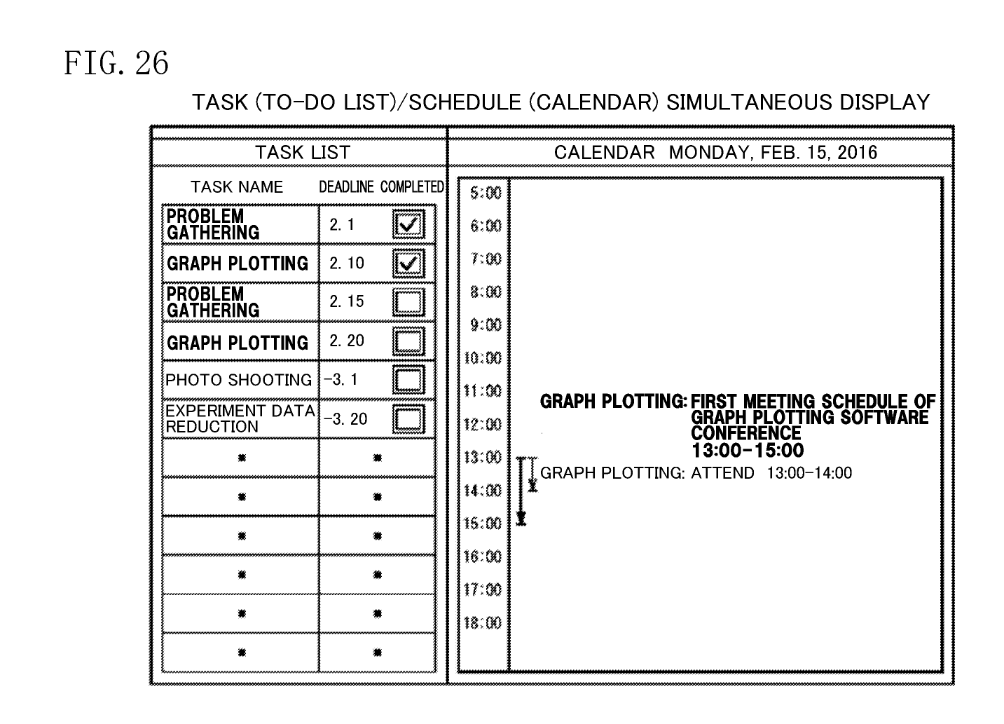

In FIG. 1, the “First Meeting Schedule of Graph Plotting Software Conference” indicated by the dashed rectangle is also a heteronomous schedule. This schedule has been taken notes of, and saved, by the user who is making reference to another user's schedule about the task called “Graph Plotting.” As for this “First Meeting Schedule of Graph Plotting Software Conference,” as shown in the calendar display area to be described later with reference to FIG. 26, for example, the name of a heteronomous schedule “Graph Plotting” is followed by the title of the heteronomous schedule “First Meeting Schedule of Graph Plotting Software Conference” with 13:00-15:00 indicated as a scheduled meeting period. The user may participate in this heteronomous schedule and create and enter his or her own schedule item, which is a schedule item associated with his or her own to-do related item and corresponding to that another user's schedule item. In the example illustrated in FIG. 26, in the scheduled meeting period 13:00-15:00 of the heteronomous schedule, the user expresses his or her agreement to participate in the meeting only 13:00-14:00, and has created and entered his or her own schedule with a binding period of 13:00-14:00. This user's own schedule is not shown in FIG. 1.

In the management data described above, a project has a grace period, and plays the role of a search path for managing a project or task (job) subordinate to that project and links thereof and indicating their locations. As used herein, the “path” is a character string indicating the location of data in a computer. For example, a path to the patent obtaining project 12 is “C:/ROOT Project/Applied Research Project.” As can be seen from this example, the path indicates a high-order project path leading from the ROOT project 6 to that project, and the end project becomes a parent project immediately superordinate to that project. Every project but the ROOT project (i.e., the highest-order project) 6 and its link are subordinate to any one of the projects in the hierarchical structure, and restricted to the grace period of the higher-order project. Note that the official name of a “project” is represented by the name of the full path from the ROOT project 6. Even if two or more “projects” have the same name, those projects are recognized as totally different “projects” unless they are linked to each other.

Just like a project, each task and its link are subordinate to any one of the projects and have their own grace period. Each task includes, as its division units, an arbitrarily number of schedules (appointments) and heteronomous schedules.

Each schedule, as well as a task, has a period. Nevertheless, a schedule is supposed to store the limited times of a user's (employee's) scheduled action, and therefore, its period is a binding period divided within the grace period of its superordinate task. Therefore, a “schedule” is a sort of a “task” record to be managed based on its binding period as a key.

As can be seen, the management data is resident, in a memory, as a tree structure comprised of high-order projects branching from the highest-order ROOT project 6, low-order projects further branching from the high-order projects, tasks subordinate to those low-order projects, and schedules subordinate to those tasks, as shown in FIG. 1, for example.

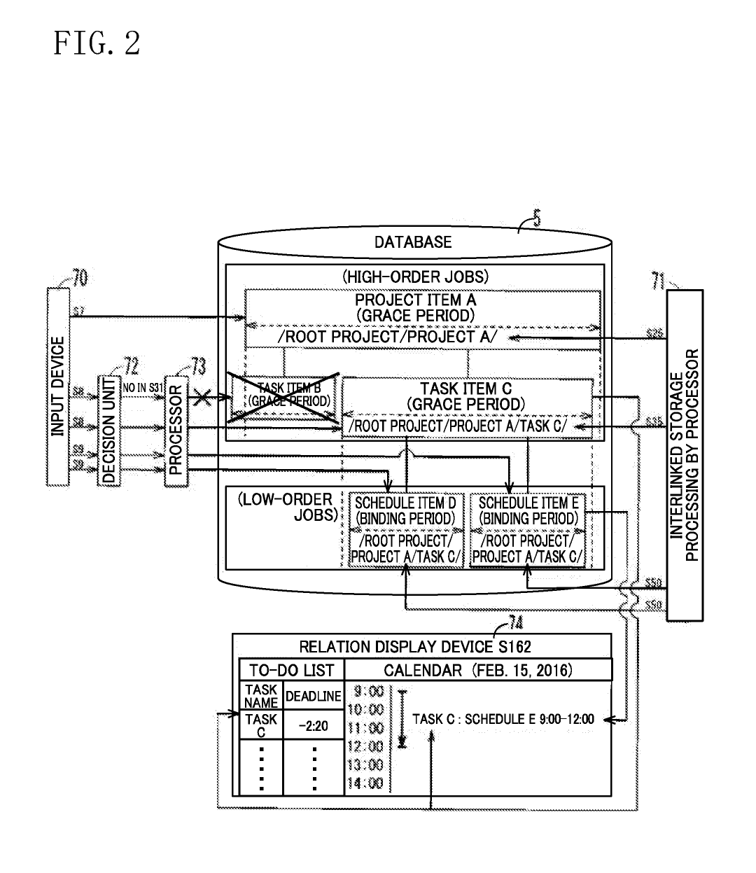

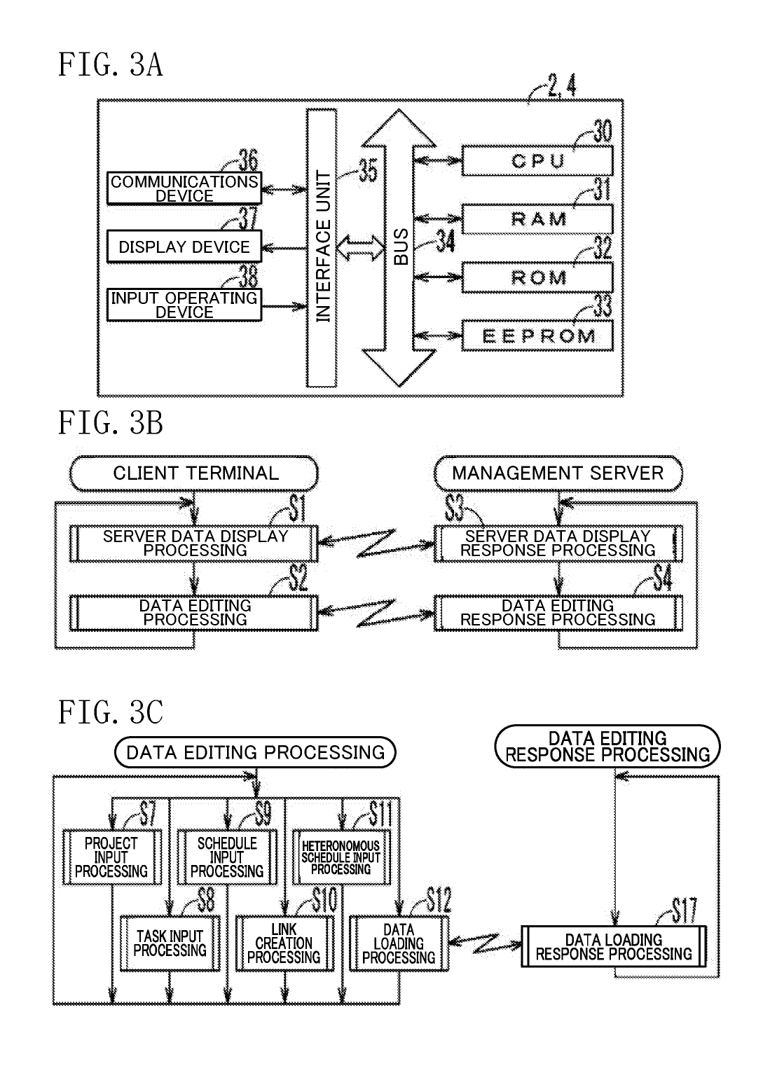

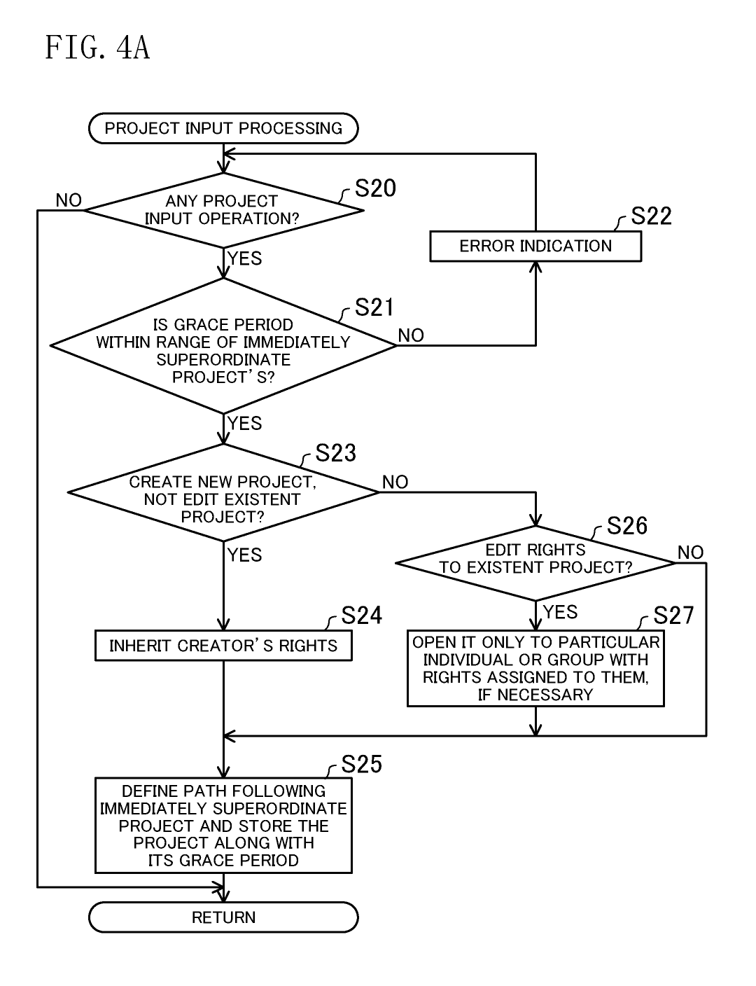

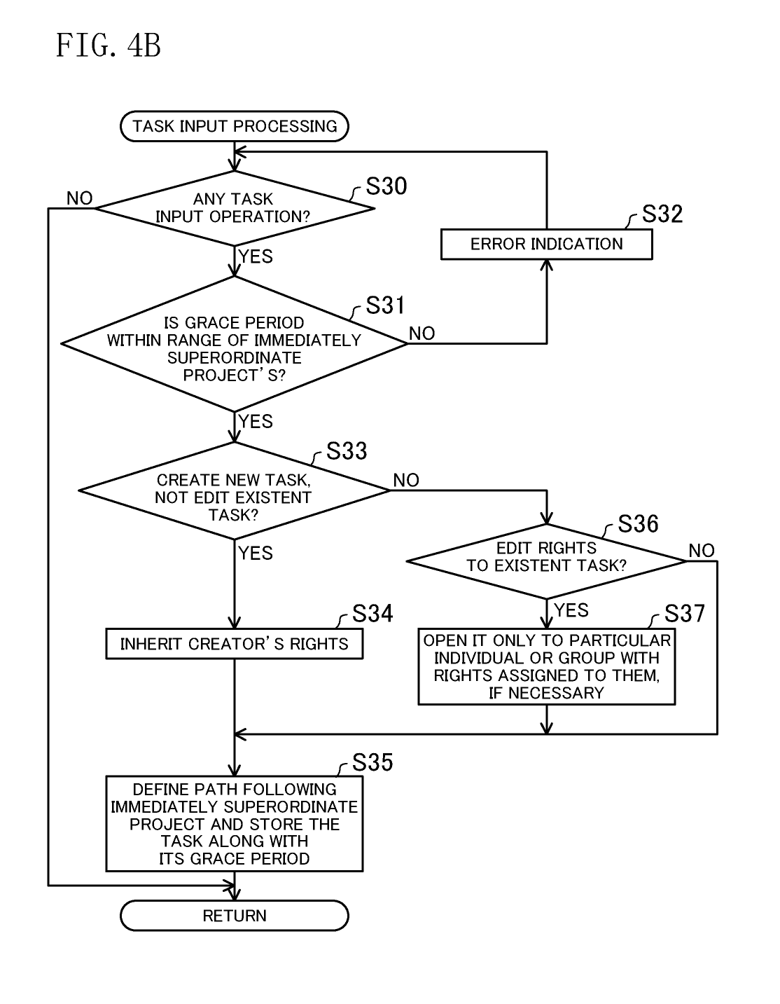

Next, it will be described with reference to FIG. 2 how a computer system according to this embodiment works. The computer system includes: a database 5 as an exemplary storage device; and an input device 70 allowing the user to input, into the database 5, a to-do related item, related to a thing to be done by him or her, and its grace period serving as its to-do period. If the user inputs Project Item A, which is an exemplary to-do related item, and its grace period via the input device 70, project input processing (see S7 in FIG. 3C) is performed to store Project Item A and its grace period in the database 5. In the meantime, a processor 73 performs interlinked storage processing 71, thereby creating a path (ROOT Project/Project A/) for Project Item A and storing the path in the database 5 (see S25 in FIG. 4A). The project immediately higher in order than Project Item A is ROOT Project. A path following ROOT Project, namely, “ROOT Project/Project A/,” is created and stored in the database 5.

If Task Item B immediately subordinate to Project Item A and its grace period are input via the input device 70 (see S8 in FIG. 3C), a decision unit 72 determines whether or not the grace period of Task Item B matches the grace period of Project Item A. Specifically, the decision unit 72 determines whether or not the grace period of Task Item B falls within the range of the grace period of Project Item A (see S31 in FIG. 4B). As shown in FIG. 2, if the grace period of Task Item B is not entirely within the grace period of Project Item A (i.e., if the answer is NO in S31), then the processor 73 does not store Task Item B in the database 5. In FIG. 2, the cross mark on “Task Item B” indicates that this task item is not stored in the database 5.

If Task Item C and its grace period are input via the input device 70 (see S8 in FIG. 3C), the decision unit 72 determines whether or not the grace period of Task Item C matches the grace period of Project Item A immediately superordinate to Task Item C. Specifically, the decision unit 72 determines whether or not the grace period of Task Item C falls within the range of the grace period of Project Item A (see S31 in FIG. 4B). If the former falls within the range of the latter (i.e., if the answer is YES in S31), then the processor 73 stores Task Item C and its grace period in the database 5. In the meantime, the processor 73 performs interlinked storage processing 71, thereby creating a path (ROOT Project/Project A/Task C/) for Task Item C and storing the path in the database 5 (see S35 in FIG. 4B). The project immediately higher in order than Task Item C is Project Item A. The path following Project Item A, namely, “ROOT Project/Project A/Task C/” is created and stored in the database 5.

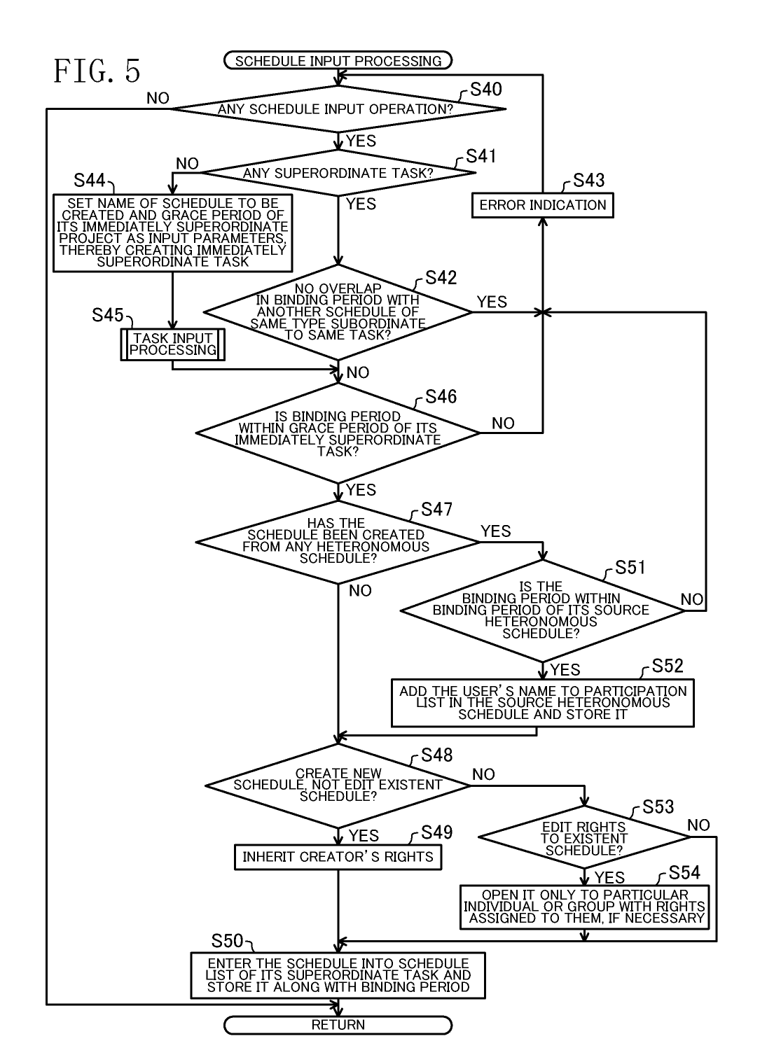

Next, if Schedule Item D and its binding period are input via the input device (see S9 in FIG. 3C), the decision unit 72 also determines, just as described above, whether or not the binding period of Schedule Item D matches the grace period of Task Item C immediately superordinate to Schedule Item D. Specifically, the decision unit 72 determines whether or not the binding period of Schedule Item D falls within the range of the grace period of Task Item C (see S46 in FIG. 5). If the former falls within the range of the latter (i.e., if the answer is YES in S46), then the processor 73 stores Schedule Item D and its grace period in the database 5 (see S50 in FIG. 5). In the meantime, the processor 73 performs interlinked storage processing 71, thereby defining the same path (ROOT Project/Project A/Task C/) as that of Task Item C immediately superordinate to Schedule Item D to be the path for that Schedule Item D.

Next, if Schedule Item E and its binding period are input via the input device (see S9 in FIG. 3C), the decision unit 72 also determines, just as described above, whether or not the binding period of Schedule Item E matches the grace period of Task Item C immediately superordinate to Schedule Item E. Specifically, the decision unit 72 determines whether or not the binding period of Schedule Item E falls within the range of the grace period of Task Item C (see S46 in FIG. 5). If the former falls within the range of the latter (i.e., if the answer is YES in S46), then the processor 73 stores Schedule Item E and its grace period in the database 5 (see S50 in FIG. 5). In the meantime, the processor 73 performs interlinked storage processing 71, thereby defining the same path (ROOT Project/Project A/Task C/) as that of Task Item C immediately superordinate to Schedule Item E to be the path for that Schedule Item E.

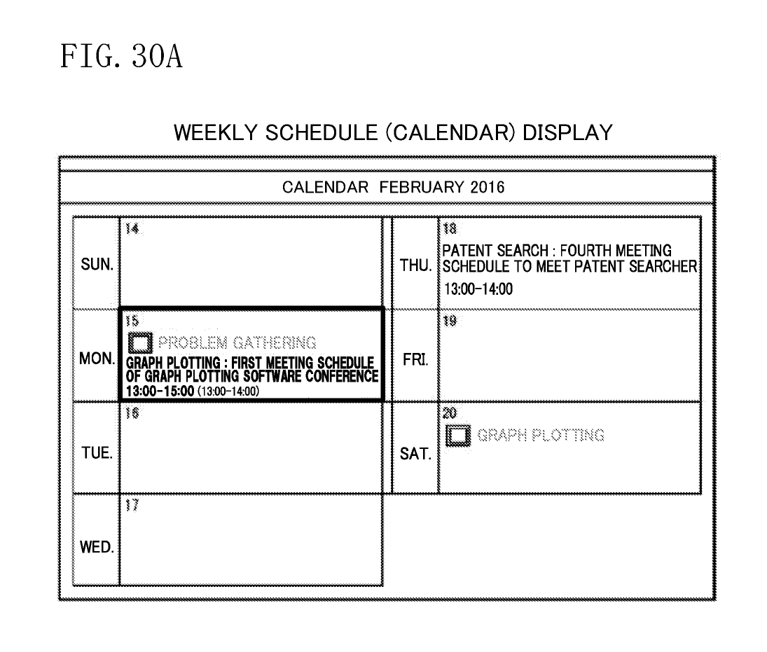

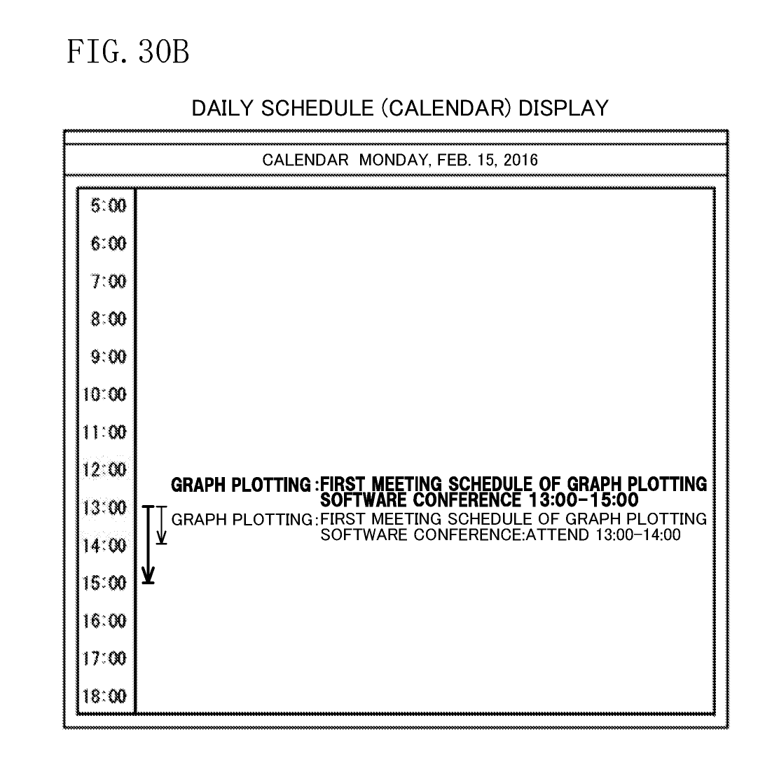

As can be seen, the interlinked storage processing 71 is carried out by the processor 73 such that a plurality of related items over multiple layers (e.g., Task Item C and Project Item A immediately superordinate to Task Item C) are associated with each other via a path, which is a character string indicating the storage location of data in the computer, and stored in the database 5. This allows those related items over multiple layers to be uniformly managed and interlinked with each other. As a result, a schedule and tasks immediately superordinate to the schedule, for example, may be displayed simultaneously. For example, in the one-week display of a schedule (calendar) to be described later (see FIG. 30A), the all-day schedule of “Graph Plotting” is displayed. This should be displayed as a to-do list (task list). In FIG. 30A, however, only the calendar is displayed, and therefore, “Graph Plotting” is displayed as the all-day schedule on the calendar. On the other hand, if a task list and a calendar are displayed simultaneously as shown in FIG. 26, control is performed such that “Graph Plotting” is not displayed as a part of the calendar but as an item of the task list. This type of control is realized by the interlinked storage and uniform management of schedules, heteronomous schedules, and tasks, which is one of the advantages of the uniform management.

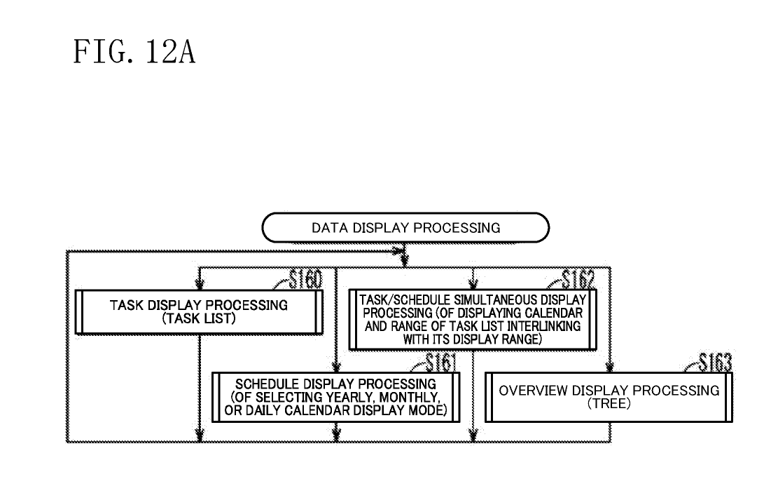

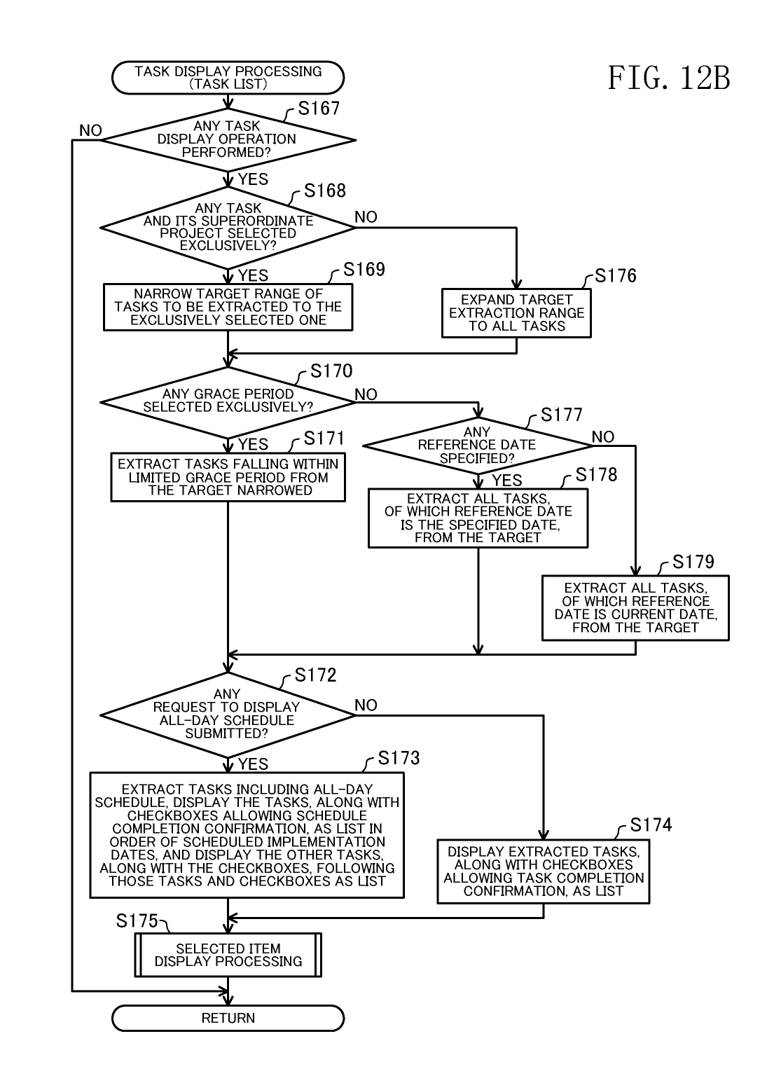

Also, as indicated by the relation display device shown in FIG. 2 (see S162 shown in FIG. 12A), Task C with no input schedules yet is displayed on the to-do list. However, the control is performed such that no sooner at least one schedule is input to that Task C than Task C is removed from the to-do list and comes to be displayed on the calendar. This type of control is realized by the interlinked storage and uniform management of schedules, heteronomous schedules, and tasks, which is one of the advantages of the uniform management.

Next, hardware circuits for the client terminals 2, 2, . . . and the management server 4 will be described with reference to FIG. 3A. A CPU (central processing unit) 30 functioning as the core of control, a ROM (read-only memory) 32 storing control programs and control data, a RAM (random access memory) 31 serving as a work area for the CPU 30, and an EEPROM (electrically erasable programmable read-only memory) 33 storing data in a rewritable state, are coupled together via a bus 34. The bus 34 is connected to various types of devices through an interface unit 35. Examples of the various types of devices include a communications device 36, a display device 37, and an input operating device 38. The communications device 36 allows the client terminals 2 to communicate with the management server 4 through the in-house LAN 1.

Next, the flow of a main routine program to be executed by one of the client terminals 2 and the management server 4 will be described with reference to FIG. 3B. The program for the client terminal 2 and the program for the management server 4 are downloaded from a website, where various kinds of third party application software programs are uniformly collected to be distributed, and installed. The CPU 30 of the client terminal 2 performs server data display processing in Step (hereinafter simply referred to as “S”) 1 and then performs data editing processing in S2.

This server data display processing S1 is performed to allow the user (employee) to display edited management data on the client terminal 2. The data editing processing S2 is performed to newly input or update the management data shown in FIG. 1. Data or a command is selected in the server data display processing S1 and the selected command is executed on the selected data in the data editing processing S2. If the client terminal 2 has performed the server data display processing S1, the management server 4 performs, in S3, server data display response processing, which is a control operation to be performed responsive to the processing S1. Also, if the client terminal 2 has performed the data editing processing S2, then its associated management data stored in the database 5 of the management server 4 also needs to be updated into new one. For that purpose, the CPU 30 of the management server 4 performs data editing response processing in S4.

Next, the flow of a subroutine program for the data editing processing S2 and the data editing response processing S4 will be described with reference to FIG. 3C. In the data editing processing, six program modules S7-S12 are selected and executed in parallel with each other. In this case, control may be performed such that these six program modules are sequentially selected and executed on a one-by-one basis in the order of S7→S8→S9→S10→S11→S12→S7, for example.

The project input processing S7 is processing allowing the user (employee) to input a “project” in the management data by operating the input operating device 38 of the client terminal 2. The task input processing S8 is processing allowing him or her to input a “task” in the management data. The schedule input processing S9 is processing allowing him or her to input a “schedule” in the management data. As will be described in detail later, the schedule input processing S9 further includes processing allowing him or her to create his or her own schedule (hereinafter referred to as an “autonomous schedule”) based on a heteronomous schedule. The link creation processing S10 is processing for creating a link to previously input real data about a task or a project as in the “Photo Shooting (Link)” 21 described above. The heteronomous schedule input processing S11 is processing allowing the user to newly create a heteronomous schedule or to edit the rights to an existent heteronomous schedule.

The data loading processing S12 is processing allowing the user to load another user's “schedule” as a piece of reference information into his or her own management data and save the schedule. In response to this data loading processing S12, the management server 4 performs data loading response processing S17. This data loading response processing S17 is processing of transmitting a source employee's opened (shared) management data to be downloaded to a destination employee's client terminal 2.

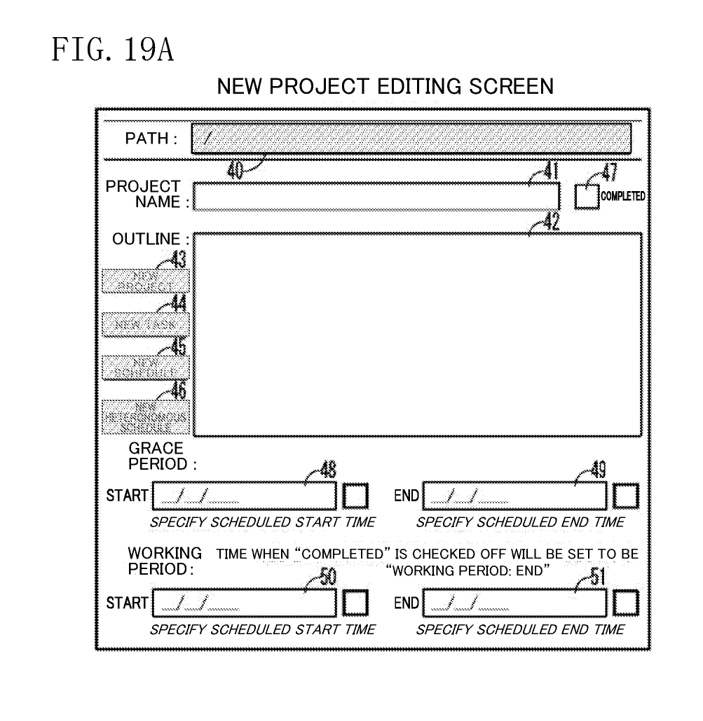

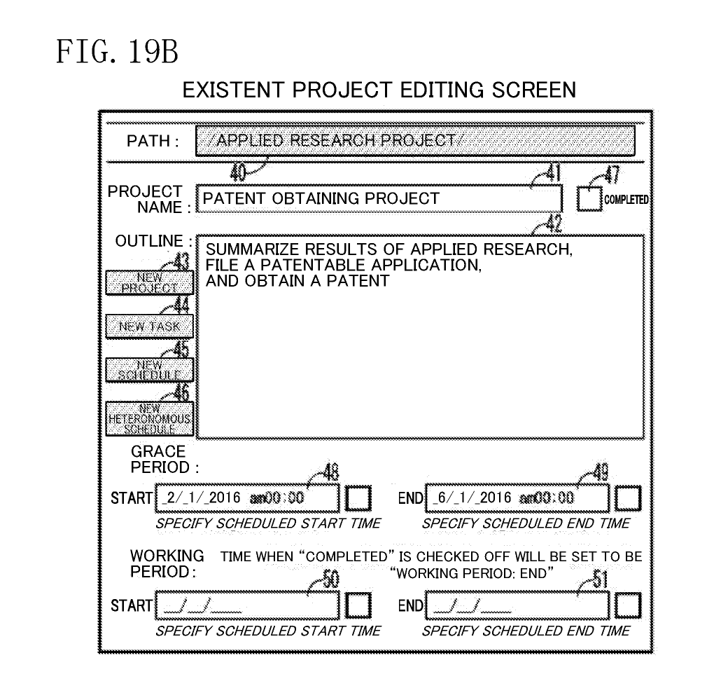

Next, the flow of a subroutine program for the program input processing S7 will be described with reference to FIG. 4A. This project input processing is processing allowing the user to input his or her own project by entering data into the editing screens shown in FIGS. 19A and 19B (to be described later). First, a determination is made in S20 whether or not any project input operation has been performed. If the answer is NO, this subroutine program for the project input processing returns such that the next task input processing S8 starts to be performed. On the other hand, if the employee has performed any project input operation by operating the input operating device 38 of the client terminal 2, the answer will be YES in S20. In that case, the control proceeds to S21. When it turns out in S20 that any project input operation has been performed, designation of an immediately superordinate project, indicating what high-order project the project to be input is subordinate to, and the grace period of the project to be input are entered.

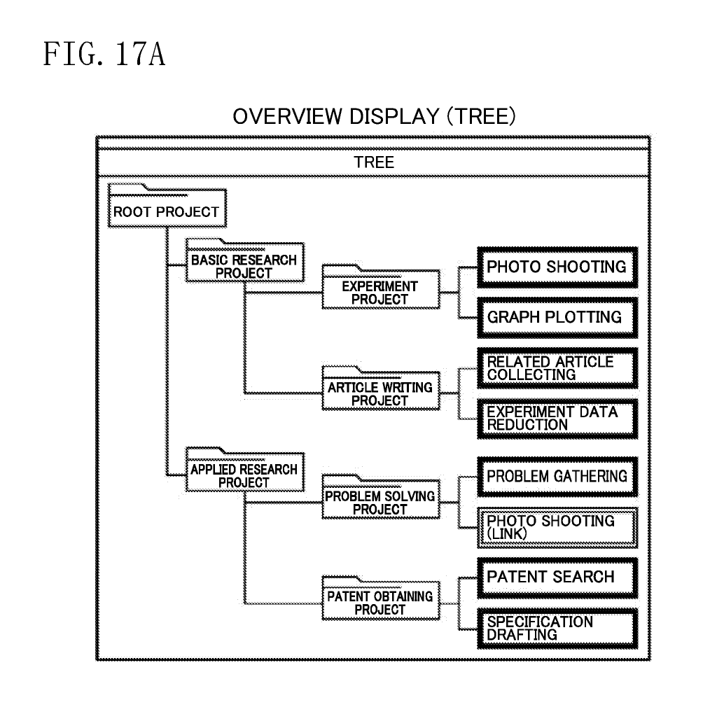

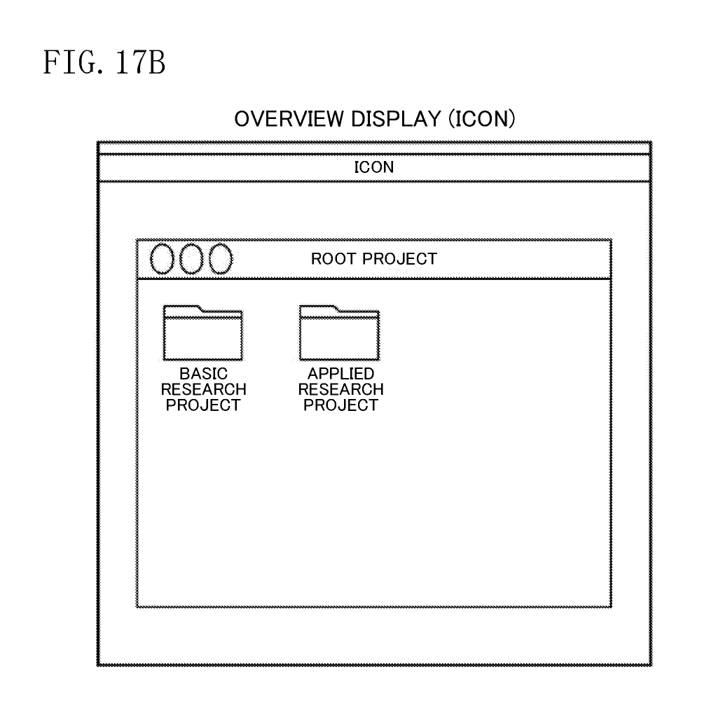

For example, in the overview display (tree) screen shown in FIG. 17A, the immediately superordinate project “ROOT Project” may be designated, “Applied Research Project” may be input as the name of the project, and “from Feb. 1, 2016 (Heisei 28) through Dec. 1, 2016 (Heisei 28)” may be input as the grace period. Note that the “ROOT Project” already exists statically, and therefore does not have to be newly created. On a startup application basis, there always is a single highest-order project with an infinite grace period as a special project. Every item is uniquely identified by a path originating from the highest-order project. Actually, in the case of servers, there is a “ROOT Project” for each administrator user, who allocates a “Virtual ROOT Project,” which is immediately subordinate to the “ROOT Project” as a management unit, for each user.

Next, the control proceeds to S21, in which a determination is made whether or not the grace period input falls within the range of the grace period of its immediately superordinate project (e.g., within the grace period of the applied research project). If the grace period input falls out of the range of the grace period of the immediately superordinate project, then the control proceeds to S22, in which the display device 37 of the client terminal 2 makes an error indication. Thereafter, the control goes back to S20. This error indication includes displaying an error message that says, for example, “Please input a grace period again, because the grace period of the project you have input falls out of the range of the grace period of the immediately superordinate project.”

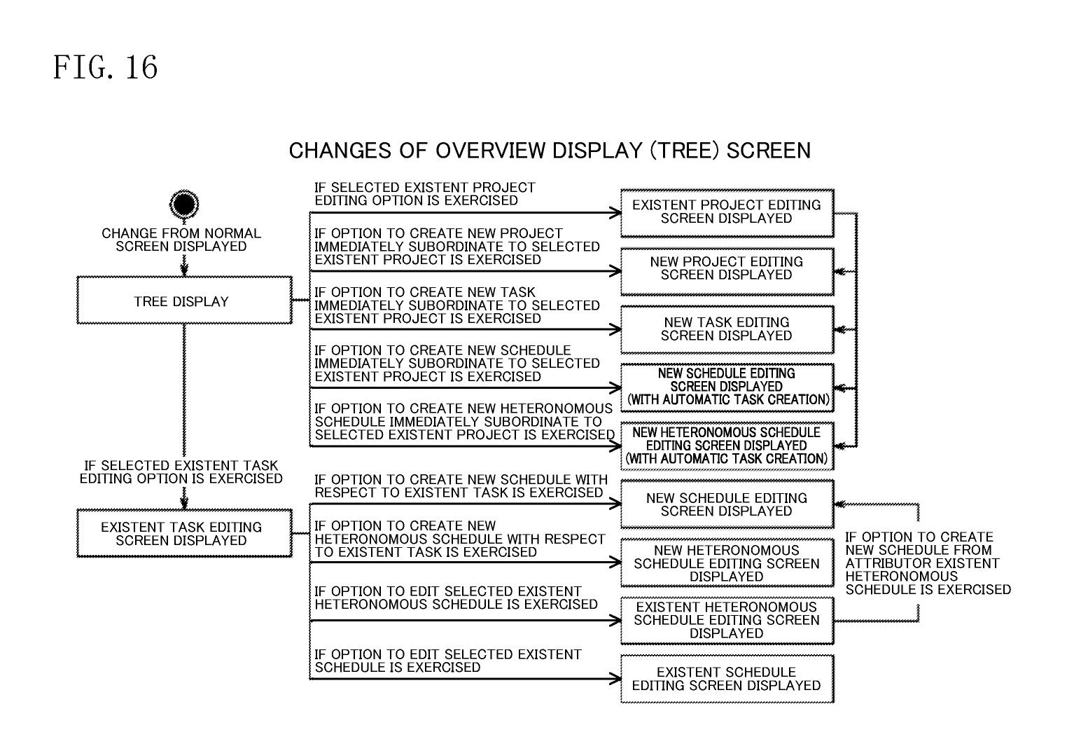

If the user, having looked at this error indication, has re-input a correct grace period, then the answer becomes YES in S20 this time, and the control proceeds to S21. If the grace period has turned out, in S21, to fall within the range of the grace period of the immediately superordinate project, then the control proceeds to S23, in which a determination is made whether or not a new project is going to be created, instead of editing an existent project. For example, if a new project editing option is picked up in the tree display as shown in FIG. 16, the new project editing screen shown in FIG. 19A (to be described later) is displayed on the display device 37 of the user's client terminal 2, the name and grace period of the project and other data are input as will be described later, and then the contents are stored in the database 5.

Then, if the answer is YES in S23, the control proceeds to S24, in which the creator's rights (such as access right) are inherited as for the newly created project. For each user (who is an employee), his or her rights to access or edit various kinds of data have been set in advance. In S24, a control operation is performed such that the rights set for that user are inherited as for the newly created project. Next, the control proceeds to S25, in which a control operation is performed such that a path leading to the immediately superordinate project (such as the ROOT project) is defined and the project is stored, along with the grace period, in the database 5. Every project is supposed to be closed when created newly.

Meanwhile, if an existent project editing option is picked up in the tree display shown in FIG. 16, for example, then the answer becomes NO in S23, and the existent project editing screen shown in FIG. 19B is displayed on the display device 37. On this existent project editing screen, the outline, grace period, and other parameters specified as will be described later for an existent project (e.g., a patent obtaining project in the example shown in FIG. 19B) are edited by the user and then stored in the database 5. Then, in S26, a determination is made whether or not the rights to the existent project should be edited. If the answer is YES, the control proceeds to S27, in which processing is performed to edit the rights to the existent project. If necessary, a control operation is performed to make the project public by setting rights (such as the access right) for a particular individual or group. When the processing step S27 is done, the control proceeds to S25. Likewise, even if the answer is NO in S26 (i.e., even if the rights to the existent project need not be edited), the process also proceeds to S25, in which the outline, grace period, and other parameters of the project edited by the user are stored.

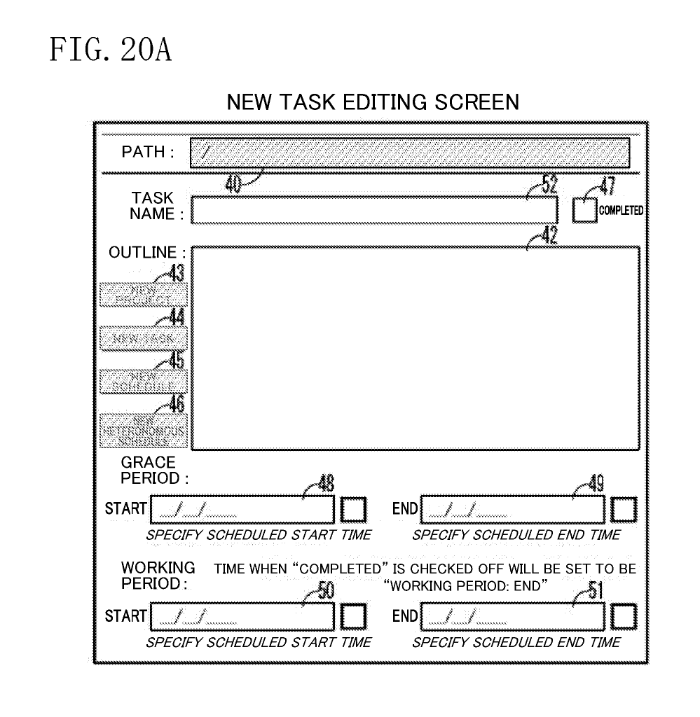

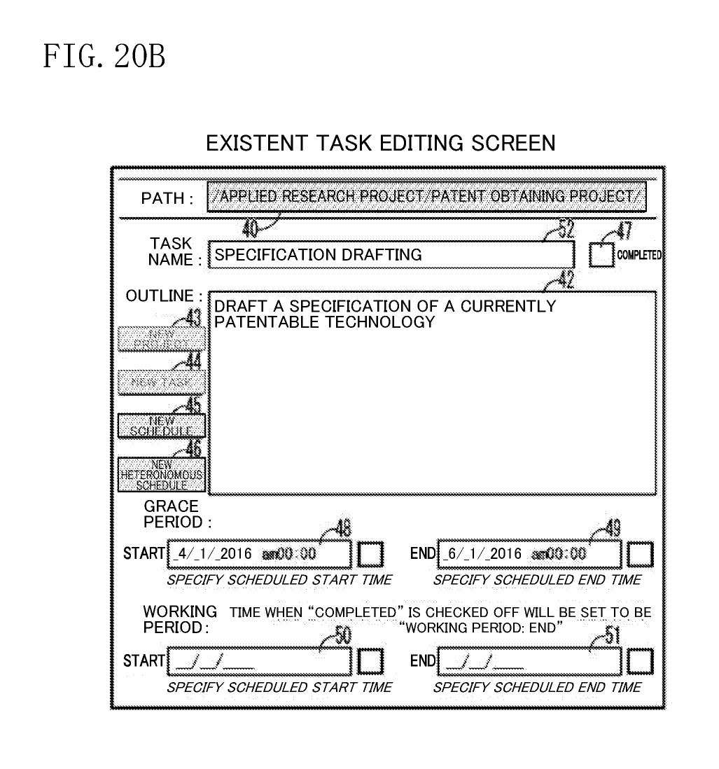

Next, the flow of a subroutine program for the task input processing S8 will be described with reference to FIG. 4B. This task input processing is processing allowing the user to input his or her own task by entering data into the editing screens shown in FIGS. 20A and 20B (to be described later). First, a determination is made in S30 whether or not any task input operation has been performed. If the answer is NO, this subroutine program for the task input processing returns such that the next schedule input processing S9 starts to be performed. On the other hand, if the user has performed any task input operation by operating the input operating device 38 of the client terminal 2, the answer will be YES in S30. In that case, the control proceeds to S31. In the task input operation that has been performed if the answer is YES in S30, the user, who has designated the immediately superordinate project “Patent Obtaining Project” on the overview display (tree) screen shown in FIG. 17A, has performed an operation of newly creating a task. As a result, the new task editing screen shown in FIG. 20A is displayed on the display device 37 to allow the user to input the name of the task and its grace period.

If any of these parameters has been input, the control proceeds to S31, in which a determination is made whether or not the grace period input falls within the range of the grace period of its immediately superordinate project. If the grace period input falls out of the grace period of the immediately superordinate project, then the control proceeds to S32, in which the display device 37 of the client terminal 2 makes an error indication. Thereafter, the control goes back to S30. This error indication includes displaying an error message that says, for example, “Please input a grace period again, because the grace period of the task you have input falls out of the range of the grace period of the immediately superordinate project.”

Note that the project that a task is immediately subordinate to is only a substantive project which does not include any project link. Therefore, if any project link has been selected and specified, then an error indication is made in S32. If the grace period input has turned out to fall within the range of the grace period of the immediately superordinate project, then the control proceeds to S33, in which a determination is made whether or not a new task is going to be created, instead of editing an existent task. Then, if the new task editing option is picked up in the tree display shown in FIG. 16, for example, then the answer is YES in S33, and the control proceeds to S34, in which the creator's rights (such as access right) are inherited.

Next, the control proceeds to S35, in which processing is performed such that a path leading to the immediately superordinate project is defined and the task is stored, along with the grace period, in the database 5. For example, a path for the task of “Specification Drafting” 24 becomes “C:/ROOT Project/Applied Research Project/Patent Obtaining Project/Specification Drafting.” As can be seen, storing a project and its related task in association with each other allows the project and the task to be interlinked with each other and managed uniformly. This allows the user to not just manage his or her tasks and schedules but also do a series of job management over the entire range from a high-order to-do related item such as a project, for which the task is performed, down to the level of low-order ones. As used herein, the “uniform management” refers to making a collective management using the same means or tool. Every task is supposed to be closed when created newly.

Meanwhile, if an existent task editing option is picked up in the tree display shown in FIG. 16, for example, then the answer becomes NO in S33, and the existent task editing screen shown in FIG. 20B is displayed on the display device 37 to allow the user to edit the outline, grace period, and other parameters of the task that has been input by him or her as the object of editing.

If the user is going to edit the rights to the existent task, then the answer becomes YES in S36, and the control proceeds to S37, in which processing is performed to edit the rights to the existent task. If necessary, a control operation is performed to make the task opened by setting rights (such as the access right) for a particular individual or group. When the processing step S37 is done, the control proceeds to S35. Likewise, even if the rights to the existent task need not be edited, the process also proceeds to S35, in which the outline, grace period, and other parameters of the task edited by the user are stored.

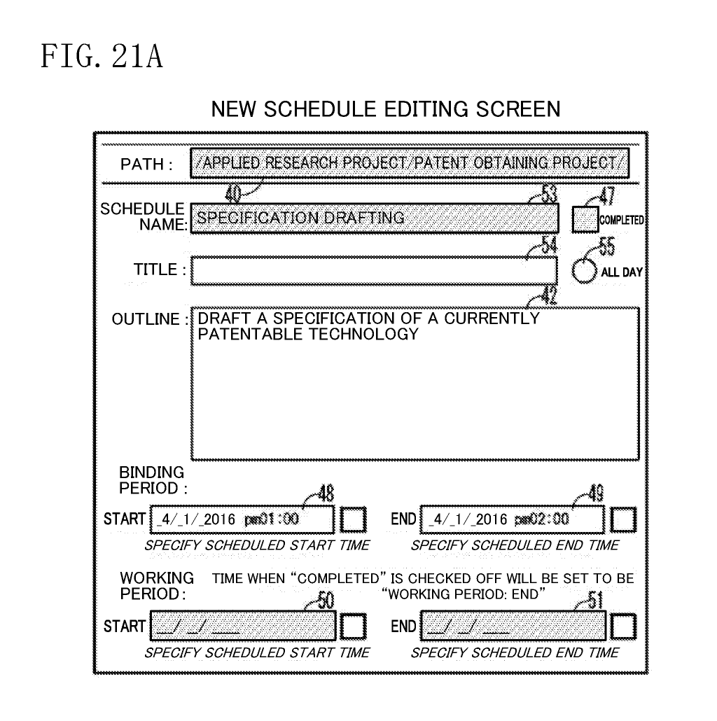

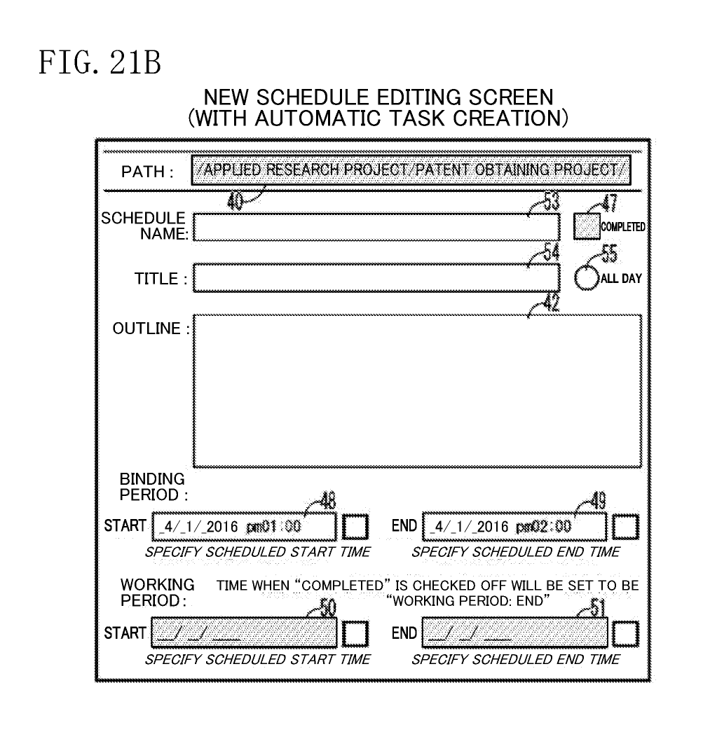

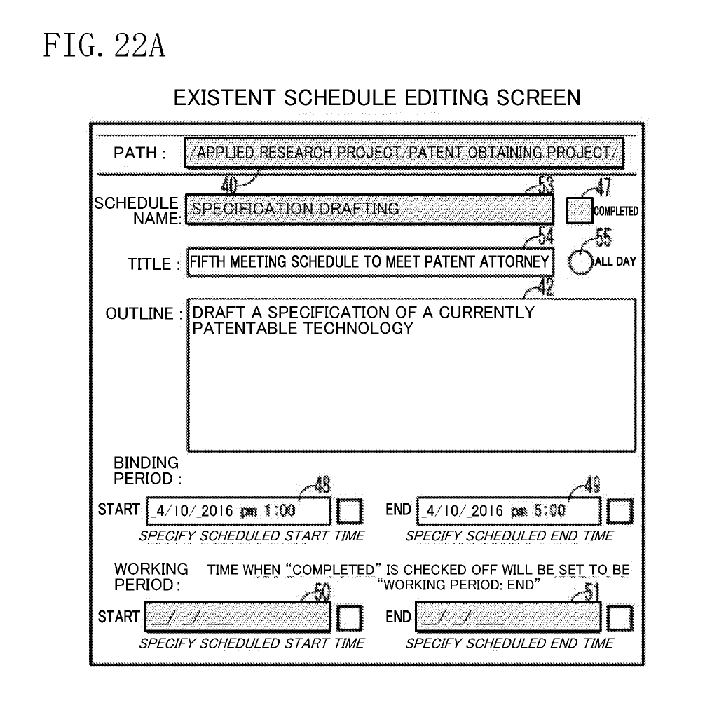

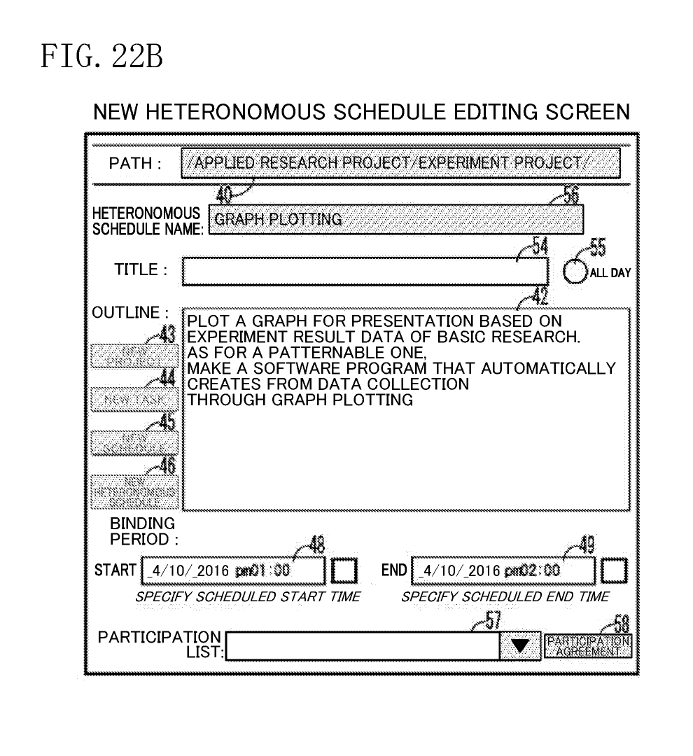

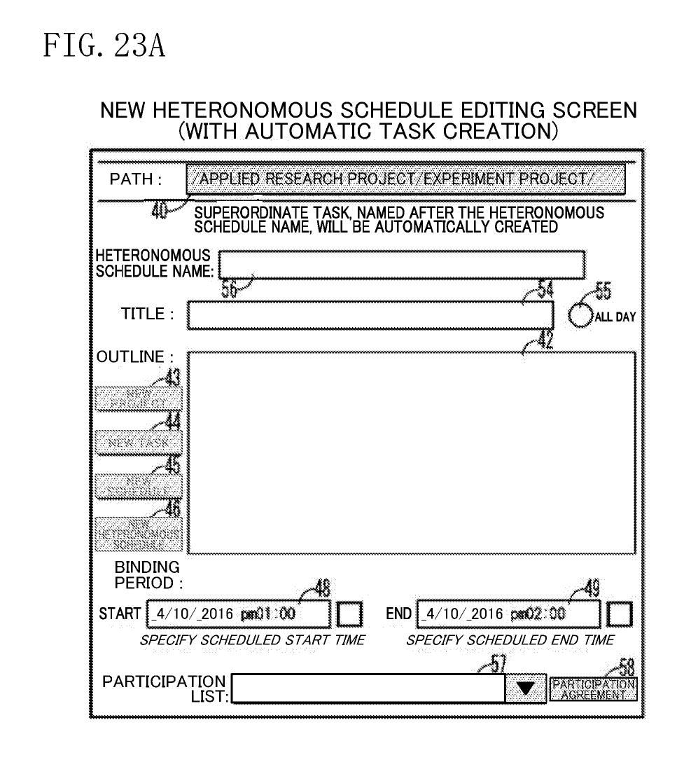

Next, the flow of a subroutine program for the schedule input processing S9 will be described with reference to FIG. 5. This schedule input processing is processing allowing the user to input his or her own schedule by entering data into the editing screens shown in FIGS. 21A-22A (to be described later). First, a determination is made in S40 whether or not any schedule input operation has been performed. If the answer is NO, this subroutine program for the schedule input processing returns such that the next link creation processing S10 starts to be performed. If the user has picked up the new schedule creating, new schedule creating (with automatic task creation), existent schedule editing, or existent heteronomous schedule editing option in the tree display shown in FIG. 16 by operating the input operating device 38 of the client terminal 2, for example, then the answer is YES in S40, and the control proceeds to S41, in which a determination is made whether or not there is any immediately superordinate task. If any option other than the new schedule editing option (with automatic task creation) is exercised among those options, then the answer is YES in S41, and the control proceeds to S42, in which a determination is made whether or not the binding period of the schedule overlaps either entirely or only partially with that of any other schedule of the same type, which is also subordinate to the same immediately superordinate task. If there is any overlap between their binding periods, the control proceeds to S43, in which the display device 37 of the client terminal 2 makes an error indication and then the control goes back to S40. As described above, there are two types of schedules, namely, autonomous schedules and heteronomous schedules. In S42, the “schedule of the same type” means excluding a type of schedule dissimilar to either an autonomous schedule or a heteronomous schedule. If, in a situation where User A's autonomous schedule and its binding period have already been stored, the same User A's autonomous schedule and binding period are input, the binding period already stored may overlap with the binding period newly input. If that is the case, an error indication is made in S43. Therefore, the answer becomes YES in S42 if, in a situation where a schedule item input as a particular user's own to-do related item and a task item, which is a to-do related item immediately higher in order than the schedule item, have already been stored and interlinked with each other in the database 5, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period. Also, if the respective binding periods of two schedules of dissimilar types that are subordinate to the same task overlap with each other or if the respective binding periods of two schedules that are subordinate to mutually different tasks overlap with each other, then a control operation is performed such that an alert is displayed to attract the user's attention and then the user is prompted to decide whether or not he or she still wants to continue the input. For example, if, when User A's autonomous Task B and its binding period C are input, the same User A's Schedule F, which is subordinate to Task E different from Task D that is a to-do related item immediately higher in order than autonomous Task B, and its binding period G have already been stored, the binding periods C and G may overlap with each other. A control operation may also be performed such that an error indication is made in S43 even in such a situation. That is to say, according to the present invention, an error indication is made in S43 at least if the binding period of one schedule overlaps with that of another schedule of the same type in a situation where the former and latter schedules are both immediately subordinate to the same task (i.e., if the answer is YES in S42). That is to say, an error indication may also be made in S43 even if the binding period of one schedule subordinate to one task overlaps with that of another schedule subordinate to another task. Furthermore, as for the error control to be performed when the respective binding periods overlap with each other, an “autonomous schedule” may be the only type of schedule. If the respective binding periods of two schedules overlapped with each other, then the person in charge could not put into practice one of the two overlapping schedules. Thus, the error indication made in S43 is a control operation to be performed to avoid such an inconvenience. This error indication includes displaying an error message that says, for example, “Please input a binding period again, because the binding period of the schedule you have input overlaps with the binding period of another schedule.” Meanwhile, if there is no overlap, then the control proceeds to S46.

On the other hand, if there are no immediately superordinate tasks and the new schedule editing option (with automatic task creation) is currently exercised, the new schedule editing screen (with automatic task creation) shown in FIG. 21B is displayed on the display device 37 and then the control proceeds to S44. As used herein, the new schedule editing option (with automatic task creation) is an editing option allowing the user to create a schedule with no immediately superordinate tasks created. According to this option, before a schedule starts to be created, tasks immediately superordinate to that schedule need to be created. Thus, in S44, the name of the schedule to be created and the grace period of its immediately superordinate project are set as parameters to be input, thereby creating a task immediately superordinate to the task that should have been created. This processing is performed in S45 (see FIG. 4B). In S45, the grace period of the immediately superordinate project input is copied as the grace period of the task to be created. When S45 is done, the control proceeds to S46. In S46, a determination is made whether or not the binding period of that schedule falls within the range of the grace period of the immediately superordinate task. If the former period falls out of the range of the latter, the control proceeds to S43, in which the display device 37 of the client terminal 2 makes an error indication and then the control goes back to S40. This error indication includes displaying an error message that says, for example, “Please input a binding period again, because the binding period of the schedule you have input falls out of the range of the grace period of the immediately superordinate task.”

Alternatively, if the binding period falls within the range of the grace period, then the control proceeds to S47, in which a determination is made whether or not that schedule has been created from any heteronomous schedule. As described above, there are two types of schedules, namely, autonomous schedules and heteronomous schedules. As used herein, the “heteronomous schedule” refers to a type of schedule, such as a meeting, in which others (e.g., other employees (users)) participate and are involved. Thus, the binding period of such a “heteronomous schedule” may not be set or changed of anyone's own free will. On the other hand, the “autonomous schedule” refers herein to a schedule in which no others participate or are involved, and may have its binding period set or changed of the user's own free will.

Then, if the new schedule editing, new schedule editing (with automatic task creation), or existent schedule editing option is currently exercised, then the answer is NO in S47, and the control proceeds to S48, in which a determination is made whether or not any schedule should be newly created, instead of editing an existent schedule. If the new schedule editing or new schedule editing (with automatic task creation) is currently exercised, then the control proceeds to S49, in which the creator's rights (such as access right) are inherited. Next, the control proceeds to S50, in which processing is performed such that the schedule is entered into the schedule list of its superordinate task and then stored, along with the binding period, in the database 5. This storage processing may also be performed on an autonomous schedule created based on the heteronomous schedule (i.e., if the answer is YES in S47). Every schedule and every heteronomous schedule are supposed to be closed when created newly.

Meanwhile, if the existent schedule editing option is currently exercised, then the answer becomes NO in S48, and the existent schedule editing screen shown in FIG. 22A is displayed on the display device 37 to allow the user to edit the outline, binding period, and other parameters of the schedule that has been designated by him or her as the object of editing. If the binding period needs to be edited, then the answer becomes NO in S53 to make the control return once. Thereafter, when the control arrives at S42 and S46 in the next loop of the main routine (see FIG. 3B), the determinations of S42 and S46 will be made. If the answers are YES and NO, respectively, an error indication will be made in S43. Subsequently, the control proceeds to S53, in which processing is performed to edit the rights to the existent schedule. If necessary, a control operation is performed to make the schedule open by setting rights (such as the access right) for a particular individual or group. When the processing step S54 is done, the control will proceed to S50.

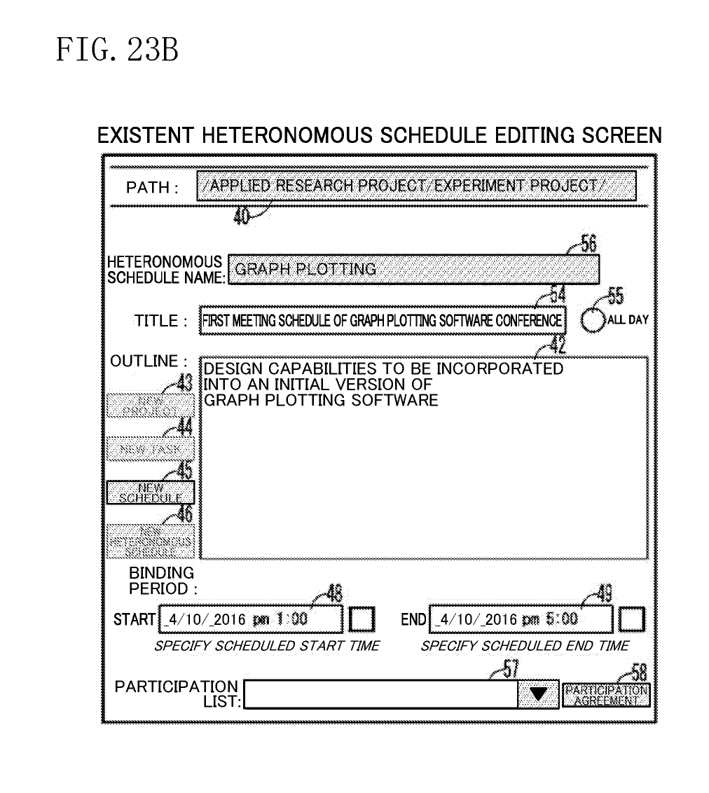

If the existent heteronomous schedule editing option is currently exercised and the Participation Agreement button 58 shown in FIG. 23B is being clicked on, then the control proceeds to S51. Clicking on the Participation Agreement button 58 is an operation that allows the user to participate in the heteronomous schedule opened and shared in S108 to be described later. In S51, a determination is made whether or not the binding period of the schedule to be created falls within the range of the binding period of the heteronomous schedule on which the former schedule will be created. Basically, in the case of a heteronomous schedule, even if the binding period (active period) thereof falls out of the range of the grace period of the immediately superordinate task, no error indication will be made (but an alert will still be displayed). This is because a heteronomous schedule just needs to be present as a reference item within the same task, and therefore, is not affected by the grace period of the task to which the heteronomous schedule is subordinate.

Nevertheless, once the user participates in the heteronomous schedule, then the participator's own schedule (autonomous schedule) will be created and entered and the heteronomous schedule will no longer be a mere reference item. For this reason, the determination of S51 needs to be made. If the binding period of the schedule to be created is not entirely within the binding period of the heteronomous schedule on which the former schedule will be created, then the control proceeds to S43, in which the display device 37 of the client terminal 2 makes an error indication. Thereafter, the control goes back to S40. This error indication includes displaying an error message that says, for example, “Please input a binding period again, because the binding period of the schedule you are going to create falls out of the range of the binding period of the heteronomous schedule on which your schedule will be created.”

If the answer is YES in S51, then the control proceeds to S52, in which an autonomous schedule corresponding to a heteronomous schedule (e.g., the name may be “Problem Gathering” 19 and the title may be “Third Meeting Schedule of Problem Solving Conference” 20 as indicated by the dashed rectangle in FIG. 1) is created and entered. This “autonomous schedule” will be hereinafter referred to as a “schedule created from an attributor heteronomous schedule.” Also performed is the processing of entering and storing the name of the user, who has expressed his or her participation agreement, into the participation list of the heteronomous schedule, on which his or her schedule will be created. This participation list is stored in the database 5. If the user plans to participate in the event for a shorter period of time than the actual scheduled duration of the event, then not the Participation Agreement button 58 but a New Schedule button may be used to display a new schedule editing screen (see FIG. 21A). In that case, the user can also express his or her participation agreement by setting and creating a shortened binding period. When the processing step S52 is done, the control proceeds to S48. Note that if the heteronomous schedule is opened and shared by the management server 4, its participation list may also serve as a list of schedules created from the associated attributor heteronomous schedule.

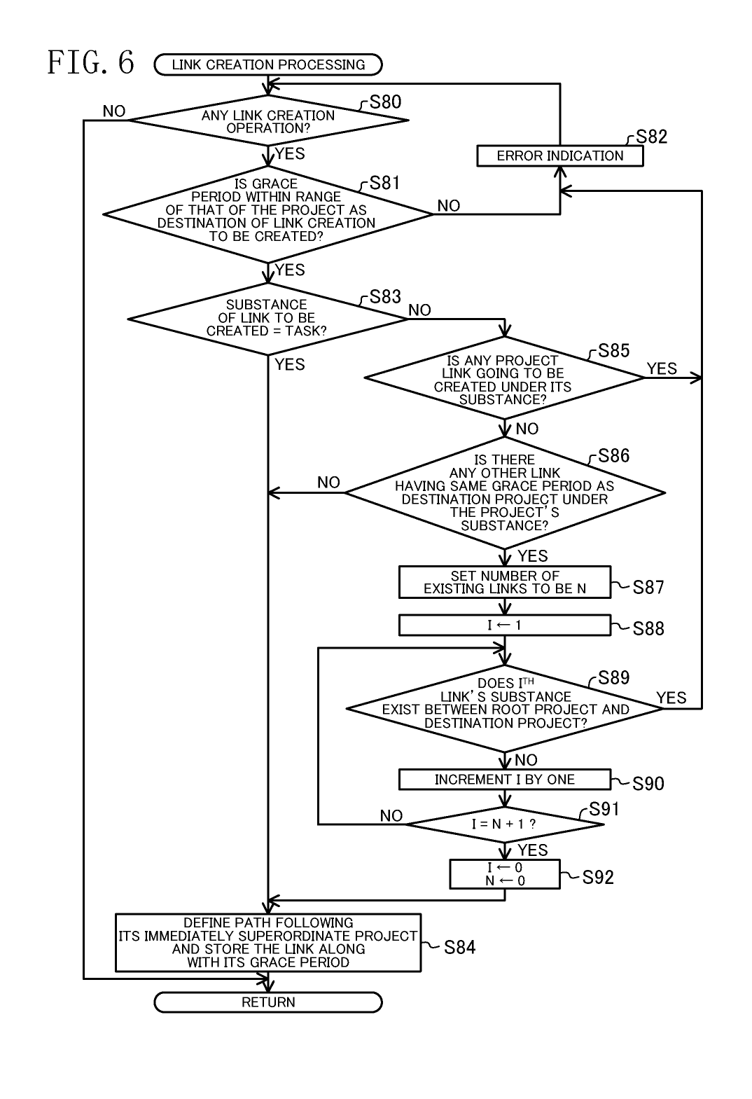

Next, the flow of a subroutine program for the link creation processing S10 mentioned above will be described with reference to FIG. 6. In S80, a determination is made whether or not any link creation operation has been performed. If the answer is NO, then the control returns. On the other hand, if the user has performed any link creation operation by operating the input operating device 38 of the client terminal 2, then the control proceeds to S81. This link creation operation allows the user to specify a link target (such as “Photo Shooting”) and designate and input an immediately superordinate project (such as the problem solving project). Specifying the “Photo Shooting” as a link target may be specifying the “Photo Shooting” 13 subordinate to the experiment project 9 shown in FIG. 1, for example.

In S81, a determination is made whether or not the grace period falls within the range of that of the immediately superordinate project. In the example described above, a determination is made whether or not the grace period of the “Photo Shooting” 13 specified as a link target falls within the range of the grace period of the problem solving project 11 as an immediately superordinate project. If the former grace period turns out to fall out of the range of the latter, the control proceeds to S82, in which the display device 37 of the client terminal 2 makes an error indication and then the control goes back to S80.

On the other hand, if the grace period falls within the range of that of the immediately superordinate project, then the control proceeds to S83, in which a determination is made whether or not the entity of the link to be created is a task. As used herein, the “entity of the link” refers to a substantive task or project, of which the location is determined by that link. There are two types of possible link targets, namely, a “task” and a “project.” If the link target is a “task,” then the answer is YES in S83 and the control proceeds to S84, in which processing is performed such that a path leading to the immediately superordinate project is defined and stored, along with the grace period, in the database 5. For example, a path defined for the “Photo Shooting (Link)” 21 may be “C:/ROOT Project/Applied Research Project/Problem Solving Project/Photo Shooting.”

Alternatively, if the entity of the link to be created is a “project,” the control proceeds to S85, in which a determination is made whether or not a link to that project is going to be created in a layer under that entity. As already described with reference to FIG. 1, “projects” include high-order projects such as the basic research project 7 and the applied research project 8 and low-order projects such as the experiment project 9 and the problem solving project 11, and have a hierarchical structure. That is why allowing a link to a project to be created in a layer under its entity would lead to forming a contradictory structure in which a project exists under the project itself. In the example illustrated in FIG. 1, a link to the applied research project 8 is created contradictorily in a layer under the applied research project 8 itself.

That is why if a link to a project is going to be created in a layer under its entity, then a control operation is performed such that the answer becomes YES in S85 and an error indication is made in S82. This error indication includes displaying an error message that says, for example, “Please input a link again to create it in a correct hierarchical layer, because the link to the project you have input is going to be created in a layer under its entity.” If the answer is NO in S85, the control proceeds to S86. On the other hand, if the entity of the link to be created is a task (i.e., if the answer is YES in S83), a link to that task cannot be created in any layer under the link's entity. Thus, in this case, it is sufficient to see if the project that is the destination of the link has a grace period that is equal to or shorter than that of the link.

Next, the outline of the series of processing steps S86-S92 will be described first. A determination is made (in S86) whether or not in a layer under the entity of a project link to be created, there is any other link having the same grace period as the project that is the destination of link creation. If the answer is YES, a determination is made (in S89) whether or not the entity of that link exists between the ROOT project and the project as the destination. If the answer is YES, an error indication is made (in S82).

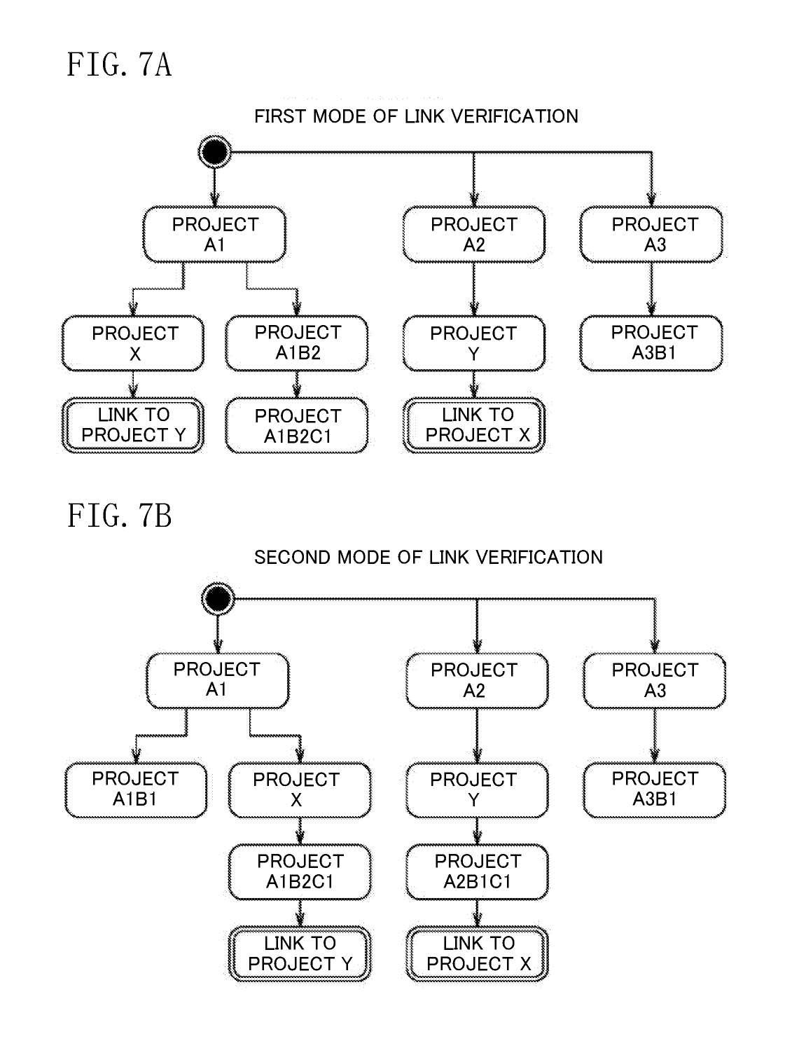

This will be described with reference to FIGS. 7A and 7B. First, referring to FIG. 7A, the details shown in FIG. 7A are inserted in parentheses into the above-described outline in the following manner: A determination is made whether or not in a layer under the entity (Project Y) of a project link to be created (link to Project Y), there is any other link having the same grace period as the project (Project X) that is the destination of link creation. If the answer is YES, a determination is made whether or not the entity (Project X) of that link (link to Project X) exists between the ROOT project and the project (Project X) as the destination. If the answer is YES, an error indication is made.

As shown in FIG. 7A, allowing, after a link to “Project Y” has been created in a layer under “Project X,” a link to the “Project X” to be created in a layer under the “Project Y” would allow a circular reference, forming a contradictory structure in which a link to Project X is present in a layer under the Project X and a link to Project Y is present in a layer under the Project Y. As used herein, the “circular reference” refers to a phenomenon that an infinite loop such as “Project X”→“Link to Project Y”→“Project Y”→“Link to Project X”→“Project X” is formed when lower layer items are searched for from the ROOT project following a path. To resolve such a contradiction, if even a single link has already been formed in a layer under the entity of the link to be created before a link is created, monitoring is carried out to see if there is no entity of the link between the ROOT project and a project that is the destination of the link.

Actually, however, if a “Link to Project X” has been created in a layer under “Project Y,” the grace period of “Project X” must be equal to or shorter than that of “Project Y.” Conversely, to create a “Link to Project Y” in a layer under “Project X,” the grace period of “Project Y” must be equal to or shorter than that of “Project X.” Therefore, if the grace period of a project as the source (i.e., Project X) is different from that of the link to be created (i.e., a link to Project Y), the check may be omitted.

Likewise, in the case of FIG. 7B, such a contradictory circular reference also occurs. The details shown in FIG. 7B are inserted in parentheses into the above-described outline in the following manner: A determination is made whether or not in a layer under the entity (Project Y) of a project link to be created (link to Project Y), there is any other link having the same grace period as the project (Project X) that is the destination of the link. If the answer is YES, a determination is made whether or not the entity (Project X) of that link (link to Project X) exists between the ROOT project and the project (Project A1B2C1) as the destination. If the answer is YES, an error indication is made.

Now, referring back to FIG. 6, a detailed description of the processing steps S86-S92 will be resumed. In S86, a determination is made whether or not in a layer under the entity of a project link to be created, there is any other link having the same grace period as the project that is the destination of link creation. If there are no links at all, the control proceeds to S84. On the other hand, if there is at least one link there, the control proceeds to S87. In S87, the number of the existent link(s) is defined to be N. Next, in S88, I is set to be one. Then, in S89, a determination is made whether or not the entity of the I^{th} link exists between the ROOT project and the project as the destination. If the answer is YES, the control proceeds to S82, in which the display device 37 of the client terminal 2 makes an error indication. This error indication includes displaying an error message that says, for example, “A contradictory circular reference will occur.”

On the other hand, if the answer is NO in S89, the control proceeds to S90, in which I is incremented by one. Then, in S91, a determination is made whether or not “I=N+1” is satisfied. If I=N+1 is not satisfied yet, the control goes back to S89. This loop of processing steps S89→S90→S91→S89 is carried out repeatedly to make the determination of S89 for every link (i.e., each one of the N links). When the answer becomes NO for all of those links, the answer will finally become YES in S91. Then, the control proceeds to S92. In S92, I and N are reset to zero. After that, the control proceeds to S84, in which processing is performed such that a path following the immediately superordinate project is defined and the link is stored, along with the grace period, in the database 5. Note that if the entity of the link to be created is a task, a link to that task cannot be created in any layer under the link's entity. Thus, in that case, it is sufficient to see if the project that is the destination of the link has a grace period that is equal to or longer than that of the link.

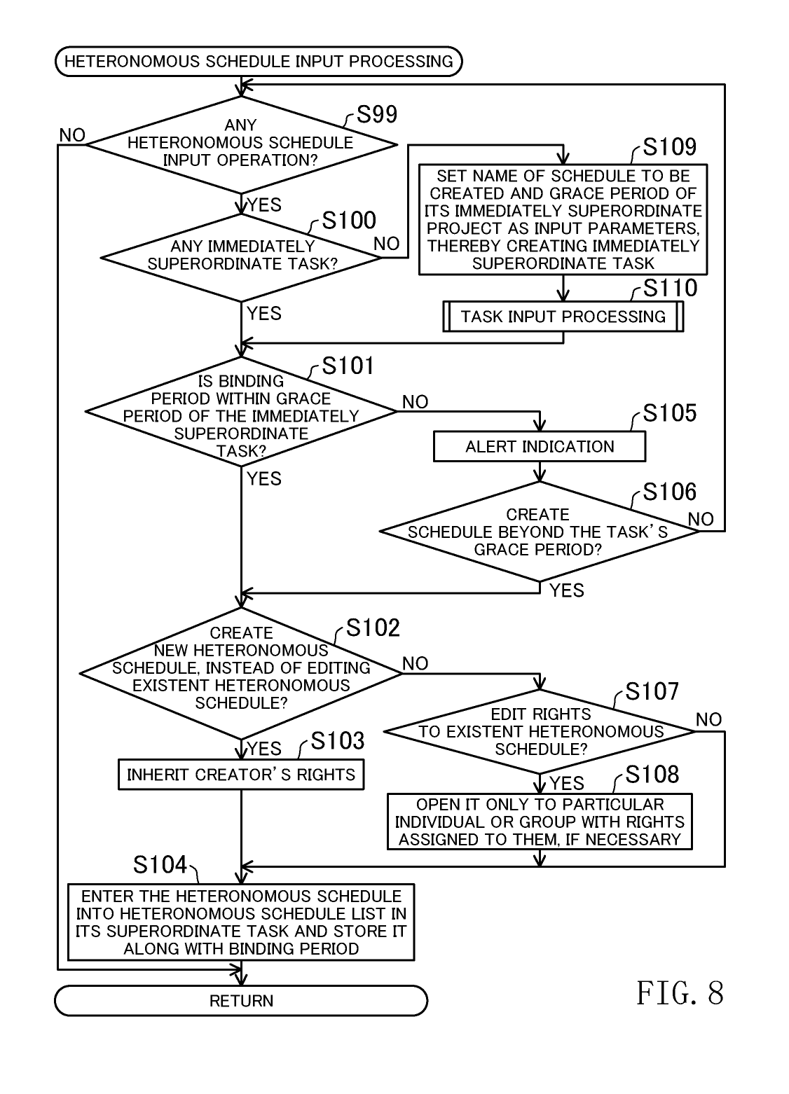

Next, the flow of a subroutine program for the heteronomous schedule input processing S11 will be described with reference to FIG. 8. This heteronomous schedule input processing is processing allowing the user to edit a heteronomous schedule by entering data into any of the editing screens shown in FIGS. 22B-23B (to be described later). First, in S99, a determination is made whether or not any heteronomous schedule input operation has been performed. If the answer is NO, this subroutine program returns. For example, if the user has picked up the new heteronomous schedule editing (with automatic task creation) option in the tree display shown in FIG. 16 or if he or she has picked up the new or existent heteronomous schedule editing option in the tree display via the existent task editing option, then the answer becomes YES in S99, and the control proceeds to S100.

In S100, a determination is made whether or not there is any immediately superordinate task. If any option other than the new heteronomous schedule editing (with automatic task creation) option has been picked up, then there should already be an immediately superordinate task, and therefore, the control proceeds to S101, in which a determination is made whether or not the binding period of the heteronomous schedule input falls within the range of the grace period of the immediately superordinate task. Since a heteronomous schedule is an event, the entity of its binding period is its active period. That is to say, there is no problem even if the binding period itself of a heteronomous schedule falls out of the grace period of the task immediately superordinate to the schedule due to various kinds of reference information such as a program or a time table.

Nevertheless, the heteronomous schedule will match its superordinate task better if the binding period of the heteronomous schedule falls within the grace period of the task. For this reason, if the binding period of the heteronomous schedule falls out of the grace period of its superordinate task, then the control proceeds to S105, in which the display device 37 of the client terminal 2 makes an alert indication to attract the user's attention. With this alert indicated, the user is prompted to decide whether or not he or she still wants to create a heteronomous schedule beyond the range of the grace period of the task. A control operation is performed such that if the user has input an instruction to create it, the answer becomes YES in S106, and the control proceeds to S102. The control operation is also performed such that if the user has instructed otherwise, the answer becomes NO in S106, and the control goes back to S99.

In S102, a determination is made whether or not the user wants to create a new heteronomous schedule, not editing any existent heteronomous schedule. If the new heteronomous schedule editing option is currently exercised and the new heteronomous schedule editing screen shown in FIG. 22B is displayed, then the user newly creates a heteronomous schedule by entering data into that editing screen, and as the answer becomes YES in S102, the control proceeds to S103. In S103, processing is performed such that the creator's rights (such as the access right) are inherited for the heteronomous schedule created. Next, the control proceeds to S104, in which processing is performed such that the heteronomous schedule is entered into the heteronomous schedule list of its superordinate task and then stored, along with its binding period, in the database 5. Every heteronomous schedule is supposed to be not open to anybody but its creator when created newly.

Meanwhile, if the existent heteronomous schedule editing option is currently exercised, then the answer becomes NO in S102, and the existent heteronomous schedule editing screen shown in FIG. 23B is displayed to allow the user to edit the title, outline, and other parameters of the existent heteronomous schedule that has been input by him or her as the object of editing. If the user is going to edit the rights (such as the access right) to the existent heteronomous schedule, then the answer becomes YES in S107, and the control proceeds to S108, in which processing is performed to edit the rights to the existent heteronomous schedule. If necessary, a control operation is performed to make the heteronomous schedule open by setting rights (such as access rights) for a particular individual or group. When the processing step S108 is done, the control proceeds to S104. If the user wants to participate in this opened heteronomous schedule, then he or she exercises the existent heteronomous schedule editing option to have the existent heteronomous schedule editing screen (see FIG. 20) displayed on the display device 37 of the client terminal 2, and clicks on the Participation Agreement button 58. As a result, the user can now participate in the heteronomous schedule through the above-described series of processing steps S47→S51→S52. When the processing step S108 is done, the control proceeds to S104. Likewise, even if the rights to the existent heteronomous schedule need not be edited, the control also proceeds to S104, in which the outline, grace period, and other parameters of the heteronomous schedule edited by the user are stored.

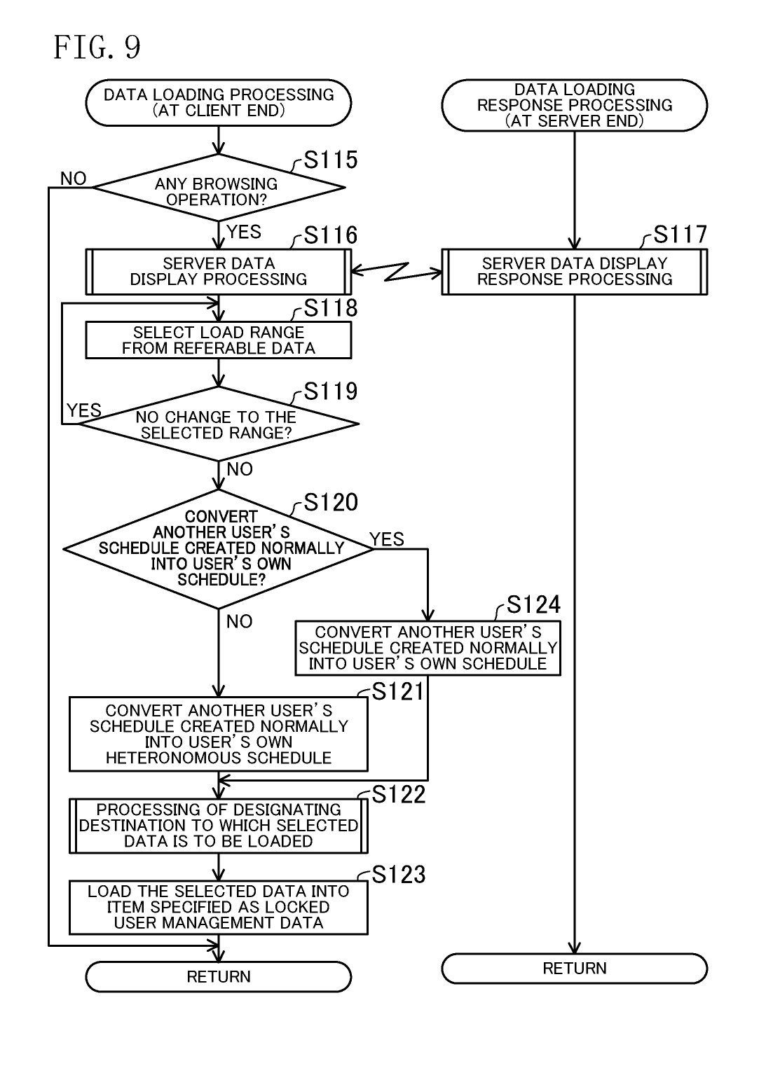

Next, the flow of a subroutine program for the data loading processing S12 mentioned above will be described with reference to FIG. 9. In this data loading processing, if the user wants to download “another user's schedule normally created regardless of the heteronomous schedule” from the management server 4, then he or she converts that another user's schedule into his or her own schedule or heteronomous schedule and then loads it. Embedding, in the heteronomous schedule, proprietor's information or any other piece of information, indicating whose schedule is to be loaded, during the conversion to indicate whose schedule the user is making reference to would enhance the user friendliness.

First, in S115, a determination is made whether or not any browsing operation to browse through another user's management data has been performed. If the answer is NO, then the control returns. If the employee performs an operation of transmitting a browsing request to the management server 4 by inputting his or her own ID, then the control proceeds to S116, in which server data display processing is performed. In response to this request, the management server 4 performs server data display response processing S117. This pair of processing is performed to allow only a part of public management data comprised of projects, tasks, and schedules and stored in the database 5 to be displayed on the client terminal 2 if a person who wants to browse through that part of the management data is granted a right to browse through the data, as will be described in detail later. The data itself extracted by the management server 4 in response to the browsing request is under the management of the server. However, at a point in time when the data is loaded into the client terminal 2 from the management server 4, the data becomes the client's own private management data under the management of the user him- or herself. The employee (user), having looked at another user's management data displayed in response to the browsing request in S116, operates the input operating device 38 of the client terminal 2 to select a load range from the data that can be made reference to (in S118).

Next, the control proceeds to S119, in which a determination is made whether no changes have been made to the selected range. If the answer is YES, the control goes back to S118 to make the user select a load range again. Alternatively, if no changes have been made to the selected range, then the control proceeds to S120, in which a determination is made whether or not the user wants to convert another user's schedule created normally into his or her own schedule. If the user wants to convert it into his or her own schedule (i.e., autonomous schedule), then the control proceeds to S124, in which the processing of converting another user's schedule created normally into his or her own schedule (autonomous schedule) is performed. After that, the control proceeds to S122. On the other hand, if the user wants to convert another user's schedule created normally into a heteronomous schedule, then the control proceeds to S121, in which another user's schedule created normally is converted into his or her own heteronomous schedule. After that, the control proceeds to S122. In S122, the processing of designating the destination to which the selected data is going to be loaded is performed. This processing is performed to specify high-order data immediately superordinate to the selected data, i.e., to specify where the data that should be immediately superordinate to the selected data to be loaded is located, as will be described in detail later.

Next, the control proceeds to S123, in which processing of loading the selected data into an item specified as locked (i.e., temporarily unalterable) user management data is performed. If another user's item is loaded into the user's own project in S124, the data is converted into his or her own data, when the data is loaded. As for the items loaded, basically every item (i.e., no matter whether it is an autonomous one or a heteronomous one) is supposed to be loaded with all parameters (including the grace period) locked (i.e., made temporarily unalterable) at the point in time of loading. That is to say, the heteronomous schedule is substantially the only item to be handled as a heteronomous item.

Furthermore, another user's schedule is supposed to be extracted as long as it has been created normally, no matter whether or not it is a heteronomous schedule. However, another user's schedule selected at the time of the data loading processing is usually a piece of reference information. That is why another user's schedule is supposed to be converted, by default, into a “heteronomous schedule” at the time of loading such that that another user's schedule may be converted into the “user's own schedule” when instructed by the loader him- or herself. This also allows the user to adjust his or her own schedule to that of another user who is acting in cooperation with him or her, as well as transferring the schedule.

In addition, while another user's item is being converted into his or her own data, that another user's schedule created from the attributor heteronomous schedule is removed, thus disabling the user to make reference to that another user's schedule associated with the participation list. Thus, to avoid such an inconvenience, the user is allowed to write the proprietor's information and other pieces of information onto the participation list as character information such as names and notes, not as a reference to its heteronomous schedule or a pointer. Such a control operation allows the user to confirm whose schedule he or she is making reference to. Furthermore, if a heteronomous schedule is not opened but used without being shared, then this system may be used such that only the names of major members, whom the user needs to keep in mind as actual participators, are written down as his or her notes.

As used herein, the act of “loading data” refers to loading data, opened to a particular person with browsing right outside of private management data, as the user's own management data on an item-by-item basis into the private management data. The private management data is mostly for personal use, and therefore, is usually managed and used on each individual's local system. Recently, however, a wider and wider variety of terminals have been put on the market and readily available. Under these circumstances, it is a general practice to establish a cloud synchronization system by saving private management data in the management server 4 and by synchronizing together the respective sets of private management data saved on respective local systems of a plurality of terminals while using, as a core, the data in the management server 4.

As used herein, to “synchronize” refers to synchronizing those sets of private management data together in order to maintain a predetermined degree of match between them. The “data loading processing” is employed when the user wants to load another user's open data item into his or her own private management data, and therefore, its target data is different from that of the synchronization processing. The extracted data itself is under the management of the server. However, at a point in time when the data is loaded into the client from the server, the extracted data becomes the client's own private management data under the management of the user him- or herself.

Another user's schedule arranged and created with respect to an opened heteronomous schedule (i.e., created from the attributor heteronomous schedule) is certainly an agreement to participate in that heteronomous schedule but is different from the heteronomous schedule itself. Also, as far as the type is concerned, that another user's schedule is of the same type as another user's schedule normally created regardless of the heteronomous schedule. “Another user's schedule normally created” is just related to its superordinate task. Meanwhile, “another user's schedule created from the attributor heteronomous schedule” is also related to the heteronomous schedule, not just its superordinate task.

Thus, according to this embodiment, “a schedule normally created from a task” and “a schedule created from an attributor heteronomous schedule” will be regarded as mutually different ones. Even if the user is allowed to browse through “another user's schedule created from an attributor heteronomous schedule,” “the user's own schedule created from an attributor heteronomous schedule,” and “his or her own schedule normally created from a task” at the same time, it would be just too confusion. That is why during the loading, “another user's schedule created from an attributor heteronomous schedule” is not converted into a heteronomous schedule, but a “participation list” comprised of IDs, binding periods, and other parameters is created in advance at the time of scheduling and provided for the heteronomous schedule. This allows the user to confirm the names of the members that will participate in the same event and their event participation schedule even without making reference to “another user's schedule created from an attributor heteronomous schedule” according to this configuration.

Also, according to this configuration, “another user's schedule created from an attributor heteronomous schedule” is deleted when selected data is extracted. To obtain the latest information about the opened heteronomous schedule, the user is required to log in the management server 4 not only when he or she expresses his or her agreement to participate in the heteronomous schedule (i.e., creates a schedule attributable to the heteronomous schedule and enrolls him- or herself in the participation list) but also when he or she just wants to make reference to the list. The “synchronization processing” is used when the same user wants to maintain a predetermined degree of match between the local data of a plurality of client terminals 2 by cloud synchronization. In this embodiment, a cloud server system is used to maintain a predetermined degree of data match between the respective users' client terminals 2 by using, as a core of synchronization, the private management data in the database 5, and is internally independent of a program in which public management data is activated.

Also, according to this embodiment, during the “data loading processing,” the system dealing with the public management data is supposed to load part of the opened data. The same is also true of a peer-to-peer system in that the opened data is loaded either entirely or only selectively. The public management data itself in the sharing server may sometimes be directly rewritten only when granted during the log-in session, but is never rewritten through the synchronization processing or any other type of processing, except for a few cases such as a backup operation.

Note that another user's schedule created from an attributor heteronomous schedule (i.e., another user's autonomous schedule converted from the heteronomous schedule if the answer is YES in S51) need not be displayed. Even if there arises any such need, it will be just complicated and meaningless that such a schedule is displayed to be compared with a normal schedule. In addition, it is expected that in most cases, a plurality of schedules attributable to the same heteronomous schedule should be compared with each other. That is why it is sufficient to display only the “participation list” of those heteronomous schedules by itself. Also, in the case of a task to be shared in common within a group by only limited members belonging to that group, each of those members belonging to that group can create a schedule about that task to be shared in common. In that case, all schedules but the ones created by the members themselves are loaded as heteronomous schedules. Optionally, each member may also create his or her own schedule attributable to the heteronomous schedule (i.e., participate in that heteronomous schedule) (see S52).

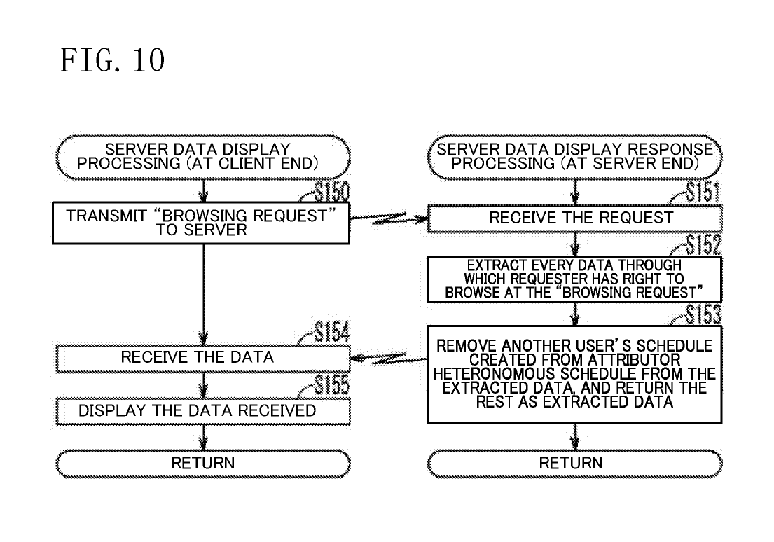

Next, the flow of a subroutine program for the server data display processing S116 and the server data display response processing S117 will be described with reference to FIG. 10. In this processing, after having logged in the management server 4, each of clients is actually entitled to receive the services provided by the management server 4 as far as they are authorized. Each employee, operating his or her own client terminal 2, selects a display range of a referable part (e.g., public management data) of the management data stored in the database 5. If he or she has performed a browsing operation, his or her browsing request (including his or her own ID) is transmitted to the management server 4 (in S150). The management server 4 receives that request (in S151).

In the database 5, an access right has been stored in advance in association with an authorized user ID. Thus, the management server 4 uses the received ID to search the database 5 for his or her access right, thereby determining whether or not the employee who has submitted the browsing request has the browsing right. If the employee has no access right, an error indication, for example, may be made to prohibit him or her from browsing through the schedule. Also, in a situation where the user is going to access a project or task to be shared in common within a group by only limited members belonging to the same group, the management server 4 performs an access right control operation to prohibit anyone but the members of that group from accessing the project or task.

Next, the management server 4 performs the processing of extracting every data, which the employee has a right to browse through, at his or her “browsing request” (in S152). Subsequently, in S153, another user's schedule created from an attributor heteronomous schedule is removed from the extracted data, and the rest is returned as extracted data to the client terminal 2. The client terminal 2 receives the extracted data (in S154) and has the data displayed on the display device 37 in S155.

If the task extracted in S152 includes a heteronomous schedule, then it is displayed as it is as the heteronomous schedule. However, as described above, another user's schedule created from the attributor heteronomous schedule (i.e., another user's autonomous schedule converted from the heteronomous schedule if the answer is YES in S51) is not displayed. The persons who have expressed their agreement to participate in the heteronomous schedule can be confirmed with the “participation list” retained with the heteronomous schedule. Thus, normally, there is no need to browse through another user's schedule created from the attributor heteronomous schedule. Thus, another user's schedule created from an attributor heteronomous schedule is removed from the extracted data, and the rest is returned as extracted data to the client terminal 2 (in S153). Furthermore, another user's schedule is supposed to be extracted as long as it has been created normally, no matter whether or not it is a heteronomous schedule. However, another user's schedule selected at the time of the data loading processing is usually a piece of reference information. That is why another user's schedule is supposed to be converted, by default, into a “heteronomous schedule” at the time of loading such that that another user's schedule may be converted into the “user's own schedule” when instructed by the loader him- or herself. This also allows the user to adjust his or her own schedule to that of another user who is acting in cooperation with him or her, by transferring the schedule.

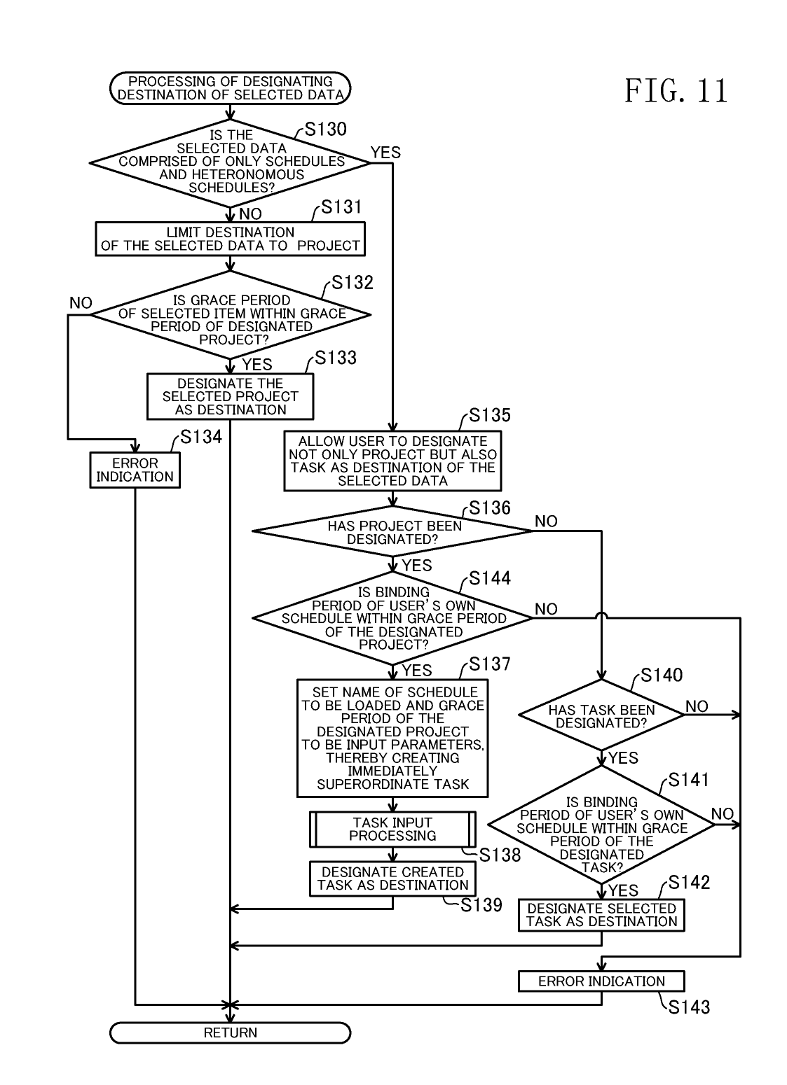

Next, the flow of a subroutine program for the processing S122 of designating a destination to which selected data is going to be loaded will be described with reference to FIG. 11. Three types of data, namely, data comprised of only a schedule and a heteronomous schedule, data comprised of a schedule, a heteronomous schedule, and a task, and data comprised of a schedule, a heteronomous schedule, a task, and a project, may have been selected in accordance with the flow shown in FIG. 9 as data to be loaded. If the selected data is either a set of a schedule, a heteronomous schedule, and a task or a set of a schedule, a heteronomous schedule, a task, and a project, then the answer becomes NO in S130, and the control proceeds to S131, in which the destination to which the selected data is going to be loaded is limited to a project.

If the user designates, in such a state, the project at the destination to which the selected data is going to be loaded, a determination is made (in S132) whether or not the grace period of the selected item falls within the grace period of the designated project. If the answer is YES in S132, then the processing of designating the selected project as the destination is performed in S133. On the other hand, if the answer is NO in S132, the control proceeds to S134, in which the display device 37 of the client terminal 2 makes an error indication. This error indication includes displaying an error message that says, for example, “Please input a grace period again, because the grace period of the selected item you have input falls out of the range of the grace period of the designated project.”

Alternatively, if the selected data is comprised of only a schedule and a heteronomous schedule, then the answer becomes YES in S130 and the control proceeds to S135, in which the user is allowed to designate not only a project but also a task as the destination of the selected data. If the user designates, in such a state, a project as the destination of the selected data, then the answer becomes YES in S136 and then the control proceeds to S144. In S144, a determination is made whether or not the binding period of the user's own schedule falls within the grace period of the designated project. If the answer is YES, then the control proceeds to S137. On the other hand, if the answer is NO in S144, the control proceeds to S143, in which the display device 37 of the client terminal 2 makes an error indication. This error indication includes displaying an error message that says, for example, “Please input a binding period again, because the binding period of the selected schedule you have input falls out of the range of the grace period of the designated project.”

If a “project” is designated as the item at the destination even though the selected data is a “schedule,” then there will be no “task” data as the immediately superordinate item of the “schedule and heteronomous schedule.” Thus, the processing of creating a “task” is performed in S137 and S138. First, in S137, the processing of creating an immediately superordinate task is performed with the name of the schedule to be loaded and the grace period of the designated project set to be input parameters. Next, in S138, task input processing is performed. The details of this task input processing are shown in FIG. 4B. The grace period of the designated project is copied as the grace period of the task to be created. Then, in S139, the task created is designated as the destination.

If the user designates a task as the destination, then the answer becomes YES in S140 and then the control proceeds to S141, in which a determination is made whether or not the binding period of the user's own schedule falls within the grace period of the designated task. If the answer is YES, then the processing of designating the selected task as the destination is performed in S142. On the other hand, if the answer is NO in S141, the control proceeds to S143, in which the display device 37 of the client terminal 2 makes an error indication. This error indication includes displaying an error message that says, for example, “Please input a binding period again, because the binding period of the selected schedule you have input falls out of the range of the grace period of the designated task.”

Note that if there are multiple names of selected schedules, then it is recommended to prompt the user to decide whether he or she wants to create all of those schedules as high-order tasks or to pick the name of the first selected schedule as a candidate for the time being and then use or edit it. If a “schedule” is designated in a situation where the selected data is comprised of only schedules, then the answer becomes NO in S140 and error processing is performed in S143. This error indication is made because an operation of creating a subordinate “schedule” in a layer under another “schedule” has been performed.

Next, the flow of a subroutine program for the data display processing S1 mentioned above will be described with reference to FIG. 12A. In this data display processing, the display screen actually serves as a user interface allowing the user to perform an editing operation. In this data editing processing, four program modules S160-S163 are selected and executed in parallel with each other. In this case, these four modules may be sequentially selected and executed on a one-by-one basis such that those modules are executed in the order of S160→S161→S162→S163→S160, for example.

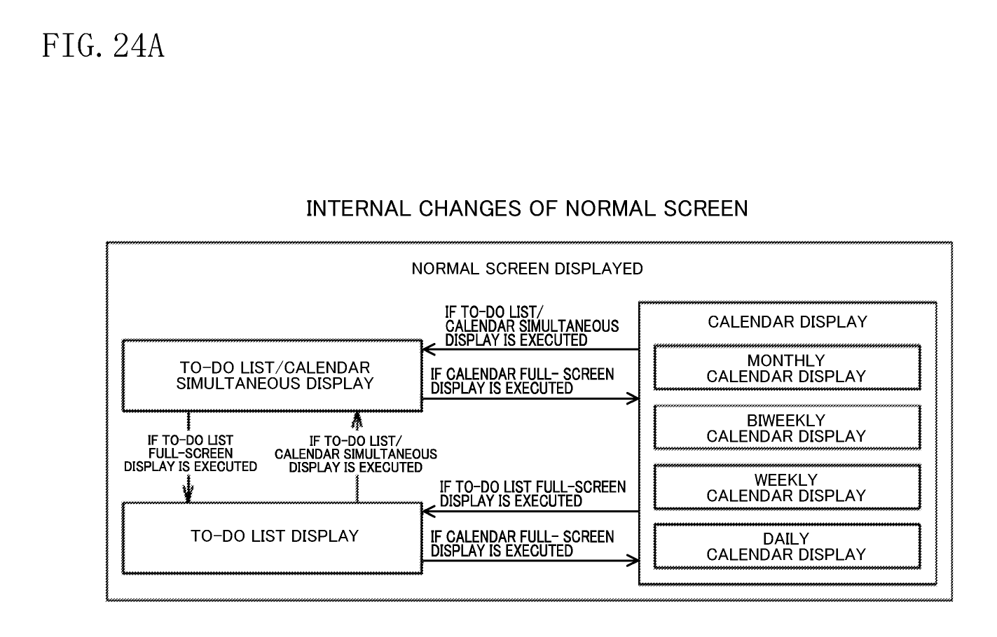

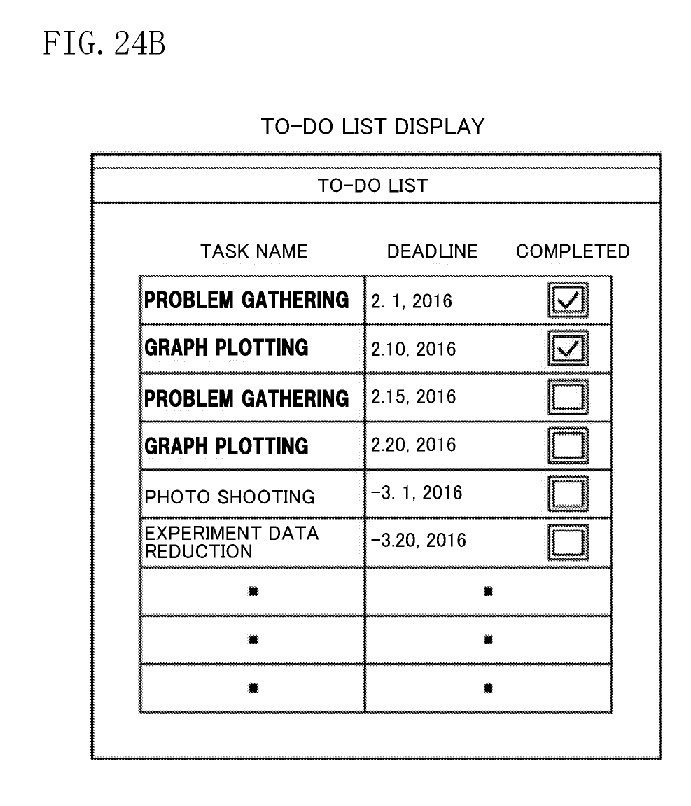

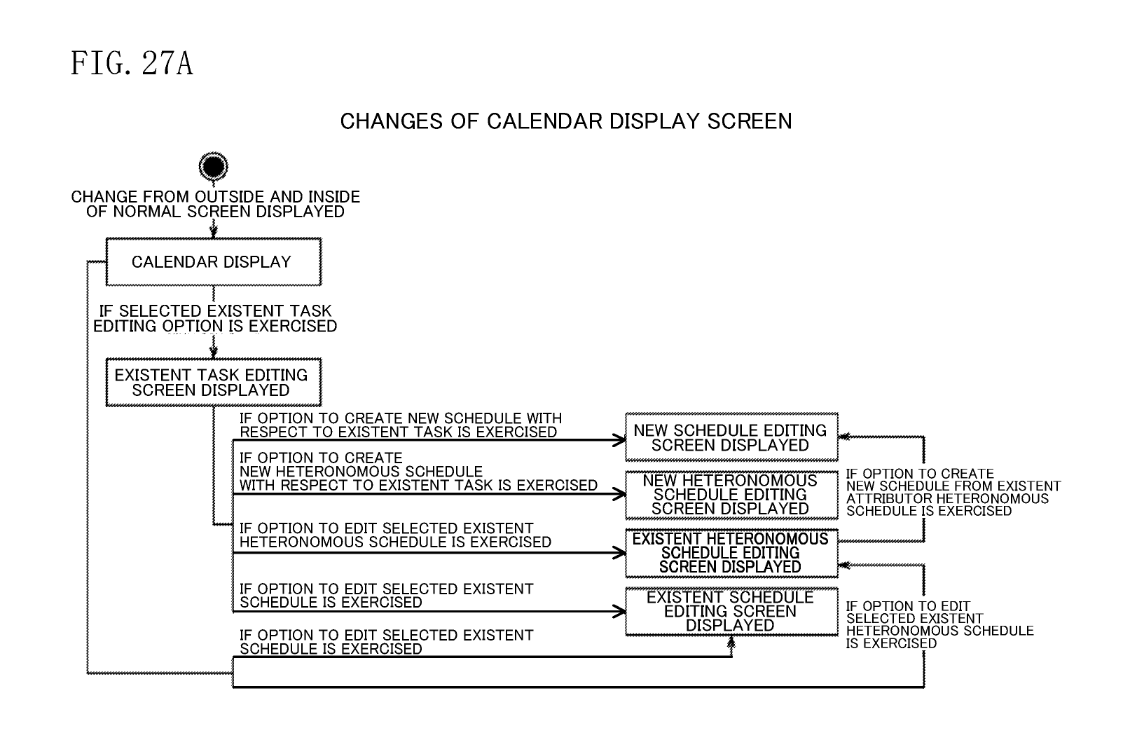

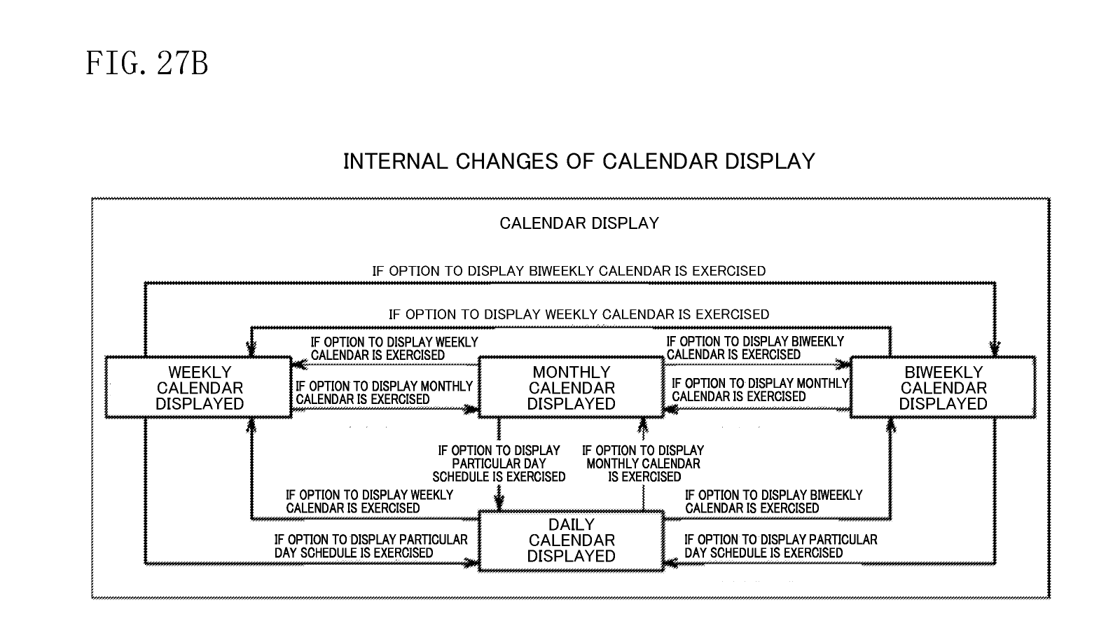

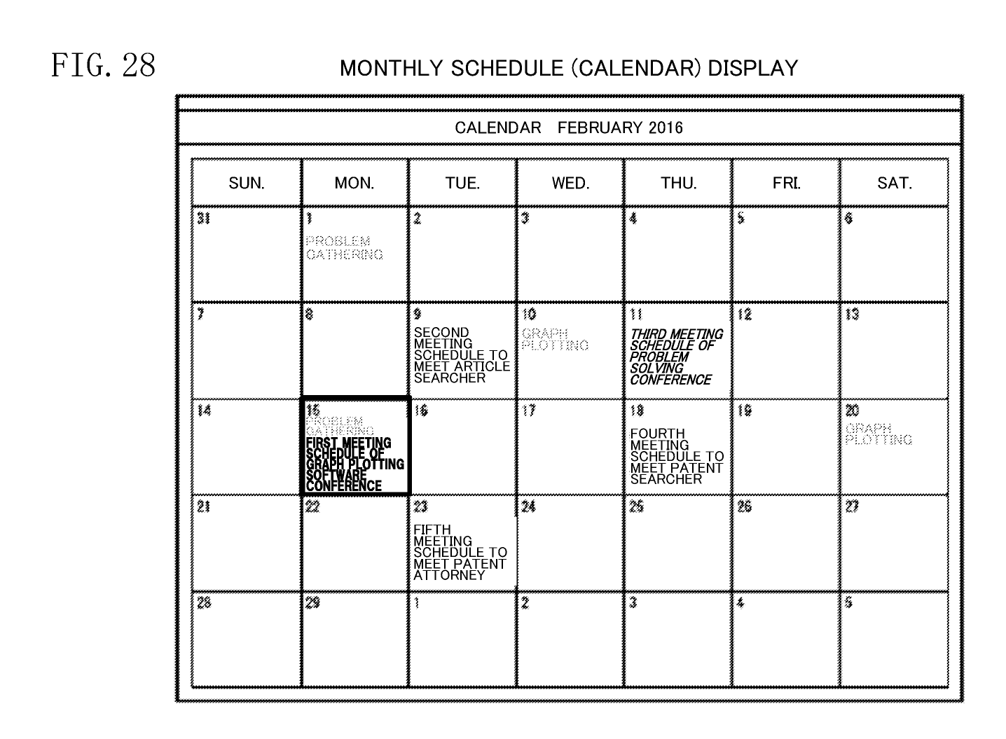

The task display processing (task list) to be executed in S160 allows the employee (user) to have his or her own tasks displayed on the display device 37 (see, for example, FIG. 24B). The schedule display processing (of changing the calendar display modes to select a yearly, monthly, or daily display mode) to be executed in S161 allows the user to select one of multiple calendar ranges respectively showing a monthly schedule, a biweekly schedule, a weekly schedule, and a daily schedule, and display tasks belonging to the selected calendar range (see, in particular, FIGS. 27 and 28). The task/schedule simultaneous display processing (of displaying a calendar and a range of a task list interlinking with its display range) to be executed in S162 allows both a to-do list and a scheduler calendar to be displayed simultaneously (see FIG. 26). The overview display processing to be executed in S163 allows the tree management data shown in FIG. 1 to be displayed as it is as a tree.

Next, the flow of a subroutine program for the task display processing (task list) S160 will be described with reference to FIG. 12B. In S167, a determination is made whether or not any task display operation has been performed. If the answer is NO, then the control returns. If the user selects a normal screen (see FIG. 24A) to be displayed by pressing a button on either a horizontal menu bar displayed at the top of the normal screen on the display device 37 of the client terminal 2 or a pop-up menu and clicks on a “To-Do List” button, then the answer becomes YES in S167 and the control proceeds to S168. In S168, a determination is made whether or not there are any task and its superordinate project that have been selected exclusively.

If the user has selected any task and project to be displayed exclusively, then the processing of narrowing the target range of tasks to be extracted to that exclusively selected one is performed in S169 and then the control proceeds to S170. On the other hand, if the user has not selected any task or project exclusively, then the processing of expanding the target range of tasks to be extracted to all tasks is performed in S176 and then the control proceeds to S170. In S170, a determination is made whether or not there is any grace period that has been selected exclusively. If the user has limited any grace period as an exclusive input period, then the control proceeds to S171, in which the processing of extracting tasks falling within the limited grace period from the target narrowed in S169 or S176 is performed. This is processing of extracting tasks that start and end within the limited grace period.

On the other hand, if the user has specified a reference date, then the control proceeds to S178, in which the processing of extracting all tasks, of which the reference date is the specified date, from the target is performed. Specifically, all tasks, including the reference date specified by the user within the grace period, are extracted. As used herein, the “reference date” refers to a date specified on a scheduler as a starting point for extracting a range to be displayed. A scheduler is normally used to determine or confirm the day's action schedule. Thus, “the day” means, by default, “today,” or “a date including the current time.” In addition, having the user specify the “reference date” allows him or her to confirm his or her tasks or schedule with the “reference date set” regarded as “virtual today.”

Meanwhile, if neither any grace period nor any reference date has been specified, then the control proceeds to S179, in which the processing of extracting all tasks, of which the reference date is set to be the current date, from the target is performed. After the processing step S171, S178, or S179 has been performed, the control proceeds to S172, in which a determination is made whether or not a request to display an all-day schedule has been submitted. As used herein, the “all-day schedule” refers to a schedule set for an entire day, and means a schedule, of which the grace period (scheduled implementation date) is defined to be the selected date (24 hours) and for which no binding period has been set yet.

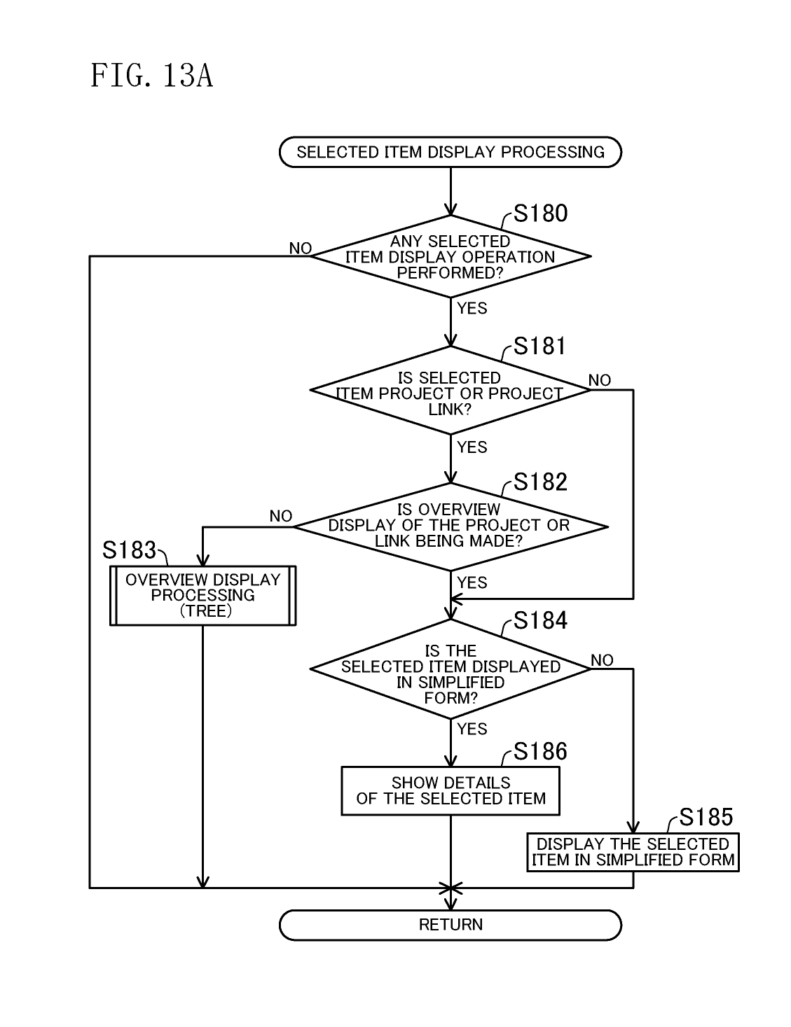

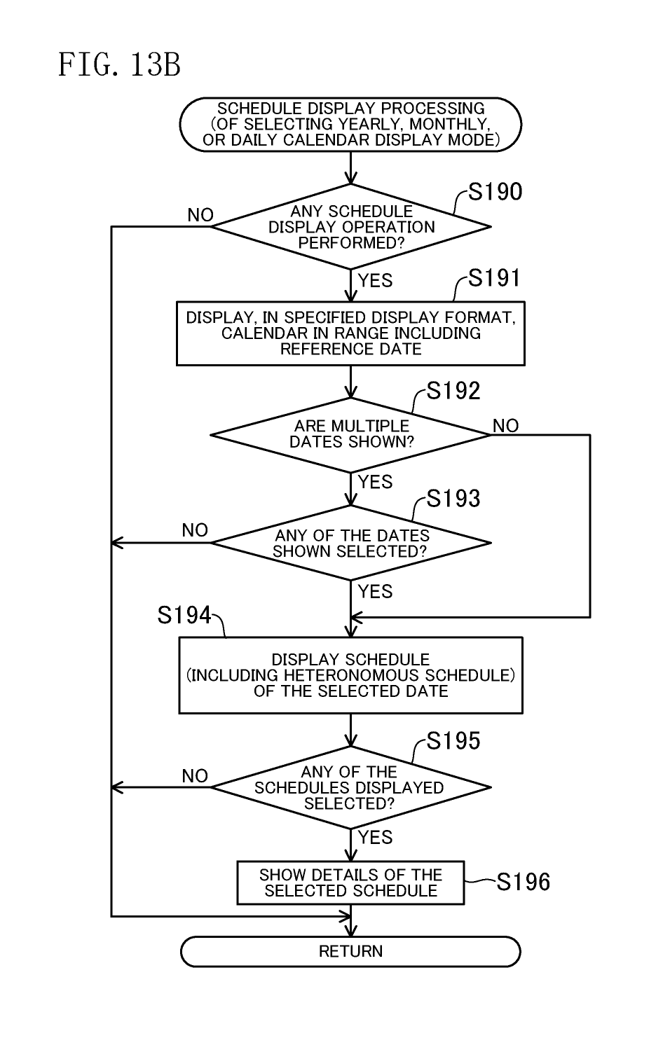

If the user has submitted no request to display an all-day schedule, then a control operation of displaying the extracted tasks, along with checkboxes allowing him or her to confirm that he or she has done the tasks by checking off the boxes, as a list on the display device 37 is performed in S174. On the other hand, if the user has submitted any request to display an all-day schedule, then a control operation of extracting tasks including the all-day schedule, displaying the tasks, along with the checkboxes allowing him or her to confirm the completion by checking off the boxes, as a list on the display device 37 in the order of scheduled implementation dates, and displaying the other tasks, along with the checkboxes allowing him or her to confirm the completion, following those tasks and checkboxes as a list is performed in S173. After the control operation S173 or S174 has been performed, the processing of displaying the selected items is performed in S175. This selected item display processing will be described in detail with reference to FIG. 13A.

In S180, a determination is made whether or not any selected item display operation has been performed. If the answer is NO, the control returns. If the user makes a single click (one click) on the item he or she wants to be displayed, the answer becomes YES in S180, and the control proceeds to S181, in which a determination is made whether or not the item selected by his or her operation such as the single click is a project or a link to a project. If the selected item is neither a project nor a link to a project, the control proceeds to S184. Alternatively, if the selected item is either a project or a link to a project, then the control proceeds to S182, in which a determination is made whether or not an overview display of the selected item, namely, a project or a link, is now being made. If the answer is NO, the control proceeds to S183, in which overview display processing (tree) is performed.

Next, the control proceeds to S184, in which a determination is made whether or not the selected item is being displayed in a simplified form. If the item selected by the user turns out to be displayed in a simplified form, then a control operation to show the details of the selected item is performed in S186. On the other hand, if the item selected by the user turns out to be displayed in a detailed form, then a control operation to display the selected item in a simplified form is performed in S185.

In this selected item display processing, the user's single clicking on an item or any other object on the screen allows it to be selected, and his or her double clicking on the item or any other object allows it to be entered (displayed). Also, an actual display format such as the “simplified display” and “detailed display” described above varies according to the actual display format of the display screen such as a list or a calendar. In particular, a calendar display or a display format like that also varies depending on the number of days to be displayed at a time.

Next, the flow of a subroutine program for the schedule display processing S161 will be described with reference to FIG. 13B. In S190, a determination is made whether or not any schedule display operation has been performed. If the user selects and specifies (e.g., by a single click) any of a monthly calendar, a biweekly calendar, a weekly calendar, or a daily calendar on the normal screen (see FIG. 24A) displayed on the display device 37, then the answer becomes YES in S190, and the control proceeds to S191, in which a calendar in a range including the reference date is displayed in the specified display format (i.e., as a monthly calendar, a biweekly calendar, a weekly calendar, or a daily calendar) (see FIGS. 27 and 28).

The display format and reference date specified by the user are usually input within an event loop with a mouse or any other input device. In this example, for the sake of convenience, the display format and reference date are supposed to have been specified before each type of display processing is called. That is why the reference date is supposed to have already been specified and the display format of a scheduler calendar display screen, which would normally be selectable from among the options of one-month (five weeks), two weeks, one week, two days, and one day, is also supposed to have already been specified before calling. As used herein, the “reference date” refers to a date that is always included within the period in the selected display format (namely, one-month (five weeks), two weeks, one week, two days, or one day).

Next, in S192, a determination is made whether or not a plurality of dates are shown on the calendar. If a plurality of dates are not shown on the calendar displayed in S191, the control proceeds to S194. Alternatively, if a plurality of dates are shown there, then a determination is made in S193 whether or not any one of the dates shown has been selected. If the answer is NO, the control returns. On the other hand, if the answer is YES, the control proceeds to S194, in which a control operation of displaying the schedule and heteronomous schedule of the selected date on the display device 37 is performed. Note that in an actual operation, any item on the screen is selected by a single click and entered (displayed) by a double click.

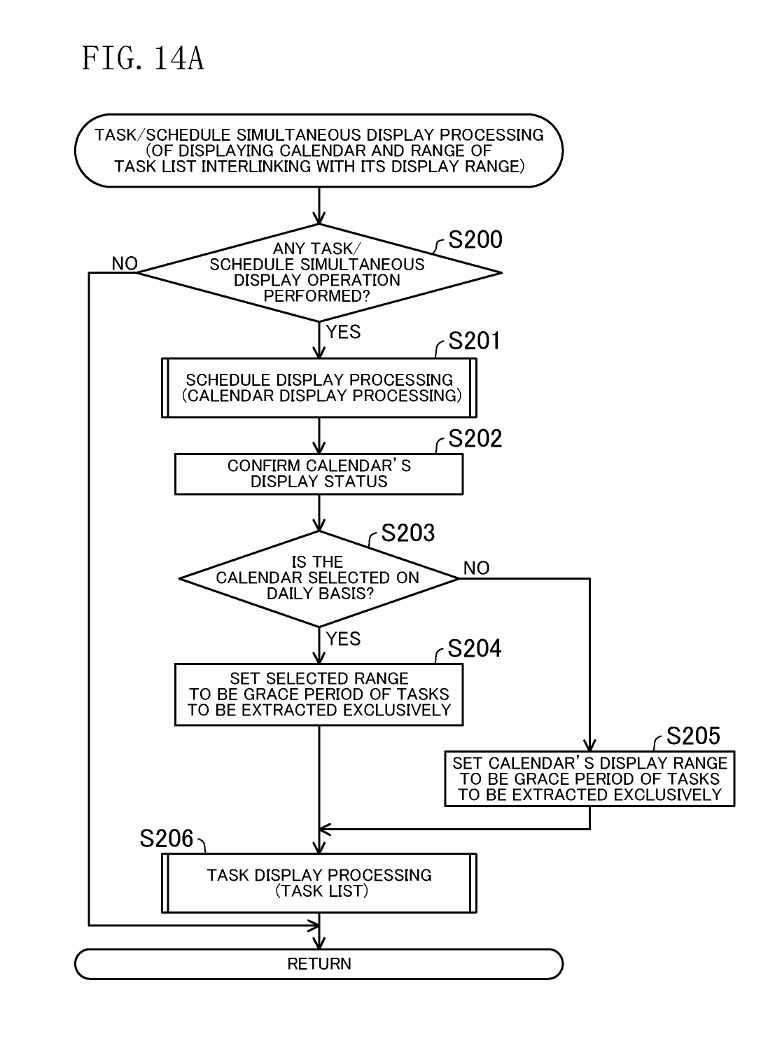

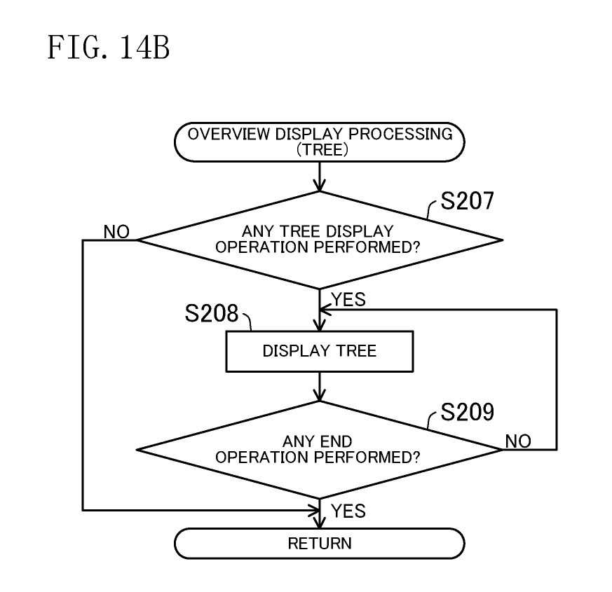

Next, the flow of a subroutine program for task/schedule simultaneous display processing S162 (display of a calendar and a task list in a range interlinking with its display range) will be described with reference to FIG. 14A. In S200, a determination is made whether or not any task/schedule simultaneous display operation has been performed. If the answer is NO, then the control returns. If the user has clicked on the “To-Do List/Calendar Simultaneous Display” button in the normal screen (see FIG. 24A) displayed on the display device 37, then the answer becomes YES in S200, and the control proceeds to S201, in which schedule display processing (calendar display processing) is performed. Through this processing, a control operation is performed to show one of the schedule (calendar) display screens shown in FIGS. 28-30B that has been selected by the user.

Next, the calendar's display status is confirmed (in S202) and a determination is made (in S203) whether or not the calendar is selected on a daily basis. The scheduler calendar display screen shows a schedule over any of one-month (five-week), two-week, one-week, two-day, or one-day period of time, and is any one of the three types of a monthly calendar, a weekly calendar, or a daily calendar. If the calendar is selected on a monthly or weekly basis, the control proceeds to S205, in which the processing of setting the calendar's display range to be the grace period of tasks to be extracted exclusively is performed. Alternatively, if the calendar is selected on a daily basis, the control proceeds to S204, in which the processing of setting the user's selected range to be the grace period of tasks to be extracted exclusively is performed.

As used herein, the “selected range” refers to a range selected by the user on the screen displayed at a point in time when a subroutine program for this task/schedule simultaneous display processing (display of a calendar and a task list in a range interlinking with its display range) is called. Next, in S206, the task display processing (task list) is performed. The details of this processing are shown in FIG.12B. In this task display processing (task list), the grace period set in S204 or S205 described above is regarded as the “specified grace period” in S171, tasks falling within the grace period are extracted, and a list of those extracted tasks (task list) is simultaneously displayed on the left hand side of the calendar displayed in S201 (see FIG. 26).

In the calendar display area on the right hand side of FIG. 26, the name of a heteronomous schedule “Graph Plotting” is followed by the title of the heteronomous schedule “First Meeting Schedule of Graph Plotting Software Conference.” This shows a result of a search for the task “Graph Plotting” and the schedule “First Meeting Schedule of Graph Plotting Software Conference” that are stored and interlinked with each other through a path. For example, in the one-week display of a schedule (calendar) to be described later (see FIG. 30A), the all-day schedule of “Graph Plotting” is displayed. This should be displayed as a to-do list (task list). In FIG. 30A, however, only the calendar is displayed, and therefore, “Graph Plotting” is displayed as the all-day schedule on the calendar. On the other hand, if a task list and a calendar are displayed simultaneously as shown in FIG. 26, a control operation is performed such that “Graph Plotting” is not displayed as a part of the calendar but as an item of the task list. This type of control is realized by the interlinked storage and uniform management of schedules, heteronomous schedules, and tasks, which is one of the advantages of the uniform management.

Meanwhile, the control operation is also performed such that although some tasks, to which no schedules have been entered yet (such as “Photo Shooting” and “Experiment Data Reduction”), are displayed on the task list, any of the tasks will be removed from the task list and displayed on the calendar as soon as even a single schedule is entered into the task. This type of control is realized by the interlinked storage and uniform management of schedules, heteronomous schedules, and tasks, which is one of the advantages of the uniform management.

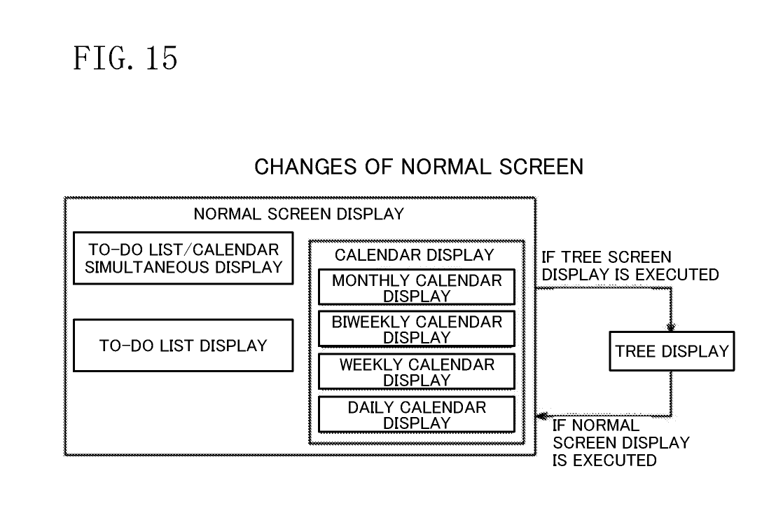

Next, the flow of a subroutine program for the overview display processing (tree) S163 will be described with reference to FIG. 14B. In S207, a determination is made whether or not any tree display operation has been performed. If the answer is NO, then the control returns. If a tree display option is picked up on the “Normal Screen” shown in FIG. 15, for example, then the answer becomes YES in S207, and the control proceeds to S208, in which the tree is displayed by the display device 37 (see FIG. 17A). This tree display processing is performed by searching for and displaying projects, tasks, and schedules that are stored and interlinked with each other through a path, and is a display mode realized by the interlinked storage and uniform management of those projects, tasks and schedules through the path. For example, a path for the task “Specification Drafting” is “ROOT/Applied Research Project/Patent Obtaining Project/Specification Drafting,” which forms a single tree display object in which ROOT, applied research project, patent obtaining project, and specification drafting are linked together in this order. Next, a determination is made (in S209) whether or not any operation of ending the overview display has been performed. If the answer is NO, the control operation of S208 is continued. Alternatively, if the answer is YES, the control returns.

Next, various types of screens displayed on the display device 37 of the client terminal 2 and changes between those screens displayed will be described with reference to FIGS. 15-27. First of all, a normal screen and a change from the normal screen to another screen will be described with reference to FIG. 15. From the horizontal menu bar displayed on the display device 37 or from a pop up menu, the normal screen may be selected and displayed. On this normal screen, displayed are a “To-Do List/Calendar Simultaneous Display” button, a “To-Do List Display” button, a “Monthly Calendar Display” button, a “Biweekly Calendar Display” button, a “Weekly Calendar Display” button, and a “Daily Calendar Display” button. The user's selecting and clicking on any of these various types of display buttons allows a type of display control corresponding to the button on which he or she has clicked to be performed.

Next, as shown in FIG. 15, if the user has picked up the tree display option on the normal screen, then the screen changes into a tree display screen, i.e., an overview display screen. This overview display (tree) screen is shown in FIG. 17A. On the other hand, if the user has picked up the normal screen display option on the overview display screen, then the screen changes into the normal screen.

Next, a change from the overview display (tree) screen to another screen will be described with reference to FIG. 16. On the overview display (tree) screen, various types of project items and task items branching from the ROOT project are displayed as shown in FIG. 17A, for example. To change the screens from the overview display (tree) screen to another screen, first, the user selects and specifies one of those displayed items.

Specifically, if the user has selected an existent project (such as the applied research project) and has clicked on, and entered, the editing option on the pop-up menu on the display screen, then the screen changes into an existent project editing screen (see FIG. 19B). If the user has selected an existent project (such as the ROOT project) and has exercised an option to create a new project immediately subordinate to that existent project, then the screen changes into a new project editing screen (see FIG. 19A).

If the user has selected an existent project (such as the ROOT project) and has exercised an option to create a new task immediately subordinate to that existent project, then the screen changes into a new task editing screen (see FIG. 20A). If the user has selected an existent project (such as the applied research project) and has exercised an option to create a new schedule immediately subordinate to that existent project, then the screen changes into a new schedule editing screen (with automatic task creation). This is a screen for automatically creating immediately superordinate tasks, because there are no tasks immediately superordinate to the schedule to be newly created (see S41-S45). If the user has selected an existent project (such as the applied research project) and has exercised an option to create a new heteronomous schedule immediately subordinate to that existent project, then the screen changes into a new heteronomous schedule editing screen (with automatic task creation). This is a screen for automatically creating immediately superordinate tasks, because there are no tasks immediately superordinate to the heteronomous schedule to be newly created (see S100-S109).

If the user has selected an existent task (for the patent obtaining project, for example) and has exercised an editing option, then the screen changes into an existent task editing screen (see FIG. 20B). Via this existent task editing screen (see FIG. 20B), the screen may change into the existent schedule editing screen, the existent heteronomous schedule editing screen, the new heteronomous schedule editing screen, or the new schedule editing screen.

Specifically, if the user has exercised a new schedule creating option with respect to an existent task, then the screen changes into the new schedule editing screen (see FIG. 21A). If the user has exercised a new heteronomous schedule creating option with respect to an existent task, then the new heteronomous schedule editing screen (see FIG. 22B) is entered. If the user has exercised a selected existent heteronomous schedule editing option, then the screen changes into the existent heteronomous schedule editing screen (see FIG. 23B). If the user has exercised a selected existent schedule editing option, then the screen changes into the existent schedule editing screen (see FIG. 22A).

In FIG. 16, in each option with “automatic task creation,” superordinate tasks are created automatically in accordance with information about schedules or heteronomous schedules created. Thus, this refers to a screen in which information about tasks created is also displayed according to the new normal or heteronomous schedule creating screen. Also, although the screen actually turns back into the screen before the change (i.e., a tree display) after the items have been modified or created, arrows indicating such changes are omitted herein to avoid making the drawings excessively complicated.

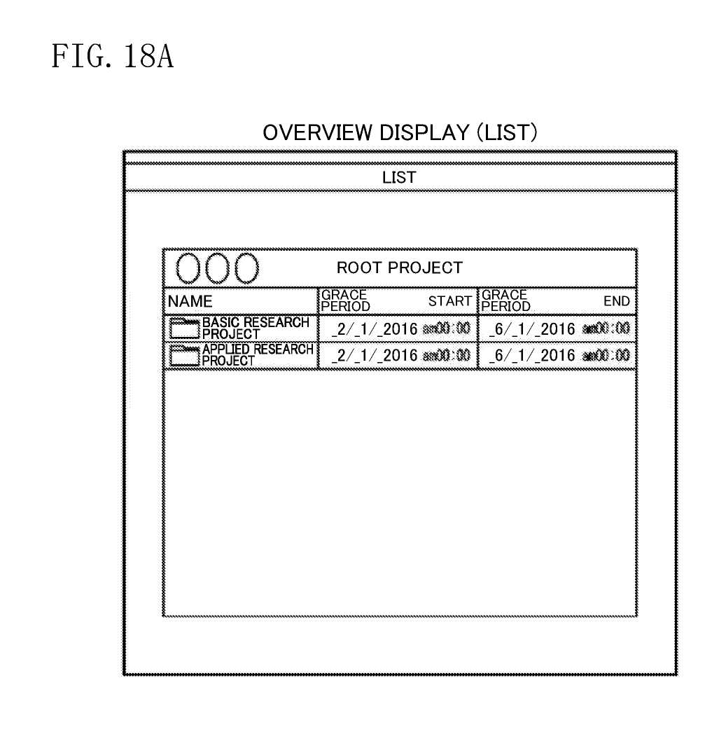

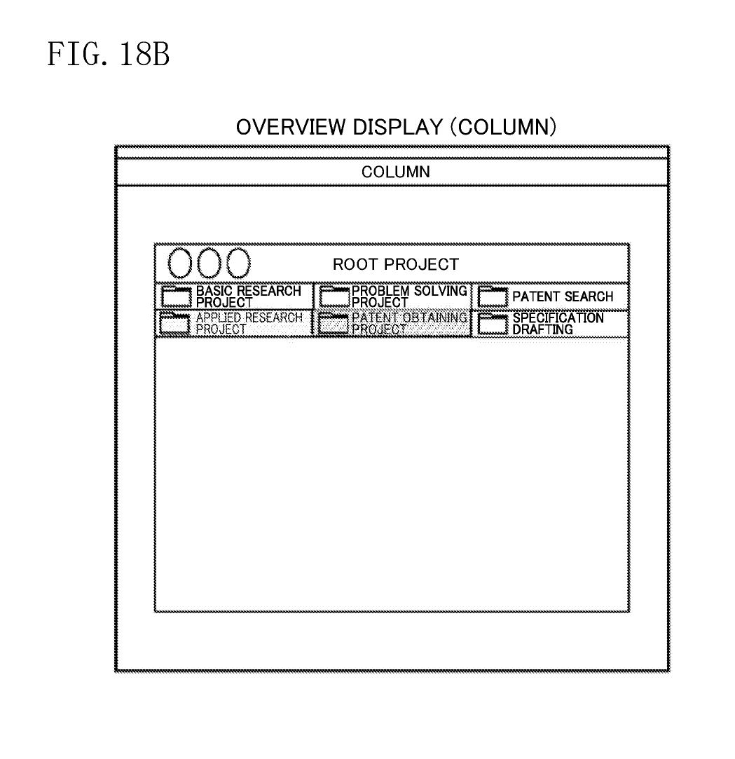

Next, the “Overview Display Screen” will be described with reference to FIGS. 17A-18B. As the “Overview Display Screen,” four types of screens, namely, a tree display (see FIG. 17A), an icon display (see FIG. 17B), a list display (see FIG. 18A), and a column display (see FIG. 18B), are provided. Any one of these four types of overview display screens may be selectively displayed in accordance with the user's operation.

The “Overview Display (Tree) Screen” will be described with reference to FIG. 17A. As described above, items of multiple different orders ranging from the highest-order item down to the lowest-order items, namely, the “ROOT project,” high-order projects subordinate to the ROOT project, low-order projects subordinate to the high-order projects, and tasks subordinate to the low-order projects, are associated with each other through a path in the form of a tree and stored in the database 5. The respective items of the tree are displayed on the overview display (tree) screen.

Every item can be uniquely searched for by a path with a hierarchical structure starting from the “ROOT project,” which is a project with an infinite grace period. In other words, this also means that every item is included in the “ROOT project.” In FIG. 17A, all projects and tasks are displayed in an extended form on the tree. However, since a project may be regarded as a sort of folder storing items of lower orders, those lower-order items starting from each project may all be hidden. For example, selecting any project and then picking up an option of hiding those lower-order items on a pop-up menu, for example, allows all of those items, lower in order than the selected project, to be hidden.

In this system, schedules and heteronomous schedules are regarded as divided items of tasks. Thus, normally, opening a task without showing the detailed display items of the tree display shown in FIG. 17A allows the user to confirm and edit the schedules on a detailed display screen. For example, clicking on and opening the task “Specification Drafting” will make a “Schedule to Meet Patent Attorney” subordinate to the task “Specification Drafting” shown, allowing the user to confirm and edit the schedule.

In the example shown in FIG. 17A, there is no mixture of projects and tasks. If necessary, multiple projects and multiple tasks may be included in mixture in a single project. Furthermore, selecting any project and then displaying a new item creating screen also allows the user to create child projects and child tasks immediately subordinate to the selected parent project and confirm and edit those projects and tasks on a detailed display screen.

The “Overview Display (Icon) Screen” will be described with reference to FIG. 17B. FIG. 17B illustrates how the “ROOT project” has been opened to display icons, which is the same as a file operation screen of a graphical user interface (GUI). Opening the “Basic Research Project” will change the character string “ROOT project” on the horizontal bar into “Basic Research Project” and show its contents. In the case of a personal computer, the user may open and operate multiple items in parallel. Just as opening a folder allows the user to check folders and files included in the folder, opening a project allows the user to check projects and tasks immediately subordinate to the project. In this case, projects correspond to folders and tasks correspond to files. Nevertheless, as described above, every operation is restricted by the grace period of a superordinate project, and no links can be created in a layer under its entity.

Next, the “Overview Display (List) Screen” will be described with reference to FIG. 18A. FIG. 18A illustrates how the “ROOT project” has been opened to display a list, which is the same as a file operation screen of a GUI. Opening the “Basic Research Project” will change the character string “ROOT project” on the horizontal bar into “Basic Research Project” and show its contents as a list. In the case of a personal computer, the user may open and operate multiple items in parallel. Just as opening a folder allows the user to check folders and files included in the folder, opening a project allows the user to check projects and tasks immediately subordinate to the project. In this case, projects correspond to folders and tasks correspond to files. Nevertheless, as described above, every operation is restricted by the grace period of a superordinate project, and no links can be created in a layer under its entity. The small folder icon displayed at the top indicates that this is a project. In the case of a task, the small icon represents papers.

Next, the “Overview Display (Column) Screen” will be described with reference to FIG. 18B. FIG. 18B illustrates how the “ROOT project” has been opened to display a list, which is the same as a file operation screen of a GUI. In the example illustrated in FIG. 18B, the “Patent Obtaining Project” is selected, and therefore, the “Applied Research Project,” to which the “Patent Obtaining Project” is subordinate, is displayed in a lighter background color, thus indicating that this is a path. Opening the “Basic Research Project” will change the character string “ROOT project” on the horizontal bar into “Basic Research Project” and show its contents as a list. In the case of a personal computer, the user may open and operate multiple items in parallel.

Just as opening a folder allows the user to check folders and files included in the folder, opening a project allows the user to check projects and tasks immediately subordinate to the project. In this case, projects correspond to folders and tasks correspond to files. The small folder icon displayed at the top indicates that this is a project. In the case of a task, the small icon represents papers. In the example illustrated in FIG. 18B, projects are displayed on the first and second columns and tasks are displayed on the third column That is to say, projects and tasks are arranged neatly on a column-by-column basis. However, if projects and tasks are included in mixture in the same project, then a list will be displayed such that a project is shown on an upper part of the same column (e.g., the second column) and a task is shown under the project.

Next, the “New Project Editing Screen” will be described with reference to FIG. 19A. This “New Project Editing Screen” will be displayed as an editing screen when the answer is YES in S23 shown in FIG. 4A. In a path display area 40, a path leading from the ROOT project to an immediately superordinate parent project, which is the destination of the project to be newly created, is shown. In the example shown in FIG.19A, the ROOT project has been selected as an immediately superordinate parent project. In the path display area 40, a path starting from an item immediately subordinate to the ROOT project is shown. An abbreviated name of the project is input in a project name input/setting area 41, and an outline of the project is input in an outline input/setting area 42. A “Completed” checkbox 47 is to be checked off by the user when the project, of which the name has been input in the project name input/setting area 41, is completed.

The user may pick up an option of either enabling or disabling the “Completed” checkbox 47 by default. If the “Completed” checkbox 47 is enabled, the user can manually check off the “Completed” checkbox 47. In a situation where there is even a single project or task in an underlying layer, an alert message that says, for example, “Are your sure to complete the project although there is incomplete items in an underlying layer?” is displayed. If the user does continue the completion process with the alert message ignored, all of those incomplete items in the underlying layer will be checked off as completed along with the target project, and editing will be made on the supposition that the project itself has been completed. On the other hand, if the user aborts the completion process in accordance with the alert message, then the editing status goes back to the status before he or she attempted to check all items off as completed. The “Completed” checkbox 47 of the project to be edited will be automatically checked off when all of those items (including tasks and projects) lower in order than the project are checked off as completed (i.e., when the last one of the items is checked off as completed).

On the other hand, if the “Completed” checkbox 47 is disabled, the operation of checking off the “Completed” checkbox 47 is disabled when even a single project or task is created immediately subordinate to the project to be edited. The “Completed” checkbox 47 of the project to be edited will be automatically checked off when all of those items (including tasks and projects) lower in order than the project are checked off as completed (i.e., when the last one of the items is checked off as completed). As used herein, the “disabled state” refers to a state where the user is prohibited from editing an item manually. Thus, even in the disabled state, the item may still be automatically edited by the system.

A New Project button 43 is a button to be clicked on by the user who is creating a new project. A New Task button 44 is a button to be clicked on by the user who is creating a new task. A New Schedule button 45 is a button to be clicked on by the user who is creating a new schedule. A New Heteronomous Schedule button 46 is a button to be clicked on by the user who is creating a new heteronomous schedule. Since no change is allowed from the “New Project Editing Screen” to any other new item editing screen (see FIG. 16), these buttons 43-46 are inactivated and displayed in a lighter shade.

In the “Grace Period” field, a start date input/setting area 48 is an area allowing the user to input the start date of the grace period of the new project that has been input to the project name input/setting area 41. An end date input/setting area 49 in the grace period field is an area allowing the user to input the end date of the grace period of the new project that has been input to the project name input/setting area 41. In the case of newly editing an item, the grace period of its parent project immediately superordinate to the item has been copied and input, by default, into the start and end date input/setting areas 48 and 49. If necessary, the user may adjust (e.g., narrow) the period to a more matching one. Specifically, in the example illustrated in FIG. 19A, the grace period of the ROOT project has been copied, and therefore, a minimum infinite value and a maximum infinite value have been set in the “start date” and “end date,” respectively.

In the “Working Period” field, a time when the user actually started the work and a time when he or she actually finished the work are set. Specifically, the time when he or she actually started the work is input in a start time input/setting area 50, and the time when he or she actually finished the work is input in an end time input/setting area 51. In the example illustrated in FIG. 19A, this “Working Period” field has no different appearance from the “Grace Period” field. In this “Working Period” field, an unset value (such as nil) has been entered as an initial value in both of the “start time” and the “end time.” As used herein, “nil” means “empty” with respect to an object (id type) of Objective-C. Also, at a point in time when the “Completed” checkbox 47 is checked off, normally the time is automatically set to be the “end time” of the “working period.”

For each project and each task, the working period is internally defined separately from the grace period. A time when the user undertook or put his or her hand to the work is recorded as the work start time, and a time when he or she finished the work is recorded as the work end time, thereby predicting an estimated turnaround time with the grace period and managing an actual turnaround time with the working period. A schedule also has internally defined work start and end times separately from the binding period. Normally, a schedule is equivalent to a binding period, and already has self-defined work start and end times in most cases. Thus, at a point in time when the start time of the binding period passes, the start time is automatically set to be the work start time by default. Likewise, at a point in time when the end time of the binding period passes, the end time is automatically set to be the work end time by default. In the case of an all-day schedule (i.e., a schedule set for an entire day), the binding period is ignored and a daily grace period is enabled. Thus, as in the case of projects and tasks, the estimated and actual turnaround times may be managed with the working period.

Note that the “New Project Editing Screen” described above shares some features in common with the “Existent Project Editing Screen,” “New Task Editing Screen,” “Existent Task Editing Screen,” “New Schedule Editing Screen,” “New Schedule Editing Screen (with Automatic Task Creation),” “Existent Schedule Editing Screen,” “New Heteronomous Schedule Editing Screen,” “New Heteronomous Schedule Editing Screen (with Automatic Task Creation),” and “Existent Heteronomous Schedule Editing Screen” to be described below. Thus, in the following description of these various types of editing screens, a detailed description of those common features will be omitted herein, and a focus will be placed on their differences.

The “Existent Project Editing Screen” will be described with reference to FIG. 19B. This “Existent Project Editing Screen” will be displayed as an editing screen when the answer is NO in S23 shown in FIG. 4A. “/Applied Research Project/” has been input to the path display area 40, which indicates that in the example shown in FIG.19B, the applied research project has been selected as an immediately superordinate parent project. In the project name input/setting area 41, “Patent Obtaining Project” has been input as an abbreviated project name. In the outline input/setting area 42, “Summarize the results of the applied research, file a patentable application, and obtain a patent” has been input as an outline of the project. In the example illustrated in FIG. 19B, an existent project is going to be edited, and therefore, current settings are displayed in an editable state. The “Completed” checkbox 47 has the same function as the counterpart shown in FIG. 19A.

In the case of editing an existent item, current settings are displayed in an editable state in the “Grace Period” field. Thus, if necessary, the user may readjust the grace period to a further matching one. In the “Working Period” field, a time when the user actually started the work and a time when he or she actually finished the work are set. In the example illustrated in FIG. 19B, since this is a state before the work is actually started, an unset value (such as nil) has been set as an initial value in each of the “Start Time” and the “End Time” of the “Working Period.” Also, at a point in time when the “Completed” checkbox is checked off, normally the time is automatically set to be the “End Time” of the “Working Period.” Since a change is sometimes allowed from the “Existent Project Editing Screen” to another new item editing screen (see FIG. 16), the New Project button 43, the New Task button 44, the New Schedule button 45, and the New Heteronomous Schedule button 46 are all activated (enabled) and displayed in a darker shade than in FIG. 19A.

The user may edit the terms of the outline displayed in the outline input/setting area 42, the values input in the start time and end time input/setting areas 48, 49 of the “Grace Period” field, and the values input in the start time and end time input/setting areas 50, 51 of the “Working Period” into any other terms or values. Nevertheless, the values input in the start time and end time input/setting areas 48, 49 of the “Grace Period” may be edited only within the range of the grace period of the “Applied Research Project” that is the immediately superordinate project. Also, the values input to the start time and end time input/setting areas 50, 51 of the “Working Period” may be edited only within the range of the period in which those values are displayed in the start time and end time input/setting areas 48, 49 to indicate the grace period. Further editing may also be made such that “the item is opened to a particular individual or group by setting rights for them” as in S27 shown in FIG. 4A. This “Patent Obtaining Project” will be opened to the individual or group for which rights have been set. This allows the individual or group, to which the project is opened, to create a link to the “Patent Obtaining Project” (see FIG. 6).

Next, the “New Task Editing Screen” will be described with reference to FIG. 20A. This “New Task Editing Screen” will be displayed as an editing screen when the answer is YES in S33 shown in FIG. 4B. Nothing is displayed in the path display area 40. In this state, the ROOT project has been selected as an immediately superordinate parent project. An abbreviated name of the task is input to a task name input/setting area 52, and an outline of the task is input to an outline input/setting area 42. Since no change is allowed from the “New Task Editing Screen” to any other new item editing screen (see FIG. 16), the New Project button 43, the New Task button 44, the New Schedule button 45, and the New Heteronomous Schedule button 46 are all inactivated (disabled) and displayed in a lighter shade.

Next, the “Existent Task Editing Screen” will be described with reference to FIG. 20B. This “Existent Task Editing Screen” will be displayed as an editing screen when the answer is YES in S36 shown in FIG. 4B. “/Applied Research Project/Patent Obtaining Project/” has been input to the path display area 40. Thus, the patent obtaining project immediately subordinate to the applied research project has been selected as an immediately superordinate parent project. “Specification Drafting” has been input to the task name input/setting area 52. Thus, the “Specification Drafting” immediately subordinate to the patent obtaining project has been selected as the existent task to edit. The outline of the existent task “Specification Drafting” has been input to the outline input/setting area 42. Specifically, “Draft a specification of a currently patentable technology” has been input to the outline input/setting area 42. This allows the user to learn about the details of the existent task “Specification Drafting.”

In this case, an existent task is going to be edited, and therefore, the current settings of the existent task are displayed in an editable state in the start time and end time input/setting areas 48, 49 of the “Grace Period” field. In the “Working Period” field, a time when the user actually started the work and a time when he or she actually finished the work are set in the start time and end time input/setting areas 48, 49, respectively. Since this is a state before the work is actually started, an unset value (such as nil) has been entered as an initial value in each of the “Start Time” and the “End Time” of the “Working Period.” Since a change is allowed from the “Existent Task Editing Screen” to either of the two new item editing screens, namely, the “New Schedule Editing Screen” or the “New Heteronomous Schedule Editing Screen” (see FIG. 16), the New Schedule button 45 and the New Heteronomous Schedule button 46 are displayed in a darker shade than in FIG. 19A.

The user may edit the terms of the outline displayed in the outline input/setting area 42, the values input to the start time and end time input/setting areas 48, 49 of the “Grace Period,” and the values input to the start time and end time input/setting areas 50, 51 of the “Working Period” into any other terms or values. Nevertheless, the values input in the start time and end time input/setting areas 48, 49 of the “Grace Period” may be edited only within the range of the grace period of the “Patent Obtaining Project” that is the immediately superordinate project. Also, the values input to the start time and end time input/setting areas 50, 51 of the “Working Period” may be edited only within the range of the period in which those values are displayed in the start time and end time input/setting areas 48, 49 to indicate the grace period. Further editing may also be made such that “the item is opened to a particular individual or group by setting rights for them” as in S37 shown in FIG. 4B. This task “Specification Drafting” will be opened to the individual or group for which rights have been set. This allows the individual or group, to which the project is opened, to create a link to the “Specification Drafting” (see FIG. 6).

Next, the “New Schedule Editing Screen” will be described with reference to FIG. 21A. This “New Schedule Editing Screen” will be displayed as an editing screen allowing the user to newly create a schedule when the answer is YES in S48 shown in FIG. 5. “/Applied Research Project/Patent Obtaining Project/” has been input to the path display area 40. Thus, the “Patent Obtaining Project” immediately subordinate to the “Applied Research Project” has been designated as a superordinate project. In the schedule name input/setting area 53, the task name of its superordinate task is displayed as it is as the schedule name in a non-editable state. In the example illustrated in FIG. 21A, “Specification Drafting” has been input as the schedule name, which indicates that a new schedule with the name “Specification Drafting” has been selected as the object of editing.

Although the “Schedule Name” is non-editable, some feature unique to the schedule may be added as an abbreviated name to the title input/setting area 54. For example, a “Schedule to Meet Patent Attorney” may be input to the title input/setting area 54. Alternatively, input to this title input/setting area 54 may be omitted to keep the title input/setting area 54 blank. Since the outline of the immediately superordinate task has been copied and input to the outline input/setting area 42 of the new schedule, the outline may be edited, as needed, by the user into a more appropriate phrase.

In the case of editing a new schedule, the user inputs and sets the scheduled date of implementation of that schedule before the new schedule editing screen is displayed. In that case, the user is allowed to input and set the date only within the range of the grace period of its superordinate task (such as “Specification Drafting”). Thereafter, when the new schedule editing screen is displayed, the pre-input scheduled date of implementation will be displayed in the start time and end time input/setting areas 48, 49. Furthermore, only an hour part of the current time value, of which the minute part has been truncated, has been set as an initial value in the start time input/setting area 48, while a temporal value one hour later than the initial value set in the start time input/setting area 48 has been set as an initial value in the end time input/setting area 49. The user may change these temporal values into appropriate ones as needed. The user is allowed to edit any of these temporal values only within the range of the grace period of its superordinate task (such as “Specification Drafting”).

In the example illustrated in FIG. 21A, the all-day option is not picked up, and therefore, the “Completed” checkbox 47, the All-Day Option button 55, and the start time and end time input/setting areas 50 and 51 of the “Working Period” are all disabled (greyed out). The “all-day option” is an option allowing the user to set the “schedule” or “heteronomous schedule” he or she is going to input to be an all-day one, making it “all-day schedule” or “all-day heteronomous schedule.” Meanwhile, the user's clicking on the All-Day Option button 55 to enable that option changes the screens into “All-Day Schedule Editing Screen” in the case of a “schedule” or into “All-Day Heteronomous Schedule Editing Screen” in the case of a “heteronomous schedule.” This will be described later. In the example illustrated in FIG. 21A, the all-day option is not picked up, and therefore, the start time and end time input/setting areas 50 and 51 of the “Working Period” are disabled. In the case of sampling actual working hours, however, these areas may be enabled so that the values in these areas are manually editable.

Next, the “New Schedule Editing Screen (with Automatic Task Creation)” will be described with reference to FIG. 21B. This “New Schedule Editing Screen (with Automatic Task Creation)” will be displayed as an editing screen, allowing the user to newly create a schedule while no immediately superordinate tasks are created, when the answer is NO in S41 shown in FIG. 5. Since there are no immediately superordinate tasks, those immediately superordinate tasks are created automatically, which is a difference from the “New Schedule Editing Screen” shown in FIG. 21A.

“/Applied Research Project/Patent Obtaining Project/” has been input to the path display area 40. In this state, the “Patent Obtaining Project” immediately subordinate to the “Applied Research Project” has been designated as a superordinate project. Thus, a new task will be created automatically immediately subordinate to the “Patent Obtaining Project.” Specifically, if the user inputs the name of a schedule (e.g., “Fifth Meeting Schedule to Meet Patent Attorney”) into the schedule name input/setting area 53, that name of the schedule will be used as it is as the name of a task to be automatically created (e.g., “Fifth Meeting Schedule to Meet Patent Attorney”). Therefore, input to the schedule name input/setting area 53 is non-omissible, indispensable input item. Optionally, input to the title input/setting area 54 and outline input/setting area 42 may be omitted just as described above.

In the case of editing a new schedule with automatic task creation, the user inputs and sets the scheduled date of implementation of that schedule before the new schedule editing screen (with automatic task creation) is displayed. In that case, the user is allowed to input and set the date only within the range of the grace period of its superordinate task (which is an automatically created task in this case). The grace period of the automatically created task is set to be the pre-editing initial value (see S44) created from the grace period of the project selected at the destination described above (e.g., the patent obtaining project in the example illustrated in FIG. 21B). Thereafter, when the new schedule editing screen (with automatic task creation) is displayed, the pre-input and preset date of the grace period will be displayed in the start time and end time input/setting areas 48, 49.

Furthermore, only an hour part of the current time value, of which the minute part has been truncated, has been set as an initial value in the start time input/setting area 48, while a temporal value one hour later than the initial value set in the start time input/setting area 48 has been set as an initial value in the end time input/setting area 49. The user may change these temporal values into appropriate ones as needed. The user is allowed to edit any of these temporal values only within the range of the grace period of the automatically created task. In the “Working Period” field, a time when the user actually started the work and a time when he or she actually finished the work are set in the start time and end time input/setting areas 50, 51, respectively.

In the example illustrated in FIG. 21B, the all-day option is not picked up, and therefore, the “Completed” checkbox 47, the All-Day Option button 55, and the start time and end time input/setting areas 50 and 51 of the “Working Period” are all disabled (greyed out). Setting the all-day option to be picked up by default will enable the “Completed” checkbox 47 and the start time and end time input/setting areas 50 and 51 of the “Working Period,” disabling the preset binding period. In the example illustrated in FIG. 21B, the all-day option is not picked up, and therefore, the start time and end time input/setting areas 50 and 51 of the “Working Period” are disabled. In the case of sampling actual working hours, however, these areas may be enabled so that the values in these areas are manually editable.

Next, the “Existent Schedule Editing Screen” will be described with reference to FIG. 22A. This “Existent Schedule Editing Screen” will be displayed as an editing screen, allowing the user to edit an already created, existent schedule, when the answer is NO in S48 shown in FIG. 5. “/Applied Research Project/Patent Obtaining Project/” has been input to the path display area 40. Also, “Specification Drafting” has been input to the schedule name input/setting area 53, and “Fifth Meeting Schedule to Meet Patent Attorney” has been input to the title input/setting area 54. Thus, an existent schedule with the name “Specification Drafting” entitled “Fifth Meeting Schedule to Meet Patent Attorney” has been selected as the object of editing. Although the schedule name input/setting area 53 is non-editable, some feature unique to the schedule may be added as an abbreviated name to the title input/setting area 54.

The user may edit the terms of the outline displayed in the outline input/setting area 42 and the values input to the start time and end time input/setting areas 48, 49 of the binding period into any other terms or values. Nevertheless, the values input to the start time and end time input/setting areas 48, 49 of the binding period may be edited only within the range of the grace period of the “Specification Drafting” that is the immediately superordinate task. Further editing may also be made such that “the item is opened to a particular individual or group by setting rights for them” as in S54 shown in FIG. 5. This task will be opened to the individual or group for which rights have been set. Optionally, input to the title input/setting area 54 and outline input/setting area 42 may be omitted just as described above. The same statement applies to the all-day option as what has already been described.

Next, the “New Heteronomous Schedule Editing Screen” will be described with reference to FIG. 22B. This “New Heteronomous Schedule Editing Screen” will be displayed as an editing screen, allowing the user to newly create a heteronomous schedule, when the answer is YES in S102 shown in FIG. 8. “/Basic Research Project/Experiment Project/” has been input to the path display area 40. “Graph Plotting” has been input to the heteronomous schedule name input/setting area 56. This indicates that a new heteronomous schedule with the name “Graph Plotting” has been selected as the object of editing. Although the heteronomous schedule name displayed in the heteronomous schedule name input/setting area 56 is non-editable, some feature unique to the heteronomous schedule may be added as an abbreviated name to the title input/setting area 54. Since the outline of the immediately superordinate task has been copied and input to the outline input/setting area 42, the outline may be edited, as needed, by the user into a more appropriate phrase. Optionally, input to the title input/setting area 54 and outline input/setting area 42 may be omitted.

In the case of creating a new heteronomous schedule, the user inputs and sets the date of that heteronomous schedule before the new heteronomous schedule editing screen is displayed. In that case, the user usually inputs and sets the date within the range of the grace period of its superordinate task (such as “Graph Plotting”). If the user has input a date falling out of the range of the grace period, an alert message will be displayed (in S105). However, if the user enters the date by ignoring the alert message, then the date entered will be displayed in the start time and end time input/setting areas 48 and 49 (if the answer is YES in S106). Thereafter, when the new heteronomous schedule editing screen is displayed, the pre-input and preset date will be displayed in the start time and end time input/setting areas 48, 49.

Furthermore, only an hour part of the current time value, of which the minute part has been truncated, has been set as an initial value in the start time input/setting area 48, while a temporal value one hour later than the initial value set in the start time input/setting area 48 has been set as an initial value in the end time input/setting area 49. The user may change these temporal values into appropriate ones as needed. Since no change is allowed from the “New Heteronomous Schedule Editing Screen” to another editing screen (see FIG. 16), the New Project button 43, the New Task button 44, the New Schedule button 45, and the New Heteronomous Schedule button 46 are all disabled (inactivated). In addition, since the heteronomous schedule has just been newly created, the Participation Agreement button 58, allowing the user to express his or her agreement to participate in that heteronomous schedule, is also disabled (inactivated).

In FIG. 22B, the all-day option is not picked up, and therefore, the binding period is enabled. Setting the all-day option to be enabled by default would disable the binding period that has been set. The all-day option for a heteronomous schedule is usually used in the following manner Specifically, if the scheduled date of an event has already been determined but its start time has not been determined yet, the parameter of the event is once set to be all-day. When the start time is determined, the all-day setting will be turned OFF to set a binding period instead.

Next, the “New Heteronomous Schedule Editing Screen (with Automatic Task Creation)” will be described with reference to FIG. 23A. This “New Heteronomous Schedule Editing Screen (with Automatic Task Creation)” will be displayed as an editing screen, allowing the user to newly create a heteronomous schedule while no immediately superordinate tasks are created, when the answer is NO in S100 shown in FIG. 8. Since there are no immediately superordinate tasks, those immediately superordinate tasks are created automatically, which is a difference from the “New Heteronomous Schedule Editing Screen” shown in FIG. 22B. “/Basic Research Project/Experiment Project/” has been input to the path display area 40. The heteronomous schedule name input/setting area 56 is in a standby state, ready for the user's input. Since the heteronomous schedule name input will be the name of an automatically created task as it is, input of the “Heteronomous Schedule Name” is non-omissible, indispensable input item. Optionally, input to the title input/setting area 54 and outline input/setting area 42 may be omitted just as described above.

The binding period may be edited as already described with reference to FIG. 21B. In this case, however, a heteronomous schedule is going to be edited, and therefore, even if an alert message is displayed in S105 as already described with reference to FIG. 22B, the user is still allowed to input and set the binding period by ignoring the alert message. As for the all-day option, the same statement applies as what has already been described with reference to FIG. 22B. Since this is a new heteronomous schedule editing screen, the New Project button 43, the New Task button 44, the New Schedule button 45, and the New Heteronomous Schedule button 46 are all disabled (inactivated).

Next, the “Existent Heteronomous Schedule Editing Screen” will be described with reference to FIG. 23B. This “Existent Heteronomous Schedule Editing Screen” will be displayed as an editing screen, allowing the user to edit an already created, existent heteronomous schedule, when the answer is NO in S102 shown in FIG. 8. “/Basic Research Project/Experiment Project/” has been input to the path display area 40. In addition, “Graph Plotting” has been input to the schedule name input/setting area 56, and “First Meeting Schedule of Graph Plotting Software Conference” has been input to the title input/setting area 54. This indicates that an existent heteronomous schedule with the name “Graph Plotting” entitled “First Meeting Schedule of Graph Plotting Software Conference” has been selected as the object of editing. Although the heteronomous schedule name input/setting area 56 is non-editable, some feature unique to the heteronomous schedule may be added as an abbreviated name to the title input/setting area 54.

The user may edit the terms of the outline displayed in the outline input/setting area 42 and the values input to the start time and end time input/setting areas 48, 49 of the binding period into any other terms or values. Nevertheless, the values input to the start time and end time input/setting areas 48, 49 of the binding period are editable only within the range of the grace period of the “Graph Plotting” that is the immediately superordinate task. Optionally, input to the title input/setting area 54 and outline input/setting area 42 may be omitted just as described above. The same statement applies to the all-day option as what has already been described. As further editing, editing may also be made such that “the item is opened to a particular individual or group by setting rights for them” as in S108 shown in FIG. 8. This heteronomous schedule will be opened to the individual or group for whom rights have been set. This allows the individual or group, to which this heteronomous schedule is opened, to participate in this heteronomous schedule.

Specifically, the user selects and specifies another user's heteronomous schedule on this “Existent Heteronomous Schedule Editing Screen” and then clicks on the Participation Agreement button 58. This makes the answer YES in S47 and S51 shown in FIG. 5, and the processing step S52 of entering and storing the name of the user who has expressed his or her agreement to participate in the heteronomous schedule into the participation list in the source heteronomous schedule is performed. Specifically, in a multiple-user environment, pressing the Participation Agreement button 58 automatically creates a schedule, of which the existent title is changed to include an additional character string such as “: Attend” at the end and in which the outline and binding period are copied as they are, within its superordinate task and enters the user's own information to the participation list after the creation.

In the case of the heteronomous schedule shown in FIG. 23B, a schedule entitled “First Meeting Schedule of Graph Plotting Software Conference: Attend” is automatically created. Also, pressing the New Schedule button 45 changes the screens into a new schedule editing screen (see FIG. 21A) with the same content. Thus, in a situation where the user already knows he or she has to leave in the middle, for example, he or she ends editing with the binding period shortened. This allows the edited binding period to be entered automatically into the participation list. When the user participates in this heteronomous schedule (in S52), the heteronomous schedule becomes his or her own schedule (i.e., a schedule created from the attributor heteronomous schedule). The user may cancel his or her participation by deleting the schedule created from the attributor heteronomous schedule.

A heteronomous schedule is a schedule of a special form, and is different from a project or a task. Thus, a link to a heteronomous schedule cannot be created in the same way as a normal schedule. As for the deletion of a project or a task, if the entity of a project has been deleted, then every link created from the entity and all items in a layer under the project are deleted. In deleting a link to a project, on the other hand, it is sufficient to delete the link in question itself. If the entity of a task has been deleted, there will be no items any longer under the task, because a schedule, a heteronomous schedule, and other items are parameters of the task. Thus, in that case, it is sufficient to delete every item included in the task and every link created from its entity. Also, as for a change of a project or a task, only its entity needs to be changed and there is no need to change its link, because the link just refers to the entity.

Next, it will be described what to do if the all-day option mentioned above is turned ON. The user's clicking on the All-Day Option button 55 on any of the editing screens shown in FIGS. 21A-23B turns the all-day option ON. Turning the all-day option ON changes the screens displayed from any of the various editing screens shown in FIGS. 21A-23B to its corresponding all-day setting screen (not shown), as described above. For example, clicking on the All-Day Option button 55 on the new schedule editing screen shown in FIG. 21A changes the screens displayed into an all-day schedule editing screen (not shown). Also, clicking on the All-Day Option button 55 on the new heteronomous schedule editing screen shown in FIG. 22B changes the screens displayed into an all-day heteronomous schedule editing screen (not shown). Then, the user edits his or her all-day schedule on the all-day schedule editing screen, and also edits his or her all-day heteronomous schedule on the all-day heteronomous schedule editing screen.

Turning the all-day option ON enables (or activates) the “Completed” checkbox 47 as described above. Also, in the case of an all-day schedule, the user is allowed to set the “Working Period.” Specifically, only the date part of the start time input/setting area 48 of the binding period is editable within the grace period of its superordinate task, but the end time input/setting area 49 of the binding period is disabled (greyed out) while displaying, as it is, the date input in the start time input/setting area 48 of the binding period. In addition, setting a value in a working period start time input/setting area 50 at the start of the work and checking off the “Completed” checkbox 47 at the end of the work allows a value to be recorded in a working period end time input/setting area 51.

In the case of a heteronomous schedule, turning the All-Day Option button 55 ON allows the user to edit only the date part of the value in the start time input/setting area 48 of the binding period within the grace period of its superordinate task, but disables (greys out) the end time input/setting area 49 of the binding period with the date input in the start time input/setting area 48 of the binding period displayed as it is in the end time input/setting area 49. The all-day option for a heteronomous schedule is usually used in the following manner Specifically, if the scheduled date of an event has already been determined but its start time has not been determined yet, the parameter of the event is once set to be all-day. When the start time is determined, the all-day setting will be turned OFF to set a binding period instead.

Next, changes to be made within a normal screen will be described with reference to FIG. 24A. As described above, this normal screen is displayed when the user selects, and clicks on, a normal screen button on a horizontal menu bar displayed on the display screen of the display device 37 of the client terminal 2 or a pop-up menu. On this normal screen, displayed are a “To-Do List/Calendar Simultaneous Display” button, a “To-Do List Display” button, and a “Calendar Display” operating area to select one of the four calendar display modes as shown in FIG. 24A. Also, in the “Calendar Display” operating area, displayed are a “Monthly Calendar Display” button, a “Biweekly Calendar Display” button, a “Weekly Calendar Display” button, and a “Daily Calendar Display” button.

The user's clicking on the “To-Do List/Calendar Simultaneous Display” button displays the “Task (To-Do List)/Schedule (Calendar) Simultaneous Display Screen” shown in FIG. 26. If the user exercises a to-do list full-screen display option in this state, then the screens are changed from the “Task (To-Do List)/Schedule (Calendar) Simultaneous Display Screen” to the to-do list display screen shown in FIG. 24B. This to-do list display screen shows a list of the user's tasks. If the user exercises the to-do list/calendar simultaneous display option in this display state, then the screen changes into the “Task (To-Do List)/Schedule (Calendar) Simultaneous Display Screen.”

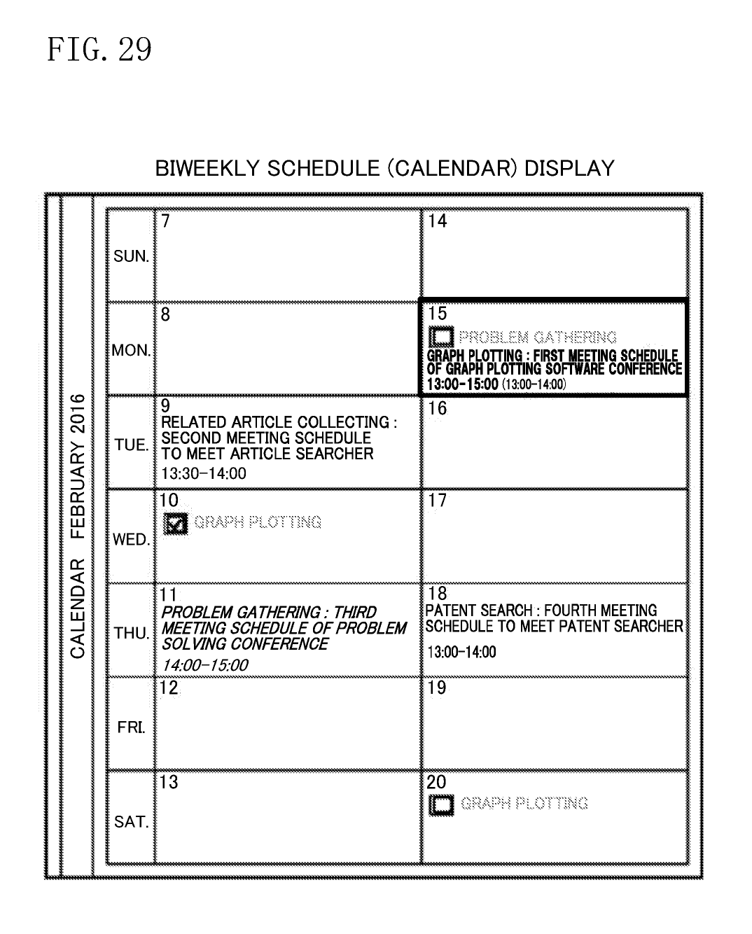

If the user exercises a calendar full-screen display option while either the “Task (To-Do List)/Schedule (Calendar) Simultaneous Display Screen” or the to-do list display screen is being displayed, then the “Calendar Display” operating area will be displayed at a larger zoom power. The user's selecting and clicking on any of the “Monthly Calendar Display,” “Biweekly Calendar Display,” “Weekly Calendar Display,” and “Daily Calendar Display” buttons displayed in the “Calendar Display” operating area changes the screens into a calendar display screen of the selected mode. If the user clicks on the “Monthly Calendar Display” button, the screen changes into the monthly schedule (calendar) display screen shown in FIG. 28. If the user clicks on the “Biweekly Calendar Display” button, the screen changes into the biweekly schedule (calendar) display screen shown in FIG. 29.

If the user clicks on the “Weekly Calendar Display” button, the screen changes into the weekly schedule (calendar) display screen shown in FIG. 30A. If the user clicks on the “Daily Calendar Display” button, the screen changes into the daily schedule (calendar) display screen shown in FIG. 30B. Among these monthly schedule (calendar), biweekly schedule (calendar), weekly schedule (calendar), and daily schedule (calendar) display screens, objects of display change between the respective display screens as shown in FIG. 27B in accordance with the user's operation.

If the user exercises the to-do list/calendar simultaneous display option in a state where the “Calendar Display” operating area is displayed at a larger zoom power or in a state where any of the four modes of schedule (calendar) display screens is displayed, then the screen changes into the task (to-do list)/schedule (calendar) simultaneous display screen. On the other hand, if the user exercises the to-do list full-screen display option in either of the two states, the screen changes into a task entered confirmation display screen.

Next, the task entered confirmation display screen will be described with reference to FIG. 24B. On this display screen, the user's tasks are displayed as a list. Specifically, the names of the respective tasks and their deadlines are displayed as a list and “Completed” checkboxes 47 allowing the user to check off tasks completed are also displayed. Essentially, in the field of schedulers, a to-do list is used to allow the user to check off any completed task quickly, and therefore, “Completed” checkboxes 47 are indispensable for such a list. For that reason, a “Completed” checkbox 47, indicating whether or not the task has been completed by allowing the user to check the box off, is displayed at the right end of each task name In the example illustrated in FIG. 24B, the tasks with the names “Problem Gathering” and “Graph Plotting” are indicated as having been completed.

In the example illustrated in FIG. 24B, the first four tasks from the top of the list are displayed in a bold font and the two tasks under the four are displayed in a standard font. The four tasks displayed in the bold font represent all-day scheduled tasks including all-day schedules. Also, as described above, the name of a schedule inherits (i.e., is the same as) the name of its superordinate task, and therefore, each single schedule is a single all-day schedule. Unlike a normal schedule, the period of an all-day schedule is not a binding period but covers an entire day (i.e., has a grace period of a single day). That is why the deadline of an all-day schedule is indicated as a scheduled date of implementation, of which the exact period of implementation is to be determined. Meanwhile, the other two tasks displayed in the standard font are tasks with no schedules at all.

Note that when there is some space left on the display screen, the name of a task including an all-day schedule (which is actually the name of an all-day schedule) may be followed by the title of the all-day schedule, for example, with a colon interposed as a separator between them. For example, if the task with the name “Problem Gathering” in the example described above includes all-day schedules entitled “Problem Gathering Conference #1” and “Problem Gathering Conference #2,” respectively, then “Problem Gathering: Problem Gathering Conference #1” and “Problem Gathering: Problem Gathering Conference #2” may be displayed. Normally, tasks, of which the start time has already passed, are extracted and displayed on a to-do list. Therefore, the start date of the grace period is only used internally when the to-do list is extracted, and not shown.

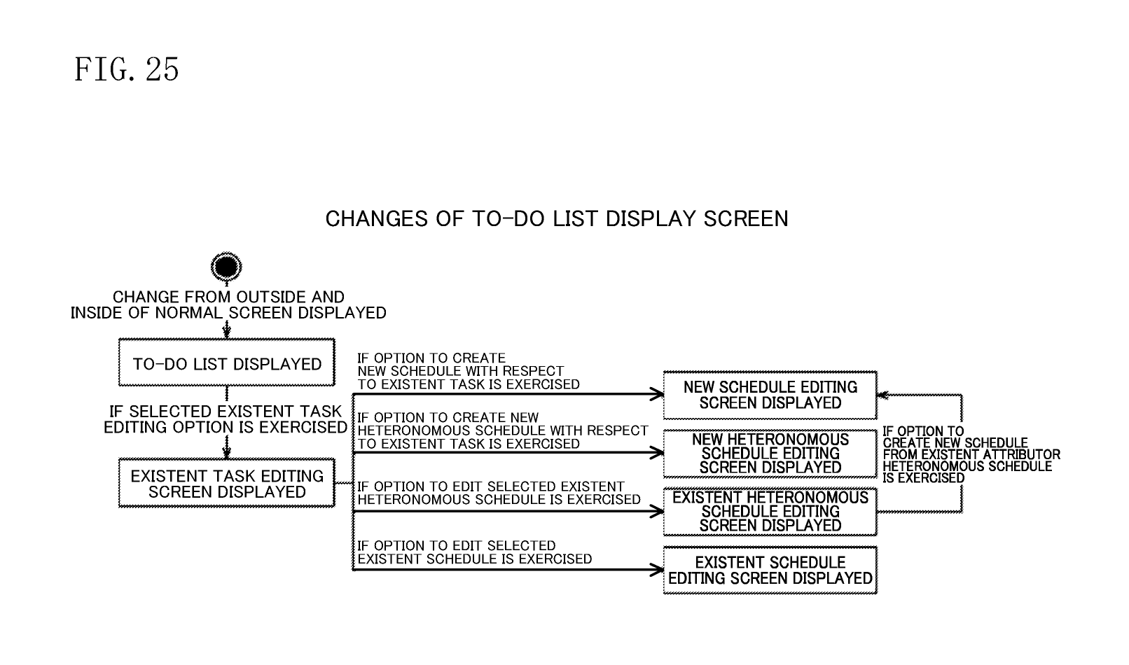

Next, it will be described with reference to FIG. 25 what screens this task entered confirmation display screen can change into. In accordance with the user's operation shown in FIG. 25, the screens change from the task entered confirmation display screen into the existent task editing screen (see FIG. 20B). Then, in accordance with the user's operation, the screens further change from the existent task editing screen into the new schedule editing screen (see FIG. 21A), the new heteronomous schedule editing screen (see FIG. 22B), the existent schedule editing screen (see FIG. 22A), or the existent heteronomous schedule editing screen (see FIG. 23B).

Note that after some items have been modified or created on the editing screen to which the previous screen has changed, the screen will turn back into the previous one (i.e., the to-do list display screen) in accordance with the user's operation. In FIG. 25, however, the arrow indicating the change is omitted to avoid the complexity of illustration. Alternatively, if the user wants to newly create an item, then the user may call the tree display. Nevertheless, the user can also newly create a schedule or a heteronomous schedule with respect to an existent task from the to-do list display screen as well. Also, the non-displayed (i.e., non-extracted) items may be either re-extracted with the extraction condition changed or displayed with the tree display called.

Next, the task (to-do list)/schedule (calendar) simultaneous display screen will be described with reference to FIG. 26. In the example illustrated in FIG. 26, a to-do list is shown in the task list area, and a schedule is shown in the calendar area. Specifically, according to the schedule displayed in the calendar area, the user is supposed to attend, only from 13:00 through 14:00, the “First Meeting Schedule of Graph Plotting Software Conference” to be held from 13:00 through 15:00 following a heteronomous schedule with the name “Graph Plotting.”

The to-do list shown in the task list area is a completion check list indicating actions to be done on that day (e.g., Feb. 15, 2016 in the example shown in FIG. 26) and actions to be done by the deadlines. That is to say, this is a list of items to be confirmed and checked on that day. Thus, it is most efficient to make the calendar show a matching schedule for that day. Thus, although a to-do list and a daily calendar are supposed to be shown by default, this scheduler is configured to facilitate the user's recognition of the current status by allowing him or her to have an overview of his or her schedules with the modes of display of the calendar changed from any of one year, one month, two weeks, one week, or one day to another. Also, changing the reference date with the calendar display modes switched also allows the user to change the reference date of the to-do list, thus updating the to-do list into a different one starting from the newly selected reference date.

This “Task (To-Do List)/Schedule (Calendar) Simultaneous Display Screen” is displayed by searching for, and displaying, a task (e.g., “Graph Plotting” in the example shown in FIG. 26) and a schedule (e.g., “First Meeting Schedule of Graph Plotting Software Conference” in the example shown in FIG. 26) that are stored and interlinked with each other via a path. For example, on the weekly schedule (calendar) display screen (see FIG. 30A), the all-day schedule of “Graph Plotting” is displayed. This should be displayed as a to-do list (task list). In FIG. 30A, however, only a calendar is displayed, and therefore, “Graph Plotting” is shown as an all-day schedule in the calendar. On the other hand, if a task list and a calendar are displayed simultaneously as shown in FIG. 26, a control operation is performed such that “Graph Plotting” is not displayed as a part of the calendar but displayed as an item of the task list. This type of control is realized by the interlinked storage and uniform management of schedules, heteronomous schedules, and tasks, which is one of the advantages of the uniform management.

Meanwhile, the control operation is also performed such that although some tasks, to which no schedules have been entered yet (such as “Photo Shooting” and “Experiment Data Reduction”), are displayed on the task list, any of the tasks will be removed from the task list and displayed on the calendar as soon as even a single schedule is entered into the task. This type of control is realized by the interlinked storage and uniform management of schedules, heteronomous schedules, and tasks, which is one of the advantages of the uniform management.

In addition, not just listing tasks having nothing to do with a given schedule (i.e., what is called “Empty Tasks (i.e., tasks with no associated schedules)” according to this method) but also interlinking even those tasks with the schedule allows an all-day-specified schedule (i.e., a schedule, of which the grace period is set to be a particular date but of which the binding period has not been set yet) to be handled as a division unit of an all-day-specified task limited to that particular date, instead of a schedule. This also enables a list including both such empty tasks and all-day schedules to be managed as a single to-do list.

More specifically, according to this embodiment, an “Empty Task,” i.e., a task associated with no schedules at all, is handled as a task, which is allowed to be performed within the grace period and which is managed on a task-by-task basis about whether or not to be performed. Meanwhile, an “all-day schedule,” i.e., a schedule supposed to be performed all day long without being limited to any implementation period, is handled as a schedule, of which the grace period is set to be the whole specified date (i.e., from 0:00 of that date through 0:00 of the next date) but of which the binding period has not been specified yet, i.e., a task having a grace period of substantially 24 hours. This allows a task and a schedule to be edited and displayed so as to be interlinked with each other, which has been impossible in the known art. In addition, both an empty task and an all-day schedule may be shown on a to-do list within the display range period, thus allowing the user to extract and create them as a mixed to-do list and check its completion within the same list.

Next, it will be described with reference to FIG. 27A what editing screens the calendar display screen can change into. In accordance with the user's operation, the screens change from the calendar display screen into the existent task editing screen (see FIG. 20B), the existent schedule editing screen (see FIG. 22A), or the existent heteronomous schedule editing screen (see FIG. 23B) as shown in FIG. 24. The screens further change from the existent task editing screen (see FIG. 20B) into the new schedule editing screen (see FIG. 21A), the new heteronomous schedule editing screen (see FIG. 22B), the existent heteronomous schedule editing screen (see FIG. 23B), or the existent schedule editing screen (see FIG. 22A).

Note that after some items have been modified or created on the editing screen to which the previous screen has changed, the screen will turn back into the previous one (i.e., any of the calendar display screens) in accordance with the user's operation. In FIG. 27A, however, the arrow indicating the change is omitted to avoid the complexity of illustration. Alternatively, if the user wants to newly create an item, then the user may call the tree display. Nevertheless, the user can also newly create a schedule or a heteronomous schedule with respect to an existent task from the calendar display screen as well. Also, the non-displayed (i.e., non-extracted) items may be either re-extracted with the extraction condition changed or displayed with the tree display called.

Next, the monthly schedule (calendar) display screen will be described with reference to FIG. 28. In the example illustrated in FIG. 28, a monthly schedule (calendar) for February, 2016 is displayed. As for this monthly display, in the case of a terminal with a large screen, day-by-day schedules to be implemented are shown as many as possible for the period of February 1 through 29, 2016. In the case of a mobile communications terminal such as a smartphone, on the other hand, it is indicated by icons, for example, whether or not there are any schedules to be implemented for each day. Tapping on any of those icons allows the schedule for that day to be shown at a larger zoom power. The same statement also applies to the biweekly schedule (calendar) display screen to be described later with reference to FIG. 29.

Also, in the example illustrated in FIG. 28, the date including the current time is indicated by the bold frame. Alternatively, “Today” or “Present Day” may be displayed, or the frame may be specially decorated, to indicate that the date includes the current time. The same statement also applies to the biweekly schedule (calendar) display screen to be described later with reference to FIG. 29. Also, in the example illustrated in FIG. 28, only the titles are shown as for entitled schedules so that schedules can be shown as many as possible inside a single frame. Conversely, showing only the names of schedules without showing their titles allows the user to distinguish the schedules belonging to the same group.

In this embodiment, each schedule is regarded as a division unit of its superordinate task as described above. Thus, the name of each schedule is set to be the name of its superordinate task, and schedules belonging to the same group all have the same name Also, in this example, all-day schedules (such as “Problem Gathering” and “Graph Plotting”) are shown and have their characters displayed in grey so as to be easily distinguished from normal time restricted schedules. Since these schedules are also shown on a to-do list, they are not necessarily shown on the calendar. When a to-do list and a calendar are displayed simultaneously, hiding such an all-day schedule on the calendar would make the schedule more easily recognizable for the user. In the example illustrated in FIG. 28, a heteronomous schedule that the user has not decided yet whether or not he or she will participate in is displayed in italics (such as “Third Meeting Schedule of Problem Solving Conference”), and a heteronomous schedule that the user has already expressed his or her agreement to participate in (i.e., an already created schedule) is displayed in a bold font (such as “First Meeting Schedule of Graph Plotting Software Conference”).

Next, the biweekly schedule (calendar) display screen will be described with reference to FIG. 29. In the example illustrated in FIG. 29, a biweekly schedule (calendar) for Feb. 7-20, 2016 is displayed. In the example illustrated in FIG. 29, the name of each schedule (which is the same as the name of its superordinate task) is shown, which is followed, with a colon interposed as a separator, by the title, if the schedule is an entitled one. Also, in the example illustrated in FIG. 29, all-day schedules (such as “Problem Gathering” and “Graph Plotting”) are shown and have their characters displayed in grey so as to be easily distinguished from normal time restricted schedules. In addition, a “Completed” checkbox is also shown at the top of each all-day schedule. Since these schedules are also shown on a to-do list, they are not necessarily shown on the calendar. When a to-do list and a calendar are displayed simultaneously, hiding such all-day schedules on the calendar would make the schedules more easily recognizable for the user.

In the example illustrated in FIG. 29, a heteronomous schedule that the user has not decided yet whether or not he or she will participate in is displayed in italics (such as “Problem Gathering: Third Meeting Schedule of Problem Solving Conference”), and a heteronomous schedule that the user has already expressed his or her agreement to participate in (i.e., an already created schedule) is displayed in a bold font (such as “Graph Plotting: First Meeting Schedule of Graph Plotting Software Conference”). The name and title of a schedule that the user has expressed his or her agreement to participate in, indicating his or her attendance in a heteronomous schedule, are omitted. However, if his or her schedule is shorter than the heteronomous schedule (e.g., if he or she plans to leave halfway through the heteronomous schedule), then his or her scheduled participation period is indicated in parentheses as shown in FIG. 29.

Next, the weekly schedule (calendar) display screen will be described with reference to FIG. 30A. In the example illustrated in FIG. 30A, a weekly schedule (calendar) for Feb. 14-20, 2016 is displayed. The date including the current time is also displayed in the same way as already described for the monthly schedule (calendar) display screen with reference to FIG. 28. Also, in the example illustrated in FIG. 30A, all-day schedules (such as “Problem Gathering” and “Graph Plotting”) are shown and have their characters displayed in grey so as to be easily distinguished from normal time restricted schedules. In addition, a “Completed” checkbox is also shown at the top of each all-day schedule.

Since these schedules are also shown on a to-do list, they are not necessarily shown on the calendar. When a to-do list and a calendar are displayed simultaneously, hiding such all-day schedules on the calendar would make the schedules more easily recognizable for the user. The name and title of a schedule that the user has expressed his or her agreement to participate in, indicating his or her attendance in a heteronomous schedule, are omitted. However, if his or her schedule is shorter than the heteronomous schedule (e.g., if he or she plans to leave halfway through the heteronomous schedule), then his or her scheduled participation period is indicated in parentheses as shown in FIG. 30A. Also, as for an entitled schedule, the “schedule name: title” format may be replaced with a title-only format from which the schedule name is omitted and to which a colon is added to the top (i.e., “:title”).

Next, the daily schedule (calendar) display screen will be described with reference to FIG. 30B. In the example illustrated in FIG. 30B, a schedule (calendar) for Feb. 15, 2016 is displayed. Although only a limited range is displayed in a fixed manner, hidden ranges may also be displayed and confirmed by scrolling the screen displayed. In the example illustrated in FIG. 30B, a daily schedule is displayed, and therefore, no all-day schedules are displayed. However, if the to-do list is not displayed simultaneously, all-day schedules with a checkbox may be displayed with a separate frame provided on top, bottom, right, or left of the display screen. In FIG. 30B, the first line in a bold font represents a heteronomous schedule, indicating that the event (i.e., “First Meeting Schedule of Graph Plotting Software Conference”) itself will be held from 13:00 through 15:00.

The next line in a standard font represents this scheduler user's own schedule, indicating that he or she plans to participate in the event from 13:00 through 14:00 (leaving early). In this line, “: Attend” is a suffix added to the title of a schedule created from an attributor heteronomous schedule (e.g., “First Meeting Schedule of Graph Plotting Software Conference”). As for a schedule to be created from an attributor heteronomous schedule, a predetermined suffix such as “: Attend” or “: Participate” is suitably able to be set for the title at the time of its creation. Also, if the user plans not to leave early (i.e., if a heteronomous schedule and a schedule attributed to the heteronomous schedule have a binding period of the same length), either the heteronomous schedule or a schedule attributed to the heteronomous schedule may be hidden. As for an entitled schedule, the “schedule name: title” format may be replaced with a title-only format from which the schedule name is omitted and to which a colon is added to the top (i.e., “: title).

In the embodiments described above, the plurality of client terminals 2, 2, . . . shown in FIG. 1 are supposed to operate following the client-server model. However, this is only an example. An alternative embodiment in which those client terminals 2, 2, . . . operate stand-alone will be described as a variation. In the following description of that variation, only differences from the client-server model will be described.

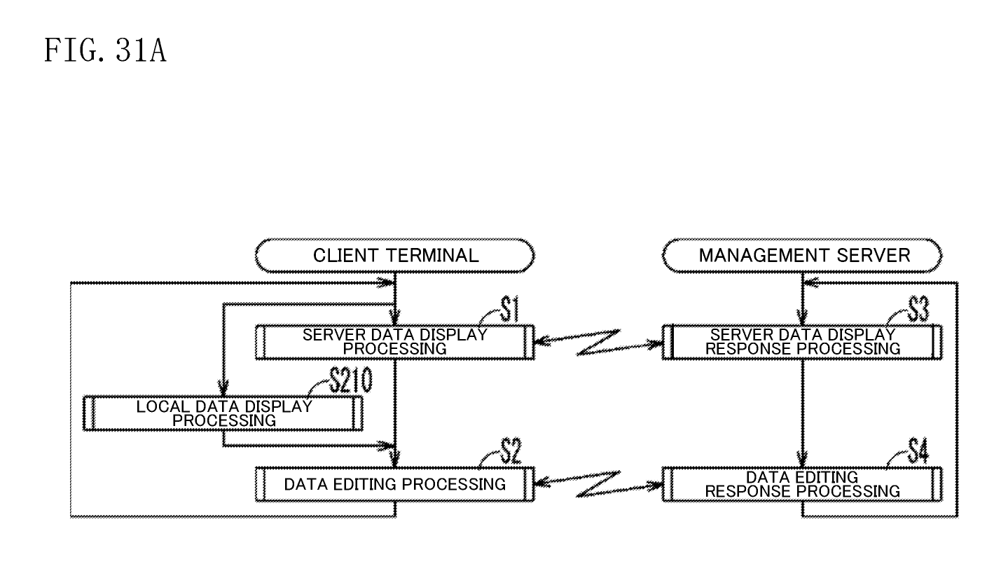

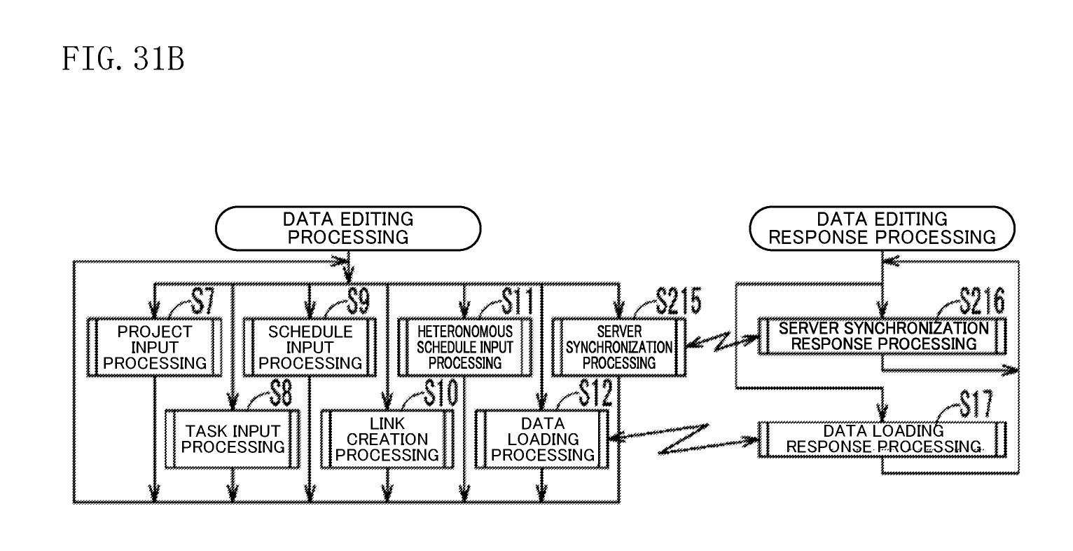

First, the flow of a main routine program to be executed by the client terminals 2 and the management server 4 will be described with reference to FIG. 31A. In this example, local data display processing S210 is added as client terminal processing, which is a difference from the flow chart of FIG. 3B. This local data display processing allows the user to make reference to private management data on a local drive by displaying the data on the display device 37 of his or her own client terminal 2. A detailed description thereof will be omitted herein.

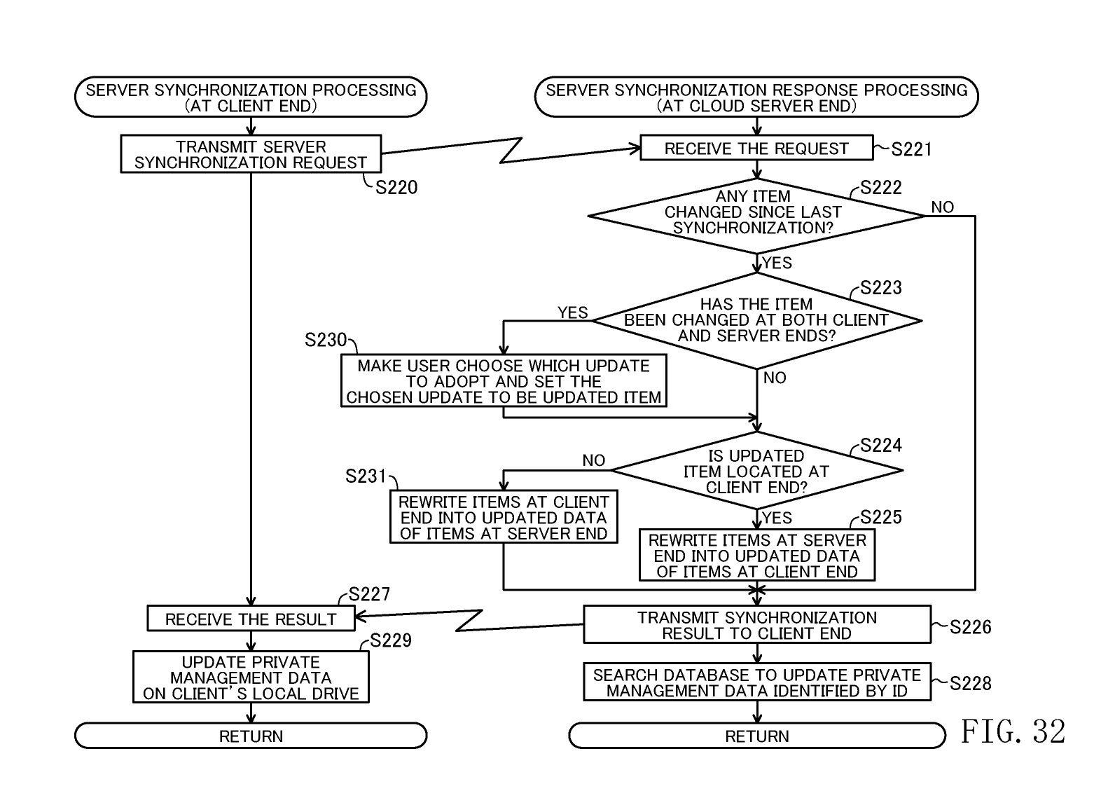

Next, the flow of a subroutine program for the data editing processing S2 and the data editing response processing S4 will be described with reference to FIG. 31B. In this example, server synchronization processing S215 is added as data editing processing and server synchronization response processing S216 is added as data editing response processing, which is a difference from the flow chart of FIG. 3C. These two processing steps will be described in detail with reference to FIG. 32.

FIG. 32 is a flow chart showing a subroutine program for the server synchronization processing at the client end (S215) and the server synchronization response processing at the management server end (S216). If the user has submitted a server synchronization request by operating the client terminal 2, a synchronization request signal is transmitted to the management server 4 in S220. The management server 4, receiving the signal in S221, determines (in S222) whether or not any item has been changed since the last synchronization. If no items have been changed since then, the control proceeds to S226, in which the synchronization result is transmitted to the client terminal 2. In this case, the reply indicates that no items have been changed. The client terminal 2 receives it (in S227) and displays, on the display device 37, a message that “No items have been updated.”

On the other hand, if any item has been changed, then the answer becomes YES in S222 and then a control operation of making the user choose which update to adopt and setting the chosen update to be an updated item is performed in S230. A specific method of having the user make his or her choice includes transmitting a selected screen from the management server 4 to the client terminal 2, having the user who is watching the selected screen on the display device 37 selectively operate any item, and sending a selection result signal back to the management server 4. Next, the control proceeds to S224, in which a determination is made whether or not the updated item is located at the client terminal end. If the updated item is located at the client terminal end, the processing of rewriting items at the management server end into updated data of items at the client terminal end is performed.

On the other hand, if the updated item is located at the management server end, the processing of rewriting items at the client terminal end into updated data of items at the management server end is performed in S231. Next, the control proceeds to S226, in which the synchronization result is transmitted to the client end. The client terminal 2 receives it (in S227). In response, the processing of updating the private management data on a local drive of the client terminal 2 is performed in S229.

Next, the features of the embodiment described above and its variations will be enumerated.
(1) According to the embodiment described above, a project administrator is allowed to follow other non-administrators' detailed project progress, including their scheduled actions, by making a uniform interlinked management of projects, tasks, and schedules. In addition, according to the embodiment described above, the storage device (such as the database 5) stores, in association with each other, a project item and task items to be done to put the project item into practice by using a path that is a character string indicating the storage location of data in the computer. Note that the means for storing, and interlinking with each other, those items does not have to be a path but may also be a pointer (i.e., a variable indicating the address of a value stored in a memory) or anything else as long as it contributes to storing and interlinking those items with each other.
(2) In addition, a task list (to-do list) and a calendar (schedule), which have been managed separately and independently of each other in the known art, are allowed to be interlinked and coordinated with each other as a task implementation grace period and a scheduled date and time of implementation (implementation binding period).
(3) A heteronomous schedule is a piece of reference information and does not restrict the user's own action. Thus, a heteronomous schedule is existent independently as a sort of memo within its superordinate task, and therefore, is not limited by the grace period of its superordinate task (see FIG. 8). That is to say, unlike a normal schedule, a heteronomous schedule may be created beyond the grace period of a task or project higher in order than the heteronomous schedule.
(4) Furthermore, creating a schedule, in which the user has expressed his or her agreement to participate, within its superordinate task from the heteronomous schedule within the range of the grace period of its superordinate task allows the timetable of a heteronomous event (heteronomous schedule) and his or her event participation schedule to be interlinked with each other. For example, suppose a situation where Taro has created a schedule to attend a product planning briefing event to be held on xx (month), yy (day). Data is stored in the form of a timetable that says, in the product planning briefing, a planning presentation is scheduled from 10 to 12, and a specific product briefing is scheduled from 13 to 14.

In such a situation, Jiro, having browsed through the timetable as a reference item, may create his own schedule by stating that he agrees to participate in, for example, only the planning presentation scheduled from 10 to 12 as a heteronomous schedule. That is to say, he can make reference to, as a memo, the heteronomous schedule in the form of a timetable, pick only items he is interested in, and fit those items into his own schedule. This allows the timetable of a heteronomous event (heteronomous schedule) and his or her event participation schedule to be interlinked with each other. However, those items may be interlinked with each other only within the grace period of their superordinate task (S51).

That is to say, if there is any event that has already been entered as a heteronomous schedule, creating a schedule subordinate to a task with the heteronomous schedule designated allows for creating a schedule using the heteronomous schedule as a template from the standpoint of schedule management, and also allows the user to state his or her agreement to participate in the event from the standpoint of project management. Note that such a technique for creating a schedule using the heteronomous schedule as a template is applicable to not only a general event but also a school schedule, a train schedule, or any other kind of event as well.
(6) Creating a shared heteronomous schedule (e.g., the “Third Meeting Schedule of Problem Solving Conference” 20 shown in FIG. 1) based on a shared task (e.g., the “Problem Gathering” 19 shown in FIG. 1) within the same project and then creating individual schedules from the shared heteronomous schedule allows for managing the dates and times of those tasks and schedules and the user's statement of participation agreement. Examples of the shared tasks include meetings.

Also, in displaying, on the user's own terminal, another user's schedule posted in a server application or in uploading data into a local stand-alone application, converting that another user's schedule posted into a heteronomous schedule, uploading the heteronomous schedule, and displaying it as a timetable showing that another user's scheduled actions allows for proposing creating a schedule or sharing a task based on that another user's scheduled actions. This allows not only the administrator but also all members sharing the same project in common to arrange their schedules, unlike the known art. In other words, this can be used effectively as a sort of communication tool between them. In addition, in a situation where it is obviously necessary for one person to act in cooperation with another person, for example, it will be convenient to convert the latter person's schedule into the former person's own schedule.

Furthermore, a timetable about all types of events may be saved as reference information, thus allowing the user to not only create his or her own schedule of actions but also make reference to a timetable of an event closely related to his or her scheduled action. A timetable of an event may cover, for example, the start and end times of the event, details of the event, departure and arrival times of trains, and their details.
(7) In reality, it is often the case that some task is related to multiple different projects, for example. In addition, allowing a task to be subordinate to multiple projects makes this computer system applicable to context-by-context schedule management.

For example, in a situation where a task is managed under the single main project but when the work is actually carried out under multiple different projects with something shared in common (e.g., use the same equipment or use the same place), interlinking those task links with each other as if they formed a single project allows for allocating scheduled implementation periods efficiently.
(8) In creating a link to a project or a task, the grace period of a project at the destination of the link may include the grace period of its entity. Only when the project at the destination is not located in a layer under the entity's superordinate project, the link is allowed to be created. If the grace periods are the same, then the entity is regarded as being inclusive in the project. If a project is located in a layer under the entity's superordinate project, then it means that no link can be created within the same project as the entity.

Unlike a general link to a file or a folder, both projects and tasks retain their grace period, which poses, as a consequence, a restriction that in the case of a project, its child projects or subordinate tasks can be created only within the range of the grace period. Also, in a layer under a project that is the entity of the link source, even if the grace period falls within the range, the circular reference disturbs the hierarchy and forms a contradictory structure, thus preventing those projects or tasks from being created.
(9) In performing scheduling, generally, a target is set along the time axis first, and then a milestone is generated. Optionally, scheduling may also be performed by generating milestone data with software provided to support the generation of the milestone and by using that data as a template. This brings a benefit of facilitating scheduling.
(10) In the embodiment described above, the user's own management data is stored in not only the database 5 but also his or her own client terminal 2 as well. Thus, in browsing through his or her own management data only, he or she can browse through it using only the client terminal 2 without accessing the management server 4. Alternatively, the computer system may also be configured such that the user's own management data is stored in only the database 5 without being stored in the client terminal 2. In that case, in the server data display processing S1, the management data to be displayed will be transmitted from the management server 4 to the client terminal 2 and displayed on the client terminal 2.
(11) Although the management server 4 is provided in the embodiment described above, the network may also be comprised of standalone user terminals (such as personal computers or smartphones) only. In that case, if the user wants to share his or her own management data stored in the user terminal with other users, he or she transmits and receives the management data to be shared among user terminals over a peer-to-peer (P2P) network, for example, thus sharing the management data.
(12) Control may be carried out such that various kinds of to-do lists are displayed in the order of closeness of their grace period expiration. In addition, control may also be carried out such that various kinds of project lists stored in the database 5 are displayed in the order of closeness of their grace period expiration.
(13) Although a schedule is displayed in a calendar display (see FIG. 26 and FIGS. 28-30B) in the embodiment described above, control may also be carried out such that clicking on the displayed schedule allows all of the schedule's superordinate tasks and all of the tasks' superordinate projects to be shown. For example, control may be carried out such that the tree is displayed along with the grace period as shown in FIG. 14.
(14) Although the start time and end time of a schedule are input to define the binding period of the schedule (see, for example, FIG. 21A), only the start time thereof may be input. Although the start time and end time of a task or a project are input to define the grace period of the task or the project (see, for example, FIGS. 19 and 20), only the start time or end time thereof may be input. Permitting such input allows the system to deal with a situation where the start time has been determined but the end time has not been determined yet and an inverse situation where the end time has been determined but the start time has not been determined yet. In that case, if, in a situation where an already stored to-do related item has been stored only at the start date and time S, (i) a low-order to-do related item subordinate to that to-do related item and its to-do period have been input, and (ii) either the start date and time or end date and time of the to-do period is earlier than the start date and time S, then an error indication is made in S22, S32, S43, or S82. Alternatively, if, in a situation where an already stored to-do related item has been stored only at the end date and time E, (i) a low-order to-do related item subordinate to that to-do related item and its to-do period have been input, and (ii) either the end date and time or start date and time of the to-do period is later than the end date and time E, then an error indication is made in S22, S32, S43, or S82.
(15) Although an item related to a job to be done by the user at a workplace, for example, is input as a to-do related item related to a thing to be done by him or her in the embodiment described above, this is only a non-limiting example. Alternatively, any kind of to-do related items other than the user's jobs, such as his or her study plan or life plan, may also be input and managed.
(16) The embodiment described above covers the following aspect of the present invention:

For example, in a situation where a plurality of users (such as employees) are managing jobs such as projects, tasks or schedules within an organization such as a company, some user may want to save another user's job as reference information. For instance, suppose a situation where User A belonging to the marketing department has to listen to a client's complaints about a new product so often when visiting the client that a schedule to call a problem solving conference by gathering problems based on the series of complaints has been input. In such a situation, User B belonging to the development department in charge of the development of the new product may be interested in the “Problem Gathering” task and the “Problem Solving Conference” schedule and may want to save them as reference information.

In this case, User A is in a position to be able to get the client's direct feedback about the problem with the new product and User B is in a position to make use of the direct feedback gotten from the client about the problem with the new product in the development of a next new product. Thus, their cooperation in the “Problem Gathering” task and the “Problem Solving Conference” schedule would produce better results. Therefore, if consensus is reached between a person engaged in the “Problem Solving” task and a person engaged in calling the problem solving conference, those jobs should sometimes be a common job to be shared by Users A and B.

To meet the needs described above, the present invention has various specific features defined as follows:

A computer system for managing to-do related items that should be performed within a predetermined period (e.g., the “Problem Gathering” 19, “Specification Drafting” 24, “Third Meeting Schedule of Problem Solving Conference” 20, and “Fifth Meeting Schedule to Meet Patent Attorney” 25 as shown in FIG. 1), the computer system including:

a storage device configured to store a plurality of users' to-do related items (e.g., in S35 shown in FIG. 4B and S50 shown in FIG. 5);

a browser configured to allow the user to browse through another user's schedule item, which is included in the to-do related items stored in the storage device (e.g., in S116 and S117 shown in FIG. 9 and in S150-S155 shown in FIG. 10); and

a reference saving device configured to save, as a memo, another user's schedule item browsed through with the browser in order to allow reference to the schedule item (e.g., in S118-S123 shown in FIG. 9).

This configuration allows the user to browse through another user's to-do related items and to save, as a memo, any of the to-do related items that he or she wants to make reference to such that he or she can easily access to it later, thus improving the user friendliness.

The computer system may further include a one's own schedule creator-entry device configured to allow the user to participate in that another user's schedule item saved in the reference saving device and to create and enter a one's own schedule item, which is a schedule item associated with the user's own to-do related item and corresponding to that another user's schedule item.

If the user wants to participate in another user's scheduled event and make the schedule item part of his or her own schedule, this configuration allows the user to create and enter his or her own schedule item, which is a schedule item associated with his or her own to-do related item and corresponding to that another user's schedule item, thus improving the user friendliness.

Optionally, the computer system may further include a modification prohibiting device configured to prohibit the user from modifying his or her own schedule item created and entered with the one's own schedule creator-entry device.

This configuration can substantially prevent the user from arbitrarily modifying, of his or her own will, any common schedule item in which not only the user him- or herself but also another user participate.
(17) The embodiment described above further covers the following aspect of the present invention:

When managing to-do related items such as projects, tasks, or schedules, the user (such as an employee) may want a task subordinate to a certain project to be subordinate to another project. For example, in a situation where a task of shooting photos representing experimental results has been input and managed as a task subordinate to an experiment project, the user may want to shoot photos representing defects of a new product as a part of a project for solving the problems with the new product. In such a situation, the user may want to manage the “Photo Shooting” that has already been input as a task subordinate to the experiment project as a task subordinate to the problem solving project as well.

In addition, projects include a high-order project and a low-order project subordinate to the high-order project. For example, under a high-order project such as an “Applied Research Project,” there may be specific low-order projects such as a “Problem Solving Project” and a “Patent Obtaining Project” to be performed to complete the high-order project. In managing such a hierarchical project in which low-order projects are subordinate to a certain high-order project, the user may want a project subordinate to one project to be subordinate to another project. For example, the user may want to manage a “Personnel Selection Project” subordinate to the “Basic Research Project” as a project subordinate to the “Applied Research Project” as well.

That is to say, in managing hierarchical to-do related items including a high-order project, a low-order project subordinate to the high-order project, and tasks subordinate to the low-order project, the user may need to manage a low-order to-do related item subordinate to a certain high-order to-do related item as an item subordinate to another to-do related item.

To meet the needs described above, the present invention has various specific features defined as follows:

A computer system for managing to-do related items (e.g., the projects, tasks, and schedules shown in FIG. 1) that should be performed within a predetermined period and that have a hierarchical structure in which one, two, or more low-order to-do related items are subordinate to a high-order to-do related item, the computer system including:

an input device (such as the input operating device 38, the project input processing shown in FIG. 4A, and the task input processing shown in FIG. 4B) configured to accept input of a high-order, first to-do related item (e.g., the experiment project 9 shown in FIG. 1) and a low-order, second to-do related item (e.g., “Photo Shooting” shown in FIG. 1) subordinate to the first to-do related item; and

a storage device configured to store, in association with each other, the first and second to-do related items input through the input device (e.g., in S25 shown in FIG. 4A and in S35 shown in FIG. 4B), wherein

the input device accepts input (e.g., in S80 shown in FIG. 6) of a link to the second to-do related item (e.g., the “Photo Shooting (Link)” 21 shown in FIG. 1) stored in the storage device as a link subordinate to a third to-do related item (e.g., the problem solving project 11 shown in FIG. 1) that is different from the first to-do related item, and

the storage device stores, as a link subordinate to the third to-do related item, the link to the second to-do related item input via the input device (e.g., in the link creation processing shown in FIG. 6).

This configuration allows a particular to-do related item under management to be subordinate to a plurality of to-do related items at the same time, thus improving the user friendliness.

Optionally, the computer system may further include an abnormality processor configured to perform (e.g., in S85 and S82 shown in FIG. 6) abnormality processing without having the storage device store the link to the second to-do related item if the hierarchical layer of the link to the second to-do related item input via the input device is lower than that of the second to-do related item.

This configuration allows for avoiding an inconvenient and contradictory situation where a link to a to-do related item is present in a layer under that to-do related item itself.

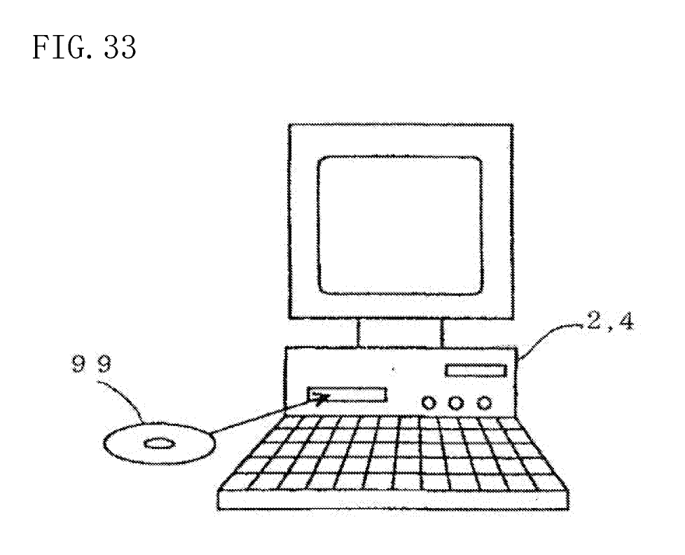

In the embodiments described above, the program for the client terminals 2 and the program for the management server 4 are downloaded from a website, where various kinds of third party application software programs are uniformly collected to be distributed, and installed. Alternatively, the application software may be stored on a (non-transitory) storage medium such as a CD-ROM 99 and circulated as shown in FIG. 33, and the user may purchase the CD-ROM 99 or any other storage medium and install the application software in the client terminal 2 and the management server 4.

Although exemplary embodiments of the present invention have been described, the present invention is in no way limited to those exemplary embodiments but is readily modifiable in various manners without departing from the true spirit and scope of the present invention.

### DESCRIPTION OF REFERENCE CHARACTERS

2 Client Terminal
4 Management Server
5 Database
8 Applied Research Project
11 Problem Solving Project
19 Problem Gathering
20 Third Meeting Schedule of Problem Solving Conference
30 CPU
36 Communications Device
37 Display Device
38 Input Operating Device

1-14 (canceled)

15. A computer system comprising:
a storage device configured to store to-do related items related to things to be done by a user and to-do periods when the things are scheduled to be done;
an input device configured to accept input of a task item included in high-order to-do related items and a schedule item serving as a low-order to-do related item to be done to put the task item into practice, and input of a to-do period to perform the task item and a binding period when the user is bound to perform the schedule item;
a decision unit configured to determine, in a state where the task item and the to-do period to perform the task item are stored in the storage device, whether or not the binding period of the schedule item input via the input device matches the to-do period of the task item; and
a processor configured to a control storage operation by the storage device by performing storage processing of instructing the storage device to store the schedule item input and its associated binding period such that the schedule item input and a task item, which is a to-do related item higher in order than the schedule item, are stored and interlinked with each other in the storage device so as to be managed uniformly, wherein
the processor disables the storage processing if a determination has been made by the decision unit that the binding period does not match the to-do period, and
the processor also disables the storage processing if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

16. A computer system comprising:
a storage device configured to store to-do related items related to things to be done by a user and to-do periods when the things are scheduled to be done;
an input device configured to accept input of a task item included in high-order to-do related items and a schedule item serving as a low-order to-do related item to be done to put the task item into practice, and input of a to-do period to perform the task item and a binding period when the user is bound to perform the schedule item;
a decision unit configured to determine, in a state where the task item and the to-do period to perform the task item are stored in the storage device, whether or not the binding period of the schedule item input via the input device matches the to-do period of the task item; and
a processor configured to instruct, provided that the decision unit has determined that the binding period matches the to-do period, the storage device to store the schedule item input and its associated binding period such that the schedule item input and a task item, which is a to-do related item higher in order than the schedule item, are stored and interlinked with each other in the storage device so as to be managed uniformly, wherein
the storage device is able to store a plurality of users' to-do related items,
the processor includes a reference saving processor configured to instruct the storage device to perform a save operation, in order to allow, as a memo, reference to another user's schedule item that is any of the to-do related items stored in the storage device,
the input device includes a one's own schedule creator-input device allowing the user to participate in that another user's schedule item stored in the storage device and to create and input a one's own schedule item, which is a schedule item associated with the user's own to-do related item and corresponding to that another user's schedule item, and
the processor performs one's own schedule storage processing of instructing the storage device to store, and interlink with each other, the one's own schedule item and the task item to be performed following the one's own schedule item so as to allow the one's own schedule item and the task item to be managed uniformly.

17. The computer system of claim 16, wherein
that another user's schedule item includes timetable data on which times are allocated on the basis of a plurality of contents, and
the one's own schedule creator-input device allows the user to make reference to the timetable data, select any of the contents that the user wants to participate in, and input the selected content as the one's own schedule item.

18. The computer system of claim 16, further comprising
an abnormality processor configured to perform abnormality processing without performing the one's own schedule storage processing if the decision unit has determined that the binding period of the one's own schedule item does not match the to-do period to perform the task item at a point in time when the one's own schedule item is input via the one's own schedule creator-input device.

19. The computer system of claim 15, further comprising
an association display device configured to display, in association with each other, the task items and the schedule items that are stored and interlinked with each other in the storage device.

20. The computer system of claim 19, wherein
the association display device displays a part of the to-do period to perform the task item as the binding period of the schedule item.

21. The computer system of claim 15, wherein
the high-order to-do related items further include a project item established to accomplish a certain purpose,
the processor includes a path association storage processor configured to instruct the storage device to store, in association with each other, the project item and task items to be done to put the project item into practice by using a path that is a character string indicating the storage location of data in a computer, and
the path association storage processor makes the storage device store, as tree structure data, the project item and the task items by defining a path following the project item as a path for the task items.

22. The computer system of claim 21, wherein
the association display device includes a tree display device configured to display, in a tree form, the project item and the task items based on the tree structure data, and
the input device allows the user to select, as items to be interlinked with each other, any combination of to-do related items including the project item and the task items displayed by the tree display device, and to create and input new to-do related items associated with the selected to-do related items.

23. The computer system of claim 15, wherein
if a first to-do related item and a second to-do related item, related to the first to-do related item, are stored in the storage device in association with each other, the input device accepts input of a link to the second to-do related item as data related to a third to-do related item that is different from the first to-do related item, and
the processor instructs the storage device to store, in association with the third to-do related item, the link to the second to-do related item input via the input device.

24. A computer system comprising:
a storage device configured to store to-do related items related to things to be done by a user and to-do periods when the things are scheduled to be done; and
a processor, wherein
the processor performs:
processing of accepting input of a task item included in high-order to-do related items and a schedule item serving as a low-order to-do related item to be done to put the task item into practice, and input of a to-do period to perform the task item and a binding period when the user is bound to perform the schedule item;
processing of determining, in a state where the task item and the to-do period to perform the task item are stored in the storage device, whether or not the binding period of the schedule item accepted in the processing of accepting matches the to-do period of the task item;
processing of performing storage processing of instructing the storage device to store the schedule item accepted and its associated binding period such that the schedule item input and a task item, which is a to-do related item higher in order than the schedule item, are stored and interlinked with each other in the storage device so as to be managed uniformly; and
processing of disabling the storage processing if a determination has been made by the decision unit that the binding period does not match the to-do period, and also disabling the storage processing if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

25. A management method comprising the steps of:
accepting input of a task item included in high-order to-do related items related to things to be done by a user and a schedule item serving as a low-order to-do related item to be done to put the task item into practice, and input of a to-do period to perform the task item and a binding period when the user is bound to perform the schedule item;
determining, in a state where the task item and the to-do period to perform the task item are stored in a storage device, whether or not the binding period of the schedule item accepted in the step of accepting matches the to-do period of the task item; and
processing to control a storage operation by the storage device by performing storage processing of instructing the storage device to store the schedule item accepted and its associated binding period such that the schedule item input and a task item, which is a to-do related item higher in order than the schedule item, are stored and interlinked with each other in the storage device so as to be managed uniformly, wherein
the step of processing includes:
determining a storage disable condition to be satisfied and disabling the storage processing if a determination has been made in the step of determining that the binding period does not match the to-do period, and
determining the storage disable condition to be satisfied and disabling the storage processing if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

26. A non-transitory computer readable medium storing a program designed to make a computer execute the steps of:
accepting input of a task item included in high-order to-do related items related to things to be done by a user and a schedule item serving as a low-order to-do related item to be done to put the task item into practice, and input of a to-do period to perform the task item and a binding period when the user is bound to perform the schedule item;
determining, in a state where the task item and the to-do period to perform the task item are stored in a storage device, whether or not the binding period of the schedule item accepted in the step of accepting matches the to-do period of the task item; and
processing to control a storage operation by the storage device by performing storage processing of instructing the storage device to store the schedule item accepted and its associated binding period such that the schedule item input and a task item, which is a to-do related item higher in order than the schedule item input, are stored and interlinked with each other in the storage device so as to be managed uniformly, wherein
the step of processing includes:
disabling the storage processing if a determination has been made in the step of determining that the binding period does not match the to-do period, and
also disabling the storage processing if, in a situation where a schedule item input as a particular user's own to-do related item and a task item, which is a to-do related item immediately higher in order than the schedule item, have already been stored and interlinked with each other in the storage device, a second schedule item, which designates that task item as a to-do related item immediately higher in order than the second schedule item itself and which is designated as a one's own to-do related item by the same person as the particular user, and its associated binding period are newly input, only to show that the binding period of the schedule item already stored overlaps with the newly input binding period.

27. A computer system comprising:
a storage device configured to store to-do related items related to things to be done by a user and to-do periods when the things are scheduled to be done; and
a processor, wherein
the processor performs:
processing of accepting input of a task item included in high-order to-do related items and a schedule item serving as a low-order to-do related item to be done to put the task item into practice, and input of a to-do period to perform the task item and a binding period when the user is bound to perform the schedule item;
processing of determining, in a state where the task item and the to-do period to perform the task item are stored in the storage device, whether or not the binding period of the schedule item accepted in the processing of accepting matches the to-do period of the task item; and
processing of instructing, provided that a determination has been made in the processing of determining that the binding period matches the to-do period, the storage device to store the schedule item accepted and its associated binding period such that the schedule item input and a task item, which is a to-do related item higher in order than the schedule item, are stored and interlinked with each other in the storage device so as to be managed uniformly, wherein
the storage device is able to store a plurality of users' to-do related items,
the processing of instructing includes reference saving processing of instructing the storage device to perform a save operation, in order to allow, as a memo, reference to another user's schedule item that is any of the to-do related items stored in the storage device,
the processing of accepting includes one's own schedule creating and accepting processing of allowing the user to participate in that another user's schedule item stored in the storage device and to create and input a one's own schedule item, which is a schedule item associated with the user's own to-do related item and corresponding to that another user's schedule item, and
the processing of instructing includes performing one's own schedule storage processing of instructing the storage device to store, and interlink with each other, the one's own schedule item and the task item to be performed following the one's own schedule item to allow the one's own schedule item and the task item to be managed uniformly.

28. A non-transitory computer readable medium storing a program designed to make a computer execute the steps of:
accepting input of a task item included in high-order to-do related items related to things to be done by a user and a schedule item serving as a low-order to-do related item to be done to put the task item into practice, and input of a to-do period to perform the task item and a binding period when the user is bound to perform the schedule item;
determining, in a state where the task item and the to-do period to perform the task item are stored in a storage device, whether or not the binding period of the schedule item accepted in the step of accepting matches the to-do period of the task item; and
instructing, provided that a determination has been made in the step of determining that the binding period matches the to-do period, the storage device to store the schedule item accepted and its associated binding period such that the schedule item input and a task item, which is a to-do related item higher in order than the schedule item, are stored and interlinked with each other in the storage device so as to be managed uniformly, wherein
the storage device is able to store a plurality of users' to-do related items,
the step of instructing includes a reference saving step of instructing the storage device to perform a save operation, in order to allow, as a memo, reference to another user's schedule item that is any of the to-do related items stored in the storage device,
the step of accepting includes a one's own schedule creating and accepting step of allowing the user to participate in that another user's schedule item stored in the storage device and to create and input a one's own schedule item, which is a schedule item associated with the user's own to-do related item and corresponding to that another user's schedule item, and
the step of instructing includes a one's own schedule storage step of instructing the storage device to store, and interlink with each other, the one's own schedule item and the task item to be performed following the one's own schedule item to allow the one's own schedule item and the task item to be managed uniformly.

29. The computer system of claim 17, further comprising
an abnormality processor configured to perform abnormality processing without performing the one's own schedule storage processing if the decision unit has determined that the binding period of the one's own schedule item does not match the to-do period to perform the task item at a point in time when the one's own schedule item is input via the one's own schedule creator-input device.

30. The computer system of claim 16, further comprising
an association display device configured to display, in association with each other, the task items and the schedule items that are stored and interlinked with each other in the storage device.

31. The computer system of claim 30, wherein
the association display device displays a part of the to-do period to perform the task item as the binding period of the schedule item.

32. The computer system of claim 16, wherein
the high-order to-do related items further include a project item established to accomplish a certain purpose,
the processor includes a path association storage processor configured to instruct the storage device to store, in association with each other, the project item and task items to be done to put the project item into practice by using a path that is a character string indicating the storage location of data in a computer, and
the path association storage processor makes the storage device store, as tree structure data, the project item and the task items by defining a path following the project item as a path for the task items.

33. The computer system of claim 32, wherein
the association display device includes a tree display device configured to display, in a tree form, the project item and the task items based on the tree structure data, and
the input device allows the user to select, as items to be interlinked with each other, any combination of to-do related items including the project item and the task items displayed by the tree display device, and to create and input new to-do related items associated with the selected to-do related items.

34. The computer system of claim 16, wherein
if a first to-do related item and a second to-do related item, related to the first to-do related item, are stored in the storage device in association with each other, the input device accepts input of a link to the second to-do related item as data related to a third to-do related item that is different from the first to-do related item, and
the processor instructs the storage device to store, in association with the third to-do related item, the link to the second to-do related item input via the input device.
